(19) United States
(12) Patent Application Publication
(10) Pub. No.: US 2013/0059996 A1
(43) Pub. Date: Mar. 7, 2013

(54) Boron-Containing PI-Electron Materials Incorporating Formally Aromatic and Neutral Borepin Rings

(71) Applicants: John Dayton Tovar, Baltimore, MD (US); Anthony Caruso, JR., Baltimore, MD (US)

(72) Inventors: John Dayton Tovar, Baltimore, MD (US); Anthony Caruso, JR., Baltimore, MD (US)

(21) Appl. No.: 13/640,221

(22) PCT Filed: Apr. 8, 2011
(86) PCT No.: PCT/US11/31742

§ 371 Date: Nov. 7, 2012

Related U.S. Application Data
(60) Provisional application No. 61/322,393, filed on Apr. 9, 2010.
(60) Provisional application No. 61/467,512, filed on Mar. 25, 2011.

(51) Int. Cl. C07F 5/02; C07F 7/22; C08F 138/00; C07F 7/08

(52) U.S. Cl. 526/239; 568/1; 568/6; 568/3; 549/4; 564/8; 562/405; 556/403; 556/95

(57) ABSTRACT

The synthesis, functionalization and characterization of borepin-based extended pi-electron molecules is disclosed. Bulky substituents shielded the vacant boron p-orbitals thus allowing synthetic manipulation and purification under ambient lab conditions. The presently disclosed borepin-containing compounds displayed reversible cathodic electrochemistry and can be viewed as n-type analogues to bent acene hydrocarbons.

### CROSS-REFERENCE TO RELATED APPLICATIONS

This application claims the benefit of U.S. Provisional Application Nos. 61/322,393, filed Apr. 9, 2010, and 61/467,512, filed Mar. 25, 2011, each of which is incorporated herein by reference in its entirety.

### BACKGROUND

Boron containing pi-electron systems have emerged as exciting subjects in contemporary organic materials chemistry. Collings, J. C., et al., Chem. Eur. J. 2009, 15, 198-208; Li, H., Jäkle, F., Angew. Chem. Int. Ed. 2009, 48, 2313-2316; Matsumi, N., et al., Macromolecules 1999, 32, 4467-4469; A. Wakamiya, et al., Angew. Chem. Int. Ed. 2007, 46, 4273-4276; Wood, T. K., et al., Angew. Chem. Int. Ed. 2009, 48, 4009-4012; Zhou, G. et al., J. Am. Chem. Soc. 2008, 130, 12477-12484; and Lorbach, A., et al., Angew. Chem. Int. Ed. 2009, 48, 4584-4588. The strong Lewis acidity of tri-coordinate boron has been used for the detection of biologically or environmentally relevant anions, for example, in sensor applications. Hudnall, T. W., Gabbai, F. P., J. Am. Chem. Soc. 2007, 129, 11978-11986; Hudnall, T. W., et al., Acc. Chem. Res. 2009, 42, 388-97; Yamaguchi, S. et al., J. Am. Chem. Soc. 2001, 123, 11372-11375.

Anionic and neutral boron heteroaromatics are important pi-donor ligands for organometallics, see Lee, B. Y., et al., J. Am. Chem. Soc. 2000, 122, 3969-3970; Ashe, A. J., et al., Organometallics 1990, 9, 2944-2948; Hoic, D. A., et al., J. Am. Chem. Soc. 1995, 117, 8480-8481, and the aromaticity of boron-containing molecules has inspired substantial experimental and theoretical effort. Schulman, J. M., Disch, R. L. Organometallics 2000, 19, 2932-2936; Subramanian, G. et al., Organometallics 1997, 16, 2362-2369; Marwitz, A. J. V., et al., Angew. Chem. Int. Ed. 2009, 48, 973-977; Bosdet, et al., M. J. D. Angew Chem. Int. Ed. 2007, 46, 4940-4943. These findings suggest that boron heteroaromaticity will play a key role in other areas where polarization may need to distort pi-electron frameworks, such as during operation in electronic devices.

The vast majority of boron-based pi-electron materials was built with main-chain, see Matsumi, N., et al., J. Am. Chem. Soc. 1998, 120, 10776-10777, or lateral, see G. Zhou, et al., Am. Chem. Soc. 2008, 130, 12477-12484; Zhao, C. H., et al., J. Am. Chem. Soc. 2006, 128, 15934-15935; Li, H. Y., et al., J. Am. Chem. Soc. 2007, 129, 5792-5793, tri-coordinate boron substitution or from locally antiaromatic four pi-electron fragments, such as the borole nucleus within 9-borafluorene. See Yamaguchi, S., et al., J. Am. Chem. Soc. 2002, 124, 8816-8817. Synthetic routes, however, for robust and bench-stable tri-coordinate borepins that could be tailored into complex pi-electron systems are lacking.

### SUMMARY

In some aspects, the presently disclosed subject matter provides the syntheses and characterization of polycyclic aromatics built around the neutral and formally aromatic six pi-electron borepin ring system that are structurally poised for synthetic elaboration into complex extended pi-electron molecular structures. The presently disclosed approach is relevant to small molecule oligomeric species, as well as polymeric entities.

More particularly, in some aspects, the presently disclosed subject matter provides a compound of Formula (Ia-IV):

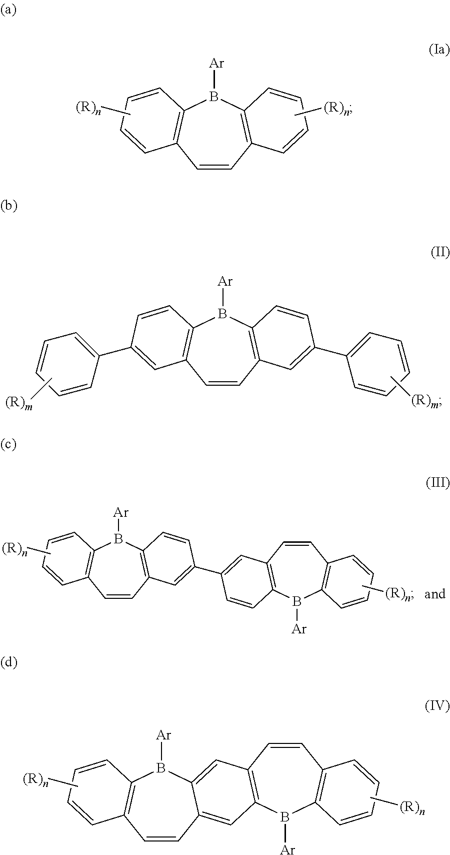

wherein:

m is an integer from 0 to 5;

n is an integer from 0 to 4;

Ar is selected from the group consisting of phenyl and substituted phenyl;

R at each occurrence is independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings; provided that if Ar is 2,4,6-trimethylbenzene, at least one R is not H; and oligomers and polymers thereof.

In particular aspects, bulky substituents, such as tri-t-butylphenyl B-substituents, referred to herein as a “super mesityl,” or B-Mes* moiety, can shield the sensitive, vacant boron p-orbitals from undesired reactivity, thus allowing synthetic manipulation and purification under ambient laboratory conditions.

In some aspects, the presently disclosed borepin-containing compounds displayed reversible cathodic electrochemistry and can be viewed as n-type analogues to bent acene hydrocarbons.

In further aspects, the presently disclosed methods can be used for an expanded cross-coupling repertoire among new substrates with different substitution patterns about the borepin scaffolds. Such materials could be used as new electronic materials, including, but not limited to, materials for transistor devices (electron transporting), liquid crystal materials, anion sensors, and any functional applications thereof, including photovoltaics or organic light emitting diodes.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

Having thus described the presently disclosed subject matter in general terms, reference will now be made to the accompanying Figures, which are not necessarily drawn to scale, and wherein:

FIG. 1 shows representative tri-coordinate triarylborane architectures;

FIG. 2 shows representative boron-based heteroaromatics: 1,2-azaborine (I); boratabenzene (II); 9-borafluorene (dibenzo[b,d]borole) (III); borepin (IV); and dibenzo[b,f]borepin (V);

FIG. 3 is a representative scheme depicting the synthesis of presently disclosed dibenzo[b,f]borepins (DBBs). Conditions for lithiation: 6a: s-BuLi, 6b-c: n-BuLi, TMEDA, Et₂O. Reagents for borepin formation: 1a: PhBCl₂; 1b: a) BCl₃, b) Tripyl-SnBu₃; 1c-e: a) BCl₃; b) Mes*Li, rt. ^{a}Yield determined by NMR;

FIGS. 4a-4d are UV-vis, photoluminescence (a, c) and cyclic voltammetry (b, d) data for 7 (top) and 8b (bottom). UV-vis and photoluminescence (PL) spectra were acquired in CHCl₃ at room temperature, with an excitation at 317 (a) and 365 (b) nm. Cyclic voltammograms (CVs) were acquired from 2.5 mM solutions of analyte in 0.1 M n-Bu₄PF₆/THF and are reported relative to Ag/Ag⁺, where E_{1/2}(Fc/Fc⁺) fell at 205 mV;

FIGS. 5a and 5b show structures (left) and DFT (B3LYP/6-31G*) calculations depicting the HOMO (center) and LUMO (right) wavefunctions of (a) para 20a and meta 20e and (b) para 20d and meta 20h;

FIGS. 6(a)-6(d) show normalized UV-vis data for (a) para substituted DBBs 20a-d and (c) meta substituted DBBs 20e-h and normalized photoluminescence data for (b) para substituted DBBs 20a-d and (d) meta substituted DBBs 20e-h. UV/Vis and PL spectra were acquired in CHCl₃ at room temperature. The legends for (a) and (b) are shown in (b) and those for (c) and (d) are shown in (d);

FIGS. 7(a) and 7(b) show UV/Vis (a) and photoluminescence (b) data for 20i. UV/Vis was acquired in CHCl₃ and PL spectra were acquired in cyclohexane, CHCl₃, THF and MeCN at room temperature, with excitation at 379;

FIGS. 8(a) and 8(b) show UV/Vis and photoluminescence data for 21a (a) and 21b (b). UV/Vis and PL spectra were acquired in CHCl₃ at room temperature, with excitation at 397 nm (a) and 410 nm (b);

FIGS. 9(a) and 9(b) show cyclic voltammetry of 20a (a) and 20e (b). CVs were acquired in 2.5 mM solutions of analyte in 0.1 M nBu₄NPF₆/THF and are reported relative to Ag/Ag⁺;

FIGS. 10(a) and 10(b) show electrochemical polymerization data for poly(20b); (a) growth curve showing multiple CV traces of monomer 20b and (b) cyclic voltammagram of the resulting polymer. CVs were obtained in 0.1 M nBu₄NPF₆/THF with polymer growth done in a 2.5 mM solution of 20b. All potentials are reported relative to Ag/Ag⁺;

FIG. 11 is a representative scheme depicting the synthesis and diversification of presently disclosed pentacyclic borepins. Reagents and conditions: (a) KOt-Bu, THF (0° C.-rt); (b) s-BuLi, TMEDA, Me₂SnCl₂, THF (−78° C.-rt); (c) BCl₃, Mes*Li, PhMe (−78° C.-rt); (d) Ni(dPPP)Cl₂, THF (50° C.);

FIGS. 12a-12d are UV-vis, photoluminescence (a) and cyclic voltammetry (b) data for 12a. UV-vis and PL were acquired in CHCl₃ at room temperature, with an excitation at 415 nm. CV conditions as in FIG. 3. The “X” in (b) denotes a background response from the electrolyte. DFT (B3LYP/6-31G*) calculations depicting the LUMO (c) and HOMO (d) wavefunctions for 13a;

FIGS. 13a and 13b are a displacement ellipsoid plot (50% probability level) of 12a given at 110(2) K (a) and an extended packing motif (b) revealing face-to-face aromatic contacts spaced at 3.43 Å. Selected bond lengths/Å: B1-C2: 1.573(3); B1-C3: 1.570(3); C3-C8: 1.423(3); C8-C9: 1.452(3); C9-C10: 1.341(3); C10-C11: 1.452(3); C2-C11: 1.421(3);

FIG. 14 demonstrates further functionalization of para chlorinated fused borepin 22a via palladium catalyzed cross-couplings to prepare fused forepins 27a-e. ^{a}Isolated yields. ^{b}Quantitative by crude NMR;

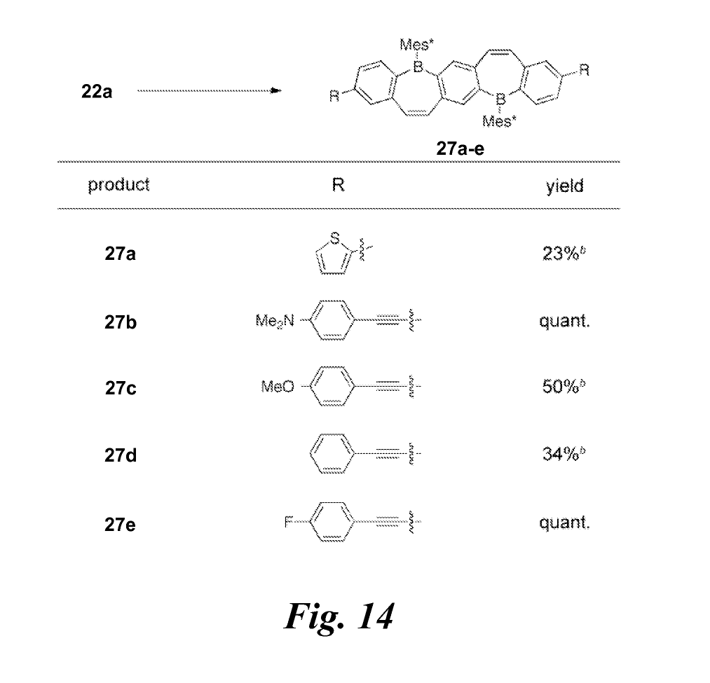

FIGS. 15(a) and 15(b) are UV-vis, photoluminescence for 27b-e (a) and cyclic voltammetry (b) datum for 27b. UV-vis spectra were acquired in CHCl₃ and PL spectra were acquired in CHCl₃ at room tempreature, with excitation at 392 nm and cyclic voltammetry (b) acquired from 2 mM solution in 0.1 M nBu₄NPF₆/THF and are reported relative to Ag/Ag⁺;

FIGS. 16(a)-16(c) are (a) photoluminescence data for 27b in various solvents, (b) image of solutions without (top) and with (bottom) irradiation with handheld UV (365 nm); and (c) DFT (B3LYP/6-31G*) calculations of the LUMO (left) and HOMO (right) surfaces;

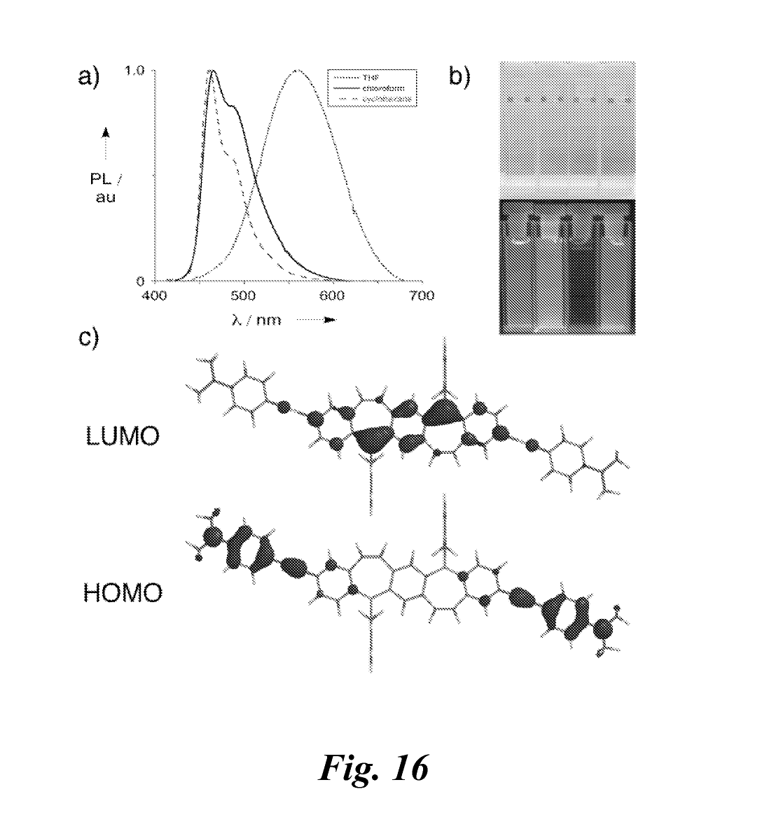

FIG. 17 is the photoluminescence spectra of methoxy phenylacetylene fused borepin 27c in cyclohexane, acetonitrile (MeCN), chloroform, and tetrahydrofuran (THF); and

FIGS. 18(a) and 18(b) are (a) UV-vis, photoluminescence and (b) cyclic voltammetry data for 28. UV-vis and PL spectra were acquired from CHCl₃, at room temperature, with excitation at 399 nm. CV acquired from 2 mM solution in 0.1 M nBu₄NPF₆/THF and are reported relative to Ag/Ag⁺.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

### I. Functionalized Dibenzoborepins and their Use as Components of Small Molecule and Polymeric π-Conjugated Electronic Materials

### A. Overview

The dibenzo[b,f]borepin (DBB) framework continues to attract substantial attention. See Caruso Jr., A., Tovar, J. D., in 236th ACS National Meeting, Philadelphia, Pa., United States (2008); Mercier, L. G., Piers, W. E., in 91st Canadian Chemistry Conference and Exhibition, Edmonton, AB, Canada (2008). Van Tamelen reported the first isolation of DBB as the ethanolamine adduct, see van Tamelen, E. E., et al., Tet. Lett. 1960, 14-15, and Piers very recently reported a B-mesityl DBB that slowly oxidized under ambient conditions. See Mercier, L. G., et al., Angew. Chem. Int. Ed. 2009, 48, 6108-6111. Theoretical treatments reveal planarity throughout the B-H DBB, which is attractive a means to enhance pi-electron delocalization, see J. M. Schulman, R. L. Disch, Organometallics 2000, 19, 2932-2936, and Nucleus Independent Chemical Shift (NICS) values reveal a weak degree of aromatic character within the borepin ring of benzo-annelated molecules. See Subramanian, G., et al., Organometallics 1997, 16, 2362-2369.

Further, boron-containing π-conjugated materials have received considerable attention in recent years due to their unique optical and structural properties that result from the vacant p-orbital of the boron center. Wade, C. R., et al. Chem. Rev. 2010, 110, 3958-84; Jäkle, F. Chem. Rev. 2010, 110, 3985-4022. The tri-coordinate organoborane center is inherently electron deficient, which makes these boron-containing materials amenable for use as electron-accepting units for donor-acceptor non-linear optical (NLO) materials. Matsumi, N.; Chujo, Y. Polym. J. 2008, 40, 77-89; Lin, N., et al., J. Mol. Struct.: THEOCHEM 2007, 820, 98-106; Entwistle, C. D.; Marder, T. B. Chem. Mater. 2004, 16, 4574-4585. The Lewis acidity of the vacant p-orbital makes boron an ideal material for sensor applications. Hudnall, T. W., et al., Acc. Chem. Res. 2009, 42, 388-97; Zhou, G., et al., J. Am. Chem. Soc. 2008, 130, 12477-12484; Hudnall, T. W.; Gabbaï, F. P. J. Am. Chem. Soc. 2007, 129, 11978-11986. In fact, Gabbaï and Müllen have used organoboranes to selectively bind fluoride and cyanide anions. These properties, along with the planar geometry of the boron center, make organoboranes desirable components for constructing tunable π-conjugated materials, Yamaguchi, S.; Wakamiya, A. Pure Appl. Chem. 2006, 78, 1413-1424, such as components for a diverse array of colored organic light-emitting diodes (OLEDs). Nagai, A., et al., Macromolecules 2008, 41, 8295; Wakamiya, A., et al., Angew Chem. Int. Ed. 2007, 46, 4273-4276; Qin, Y., et al., Org. Lett. 2006, 8, 5227-30.

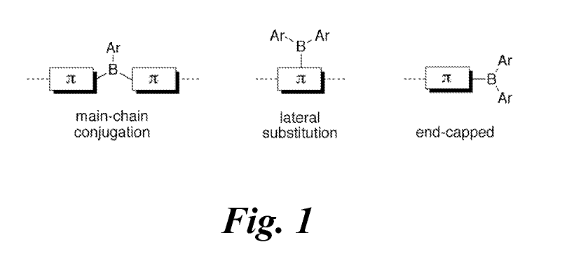

As represented generally in FIG. 1, the majority of organoborane systems used in such applications incorporate tri-coordinate boron into the π-system formally as tri-aryl boranes through either direct main-chain conjugation, Li, H.; Jäkle, F. Angew Chem. Int. Ed. 2009, 48, 2313-2316; Lorbach, A., et al., Angew Chem. Int. Ed. 2009, 121, 4654-4658; Matsumi, N., et al., J. Am. Chem. Soc. 1998, 120, 10776-10777, lateral substitution, Nagai, A., et al., Macromolecules 2008, 41, 8295; Wakamiya, A., et al., Angew Chem. Int. Ed. 2007, 46, 4273-4276; Li, H, et al., J. Am. Chem. Soc. 2007, 125(18), 5792-579; Jäkle, F. J. Inorg. Organomet. Polym. Mater. 2005, 15(3), 293-307; or as an end-capping unit. Zhou, G., et al., J. Am. Chem. Soc. 2008, 130, 12477-12484; Liu, X. Y., et al., Angew Chem. Int. Ed. 2006, 45, 5475-5478. The former includes synthetic methodology employed by Chujo, such as hydroboration polymerization between a dihydroborane and a suitable diyne forming poly(p-arylene-borane)s, Matsumi, N., et al., J. Am. Chem. Soc. 1998, 120, 5112-5113, where the boron center is directly incorporated into the main π-conjugation pathway.

More recently, Jäkle has synthesized poly(fluorenyl B-bromoborane)s via the highly selective tin-boron exchange between a bis(trimethylstannyl)fluorene and bis(dibromoboryl)fluorene followed by post-polymerization modification by quenching with a variety of aryl nucleophiles to construct electronically diverse tri-aryl boranes within the polymer chain. Li, H.; Jäkle, F. Angew Chem. Int. Ed. 2009, 48, 2313-2316. Lateral substitutions have been achieved by tin/silicon-boron exchange or by addition reactions between aryl lithiates and dimesitylboron fluoride to form both small molecules and side-borylated polymers, such as Yamaguchi's oligophenylene ethynylenes, Zhao, C. H., et al., J. Am. Chem. Soc. 2006, 128, 15934-15935, that feature dimesitylborane side groups and Jäkle's oligo- and polythiophenes bearing the same. Li, H., et al, J. Am. Chem. Soc. 2007, 129(18), 5792-579; Jäkle, F. J. Inorg. Organomet. Polym. Mater. 2005, 293-307.

End-capped molecules have been prepared through similar chemistry to incorporate boron-boron or boron-donor electronic interactions, such as Shirota's dimesitylborane-capped oligothiophenes, Noda, T., et al., Adv. Mater. 1999, 11, 283-285, and Müllen's donor-acceptor ladder-type oligofluorenes. Zhou, G., et al., J. Am. Chem. Soc. 2008, 130, 12477-12484.

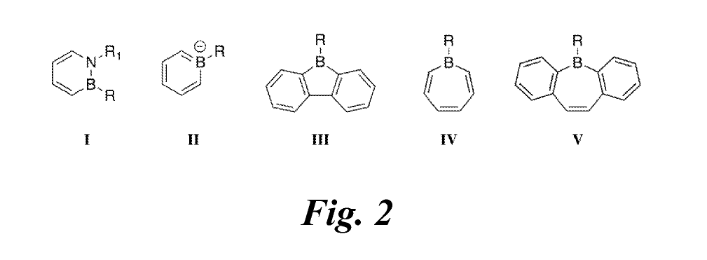

As depicted generally in FIG. 2, in addition to incorporation through tri-aryl borane connectivities, boron also has been included as part of polycyclic aromatic frameworks, such as azabora-, Lepeltier, M., et al., Chem. Commun. 2010, 46, 7007-7009; Bosdet, M. J. D., et al., Org. Lett. 2007, 9, 1395-1398; Bosdet, M. J. D., et al., Angew Chem. Int. Ed. 2007, 46(26), 4940; Jaska, C. A., et al. J. Am. Chem. Soc. 2006, 128, 10885-96; borata-, Rogers, J. S., et al., J. Am. Chem. Soc. 2000, 122, 730-731; Lee, B. Y.; Bazan, G. C. J. Am. Chem. Soc. 2000, 122, 8577-8578; Hoic, D. A., et al., J. Am. Chem. Soc. 1997, 119, 7155-7156; and bora-annulenes. Wood, T. K., et al., Chem. Eur. J. 2010, Early View, Metz, M. V., et al., Angew Chem. Int. Ed. 2000, 39(7), 1312-1316; Ashe III, A. J., et al., Organometallics 1999, 18, 466-473.

Referring once again to FIG. 2, azabora-annulenes are annulenes where one pair of adjacent π-conjugated carbon centers is replaced with a boron-nitrogen double bond with the most basic example being azaborine (I in FIG. 2), which is isoelectronic with benzene. Dewar initially synthesized derivatives of azaborine in 1962; Dewar, M. J. S.; Marr, P. A. J. Am. Chem. Soc. 1962, 84, 3782, however, sufficient characterization was difficult to obtain until the experimental studies of Ashe, see Ashe III, A. J., et al., Organometallics 2001, 20, 5413-5418, and more recently Liu, see Daly, A. et al., J. Am. Chem. Soc. 2010, 132, 5501-5506; Abbey, E. R., et al., J. Am. Chem. Soc. 2008, 130, 7250-7252, investigated the aromaticity, reactivity and optoelectronic properties. In recent years, synthetic efforts out of the Piers laboratory led to the construction of a variety of more complex polycyclic aromatics, such as B═N variants of phenanthrene, pyrene, and triphenylene. Bosdet, M. J. D., et al., Org. Lett. 2007, 9, 1395-1398; Bosdet, M. J. D., et al., Angew Chem. Int. Ed. 2007, 46(26), 4940; Jaska, C. A., et al., J. Am. Chem. Soc. 2006, 128, 10885-96.

Borata-annulenes are anionic molecules in which one sp² hybridized carbon is replaced by an anionic boron center. Such is the case for boratabenzene (II in FIG. 2), which was first synthesized by Herberich in 1970 and shown to be a suitable ligand for transition metal complexes. Herberich, G. E., et al., Angew Chem. Int. Ed. 1970, 9, 805-806. Since the seminal publication on borata-annulenes, Bazan, Ashe and others have synthesized a variety of larger systems including borataanthracene, see Lee, R. A., et al., J. Am. Chem. Soc. 1998, 120, 6037-6046, and boratanapthalene, Ashe III, A. J., et el., Organometallics 1999, 18, 466-473, and explored their application to coordination chemistry.

Bora-annulenes are conjugated heterocycles where one carbon is replaced with a neutral boron center as exemplified by the 4π-electron formally anti-aromatic borole ring first synthesized by Eisch and coworkers in 1969, which is isoelectronic with the cyclopentadienyl cation. The unsubstituted borole ring is unstable; however, the perarylation or incorporation into larger polycyclic aromatics such as 9-borafluorene (dibenzoborole, III in FIG. 2) allow for further functionalization and manipulation. Fan, C., et'al., Angew Chem. Int. Ed. 2009, 48, 2955-2958; Braunschweig, H.; Kupfer, T. Chem. Commun. 2008, 4487; Wakamiya, A., et al., Chem. Commun. 2008, 579-581; Yamaguchi, S., et al., J. Am. Chem. Soc. 2002, 124, 8816-8817. In contrast to its carbon and nitrogen analogs (fluorene and carbazole, respectively), dibenzoborole has the potential of being an electron-transporting material due to the electron deficiency of the boron center.

One class of less-utilized boron-based building blocks for 7c-electronic materials investigation is the borepins (IV in FIG. 2), which are seven-membered, 6π-electron neutral aromatic heterocycles that are isoelectronic with the tropylium cation. Vol'pin initially suggested that borepins would be Hückel-type aromatic compounds, Vol'pin, M. E. Russian Chemical Reviews 1960, 29, 129-160, and in the nearly fifty years following, various B-substituted borepins and benzoborepins were studied theoretically, Schulman, J. M.; Disch, R. L. Organometallics. 2000, 19, 2932-2936; Subramanian, G., et al., Organometallics 1997, 16, 2362-2369, and experimentally, Tamelen, E. E. V., et al., Tet. Lett 1960, 8, 14-15; Leusink, A. J., et al., Tet. Lett. 1967, 14, 1263-1266; Ashe III, A. J., et al., Angew Chem. Int. Ed. 1992, 31(9), 1255-1258; Ashe III, A. J., et al. Organometallics, 1993, 12, 3224-3231.

Ashe evaluated the aromaticity of the borepin ring by x-ray crystal analysis, NMR and UV-vis spectroscopy, and determined that they are indeed aromatic as predicted. Some years later, Schleyer, as well as Schulman and Disch, performed extensive theoretical studies of borepin and its benzo-annulated analogs, spurring much interest in their design and synthesis. Unfortunately, the air and moisture sensitivity of these molecules due to the unshielded vacant p-orbital on the boron center hindered the investigation and application of borepin-based materials, and their preparative chemistry has been restricted to small molecule analogs rather than for elaboration into extended π-conjugated systems unlike the other boron-based examples described above.

To overcome these limitations, Piers, see Mercier, L. G., et al., Angew Chem. Int. Ed. 2009, 48, 6108-6111, and Caruso et al., see Caruso Jr., A., et al., Angew Chem. Int. Ed, 2010, 45(25), 4213-4217, independently described the synthesis and characterization of a variety of more robust molecules containing different embodiments of the dibenzo[b,f]borepin ring system (DBB, V in FIG. 2) in an effort to better understand the local aromaticity of the central borepin ring and its involvement in the overall π-conjugated network. Piers reported a series of different benzo- and napthoborepins that utilized mesityl (1,3,5-trimethylbenzene) as the boron substituent, which imparted enough stability to enable purification and exposure to ambient environments. These molecules exhibited blue photoluminescence with rather high quantum yields in some cases, suggesting potential application as light-emitting components in OLEDs. In an associated paper, Mercier, L. G., et al., Organometallics. 2011, 30, 1719-17-29, describe the synthesis and electronic characterization of new silepin molecules as potential precursors to formation of borepins via tin-silicon exchanges.

Caruso et al. extended the DBB conjugation pathway through the vacant boron p-orbital by transition metal-catalyzed cross-coupling reactions onto chlorides placed para to the boron center. Caruso Jr., A., et al., Angew Chem. Int. Ed., 2010, 45(25), 4213-4217. Due to the rather low reactivity of the chlorides, installation of π-electron groups onto the DBB core under even highly active palladium catalysis was unsuccessful; however, nickel-catalyzed Kumada cross-couplings with aryl Grignards led to aryl-coupled DBBs. The kinetic protection afforded by the B-Mes* groups (2, 4,6-tri-tert-butylphenyl), Yoshifuji, M., et al., J. Am. Chem. Soc. 1981, 103, 4587-4589; Wakamiya, A., et al., Chem. Commun. 2008, 579-581, allowed these molecules to withstand treatment with aggressive transmetallation reagents necessary for doing Kumada-type cross-coupling chemistry.

Despite these initial advances in elaboration of the DBB scaffold, it is important for future materials development to have a more general and reactive platform through which a diverse array of chemical modifications for electronic property tuning can be accomplished. Accordingly, in some embodiments, the presently disclosed subject matter provides the synthesis of brominated DBBs, as well as the design, synthesis and characterization of functionalized DBBs via expanded synthetic manipulations now available with these borepin aryl bromides.

### B. Synthesis and Characterization of Functionalizable Boron-Containing Pi-Electron Materials Incorporating One and Two Formally Aromatic Fused Borepin Rings

A high demand exists for organic electronic materials capable of fostering n-channel (electron transporting) behavior. Because no clear design metrics that have proven reliable in terms of predicting useful materials on the basis of their molecular structures exist, the availability for new materials with stable reductive electrochemistry is of interest. The presently disclosed subject matter provides a solution to the low availability of boron-based aromatic molecules for organic electronics that can be fashioned into more complex structures through cross-coupling methodologies.

The presently disclosed subject matter provides the syntheses and characterization of polycyclic aromatics built around the neutral and formally aromatic six pi-electron borepin ring system that are structurally poised for synthetic elaboration into complex molecular structures. In some embodiments, the presently disclosed subject matter provides a class of pi-conjugated electronic materials bearing formally aromatic boron-based heterocycles for use in electronic applications. The presently disclosed boron-based heterocycles have been tailored to allow for extended synthetic elaboration to alter the relevant energy levels and crystal packing. Without wishing to be bound to any one particular theory, it is believed that the boron centers provide for stable electrochemical reduction, a key property that suggests their use as electron-transporting materials. The presently disclosed synthesis approach is applicable to the construction of both small molecule and polymeric electronic materials.

Further, the presently disclosed approach provides the first general class of borepin molecules that are stable under ambient conditions and can be purified using standard organic chemistry techniques. In the presently disclosed methods, the choice of starting precursors determines the placement of functional groups for synthetic modification. In some embodiments, a steric bulky group that provides protection to the sensitive boron center also provides a high degree of solubility of the borepin molecules in organic solvents. Further extensions to complex electronic structures that make up the fused borepin polycyclic aromatic also are disclosed. Representative borepin compounds that can be prepared by the presently disclosed methods are described immediately herein below.

In some embodiments, the presently disclosed subject matter includes a compound of Formula (Ia-III):

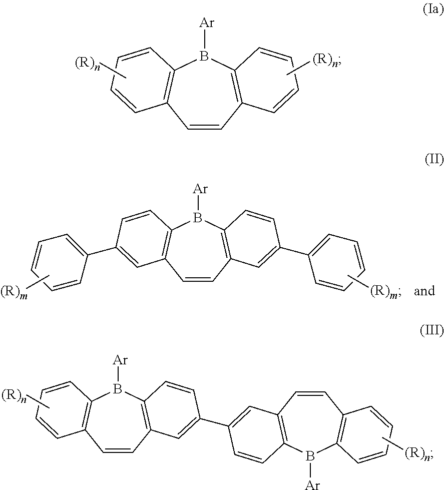

wherein m is an integer from 0 to 5; n is an integer from 0 to 4; Ar is selected from the group consisting of phenyl and substituted phenyl; R at each occurrence is independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings; provided that if Ar is 2,4,6-trimethylbenzene, at least one R is not H; and oligomers and polymers thereof.

In some embodiments, the substituted phenyl is selected from the group consisting of 2,6-dimethylphenyl, 2,4,6-tri-iso-propylphenyl, 2,4,6-tri-tert-butylphenyl, 2,4,6-trimethyl phenyl, and 4-cyanophenyl. One of ordinary skill in the art would appreciate that other bulky, steric groups also would be suitable for use with the presently disclosed compounds.

In particular embodiments, the compound of Formula (Ia) is selected from the group consisting of:

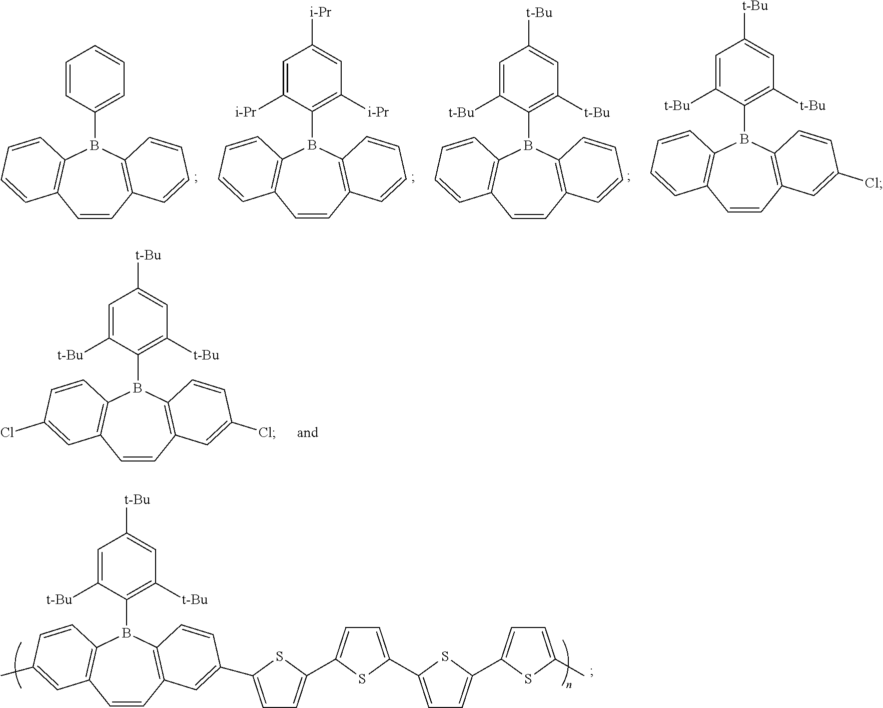

wherein “t-Bu” is a tertiary butyl group and “i-Pr” is an isopropyl group.

In yet other embodiments, the compound of Formula (Ia) is selected from the group consisting of:

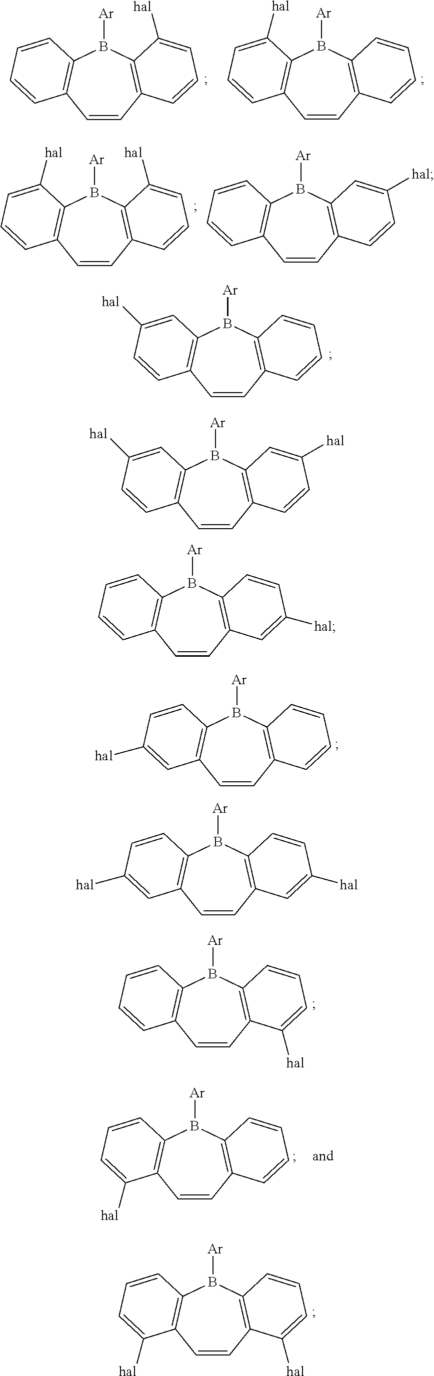

wherein Ar is as defined above and each “hal” substituent group is independently a halogen selected from the group consisting of F, Cl, Br, and I.

In some embodiments, the compound of Formula (II) is selected from the group consisting of

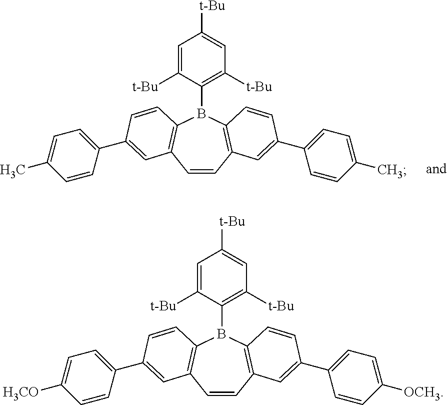 [SMILES: Cc1ccc(-c2ccc3c(c2)C=Cc2cc(-c4ccc(C)cc4)ccc2B3c2c(C(C)(C)C)cc(C(C)(C)C)cc2C(C)(C)C)cc1 ; COc1ccc(-c2ccc3c(c2)C=Cc2cc(-c4ccc(OC)cc4)ccc2B3c2c(C(C)(C)C)cc(C(C)(C)C)cc2C(C)(C)C)cc1]

wherein “t-Bu” is a tertiary butyl group.

In some embodiments, the compound of Formula (III) has the following structure:

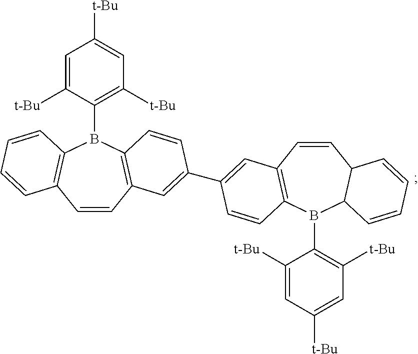 [SMILES: CC(C)(C)c1cc(C(C)(C)C)c(B2c3ccccc3C=Cc3cc(-c4ccc5c(c4)C=CC4C=CC=CC4B5c4c(C(C)(C)C)cc(C(C)(C)C)cc4C(C)(C)C)ccc32)c(C(C)(C)C)c1]

wherein “t-Bu” is a tertiary butyl group.

Accordingly, in some embodiments, the presently disclosed subject matter provides a synthetic approach that provides the construction of functionalizable borepin-based polycyclic aromatics. The bulky B-Mes* moiety shields the sensitive boron center from undesired reactivity allowing for standard synthetic manipulation and isolation under ambient laboratory conditions. The presently disclosed methods also can be used for an expanded cross-coupling repertoire among new substrates with different substitution patterns about the borepin scaffolds. Such materials could be used as new electronic materials.

In general, the presently disclosed subject matter includes any pi-electron material that can be joined to the key molecular scaffold, as a way to control crystallinity, donor-acceptor interactions, electronic properties relevant to light absorption and emission, placement of energy levels (Highest Occupied (HOMO) and lowest unoccupied (LUMO) molecular orbitals) relative to vacuum and relative to key electrodes used for device fabrication. The presently disclosed approach is relevant to small molecule oligomeric species, as well as polymer entities.

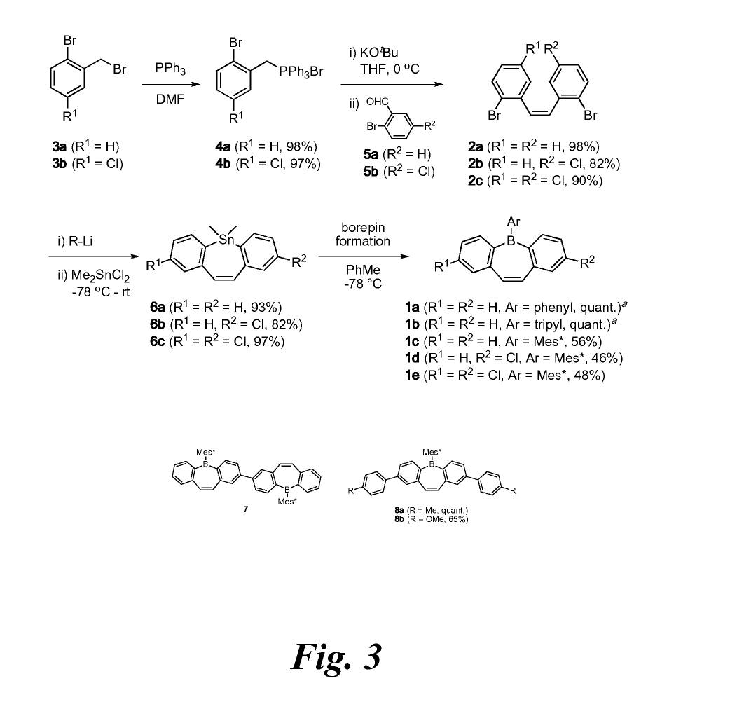

More particularly, a scheme for the synthesis of a parent DBB 1a is shown in FIG. 3. The stilbene precursor 2a was constructed via Wittig-type chemistry using reactants derived from α-bromo-o-bromotoluene 3a: radical halogenation and standard Arbuzov chemistry yielded the phosphonium salt 4a while oxidation with NMO furnished the requisite aldehyde 5a. The desired cis product 2a was dominant (90%+) and was readily purified. See E. C. Dunne, et al., Tet. Lett. 43:2449-2453 (2002). Stannocyclization was achieved by trapping the in situ generated dilithio species of 2a with dimethyltin dichloride. Tin-boron exchange between 6a and PhBCl₂ yielded the B-phenyl DBB 1a, but both it and even B-tripyl (2,4,6-triisopropylphenyl) DBBs 1b rapidly decomposed under ambient atmosphere and were handled in a glovebox. Tri-t-butylphenyl B-substituents (“super mesityl,” Mes*) rendered the resulting 1c framework stable and soluble to allow manipulation and chromatography under ambient conditions. See Wakamiya, A., et al., Chem. Commun. 2008, 579-581.

The bulkier B-Mes* of 1c slightly distorted the pi-circuit as determined by the 14-nm blue-shift of the lowest energy UV-vis features compared to 1a that remain qualitatively the same in terms of relative oscillator strengths. Otherwise, the spectroscopic and electrochemical properties of DBB 1c were comparable to those of the B-mesityl DBB frameworks reported independently by Piers. The bulk of the Mes* substituent, however, shielded the boron center from attack by Lewis bases, leaving it coordinatively unsaturated in the presence of fluoride. See Wakamiya, A., et al., Chem. Commun. 2008, 579-581. Thus, the electronics of the aromatic borepin nucleus do not preclude the use of the vacant boron p-orbital in the context of Lewis basic sensing schemes unless steric bulk is designed into the receptor.

The chloride handles were included at positions para to the boron in 1d and 1e (specifically where R¹ and/or R² in FIG. 3 are chlorides) due to their known reactivity under a variety of Ni- and Pd-catalyzed processes. For example, the chlorinated benzaldehyde 5b was treated with phosphonium salt 4a under the same Wittig-type conditions to prepare monochloro stilbene 2b that was carried on to DBB 1d, while both chlorinated units 4b and 5b were employed in the synthesis of 1e under the same scheme of reactions. In principle, any of the aryl protons of 4 and 5 could be replaced with other substituents, which ultimately would allow for substitution on any available carbon atom on the aromatic rings connected to the borepin nucleus. The use of the Mes* group was again required to impart robustness under ambient lab conditions.

DBBs with extended p-conjugation were prepared from chlorides 1d and 1e via common cross-coupling procedures, illustrating the robustness of the protected DBB core. A nickel catalyst (with stoichiometric zinc reductant) effected the homodimerization of 1d leading to 7. See Colon, I., Kelsey, D. R., J. Org. Chem. 1986, 51, 2627-2637; Reddinger, J. L., Reynolds, J. R., Macromolecules 1997, 30, 479-481.

Kumada-type couplings of aryl Grignard reagents onto 1e using Ni(dppp)Cl₂ led to the aryl coupled products 8a-b. As with the parent DBB, 7 and 8 were bench stable and could be chromatographed with no apparent decomposition. Although treatment of the DBBs with molecular bromine led to decomposition, the dimer 7 did not react with n-BuLi and even withstood an oxidative workup with aqueous hydrogen peroxide. Other pi-electron groups could not be installed onto 1e using Pd catalysts and non-phenyl groups could not be installed with Ni catalysts (e.g., via vinyl or ethynyl Grignard reagents). In some cases, clear dehalogenation of the DBB 1e was observed, suggesting that the oxidative insertion was viable on the deactivated aryl chlorides and that future target-specific chemistry will be successful after reaction and substrate fine-tuning.

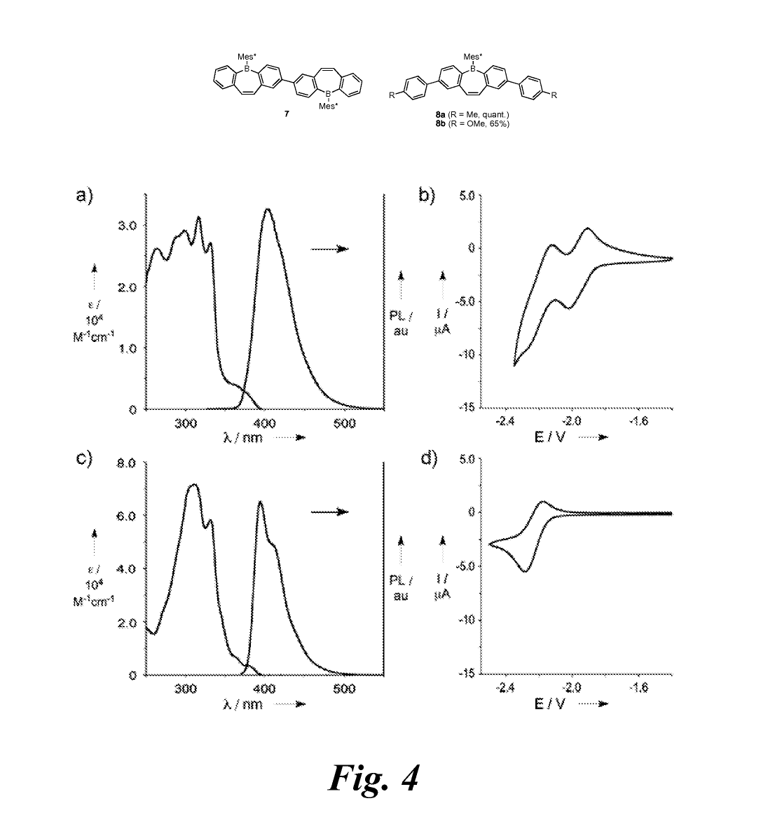

The vacant p-orbitals on boron can participate to extend the conjugation pathways in pi-electron materials. Therefore, it was unexpected to find that 7 and 8a/b had similar optical properties (see Table 1, FIGS. 4a and 4c). This observation can be rationalized by the presence of a node at the site of aryl attachment in these molecules that localized the HOMO wavefunction on the DBB core, with only slight spreading onto the substituents in the LUMO. All three molecules, e.g., 7 and 8a/b, had their lowest energy absorptions at approximately 380 nm with photoluminescence maxima at approximately 400 nm.

TABLE 1
Optical and Electrochemical Properties of Functionalized
Borepin-Containing pi-Electron Molecules.

| | Abs^{[a]} | PL | | |
|---|---|---|---|---|
| | λₘₐₓ/nm | λₘₐₓ/nm | | |
| Compound | (log ε) | (Φ_{F}/%) | E_{1/2} (1)/V | E_{1/2} (2)/V |
| 1c | 358 (3.56) | 384 (36) | −2.54 | Na |
| 7 | 379 (3.43) | 404 (58) | −1.97 | −2.20 |
| 8a | 382 (2.97) | 396 (23) | −2.24 | Na |
| 8b | 380 (3.55) | 395 (38) | −2.23 | Na |
| 12a | 439 (3.52) | 456 (73) | −1.89 | −2.59 |
| 13a | 442 (3.33) | 459 (56) | −1.87 | −2.48 |
| 13b | 438 (3.36) | 459 (50) | −1.88 | −2.46 |

^{[a]}depicts lowest energy λₘₐₓ.

On the other hand, the more electron deficient DBB substituent of 7 led to a dramatic difference in the CV compared to 8a/b showing less negative first (and second) reduction potentials (E_{1/2}s at −1.97 and −2.20 V for 7 vs −2.24 V for 8a, see FIGS. 4b and 4d). This observation indicates that, despite the orbital wavefunction nodes at the site of aryl-aryl union, substantial communication still exists among the boron redox-active centers within the dimeric structure of 7 that influences the boron redox chemistry. This communication among the boron redox-active centers within the dimeric structure can be important, for example, with electronic devices that often require tuning the HOMO and LUMO levels relative to vacuum to facilitate charge injection as opposed to exploiting differences in optical bandgaps.

### C. Synthesis And Characterization of Dibenzo[b,f]borepins (DBBs) Functionalized at the Para and Meta Position with Respect to the Boron Center.

In some embodiments, the presently disclosed subject matter provides the synthesis and characterization of dibenzo[b,f]borepins (DBBs) functionalized at the para and meta position with respect to the boron center to demonstrate how regiochemical issues influence photophysical and electrochemical properties. An expanded synthetic repertoire is disclosed herein, using palladium catalysis (to perform Stille, Suzuki, Buchwald-Hartwig and Sonogashira cross-coupling reactions) and lithium-halogen exchange to synthesize a series of extended π-conjugated DBBs. These chemistries are enabled by the use of a sterically bulky Mes* (2,4,6-tri-tert-butylphenyl) group on boron and the inclusion of reactive bromide handles on the DBB core. Photophysical, electrochemical, and computational analyses of the presently disclosed compounds indicate that relative to the protio DBB the installation of groups at the meta positions decreases the optical band gap while para-substitution raises the electron affinity of the system. Thus, both the HOMO-LUMO gap and specific frontier molecular orbital levels can be tuned by the installation of different conjugated substituents.

In designing functionalized DBB molecules, two apparent positions are available where π-electron groups could be installed that could lead to extended intramolecular delocalization, meta or para to the boron center (see Scheme 1).

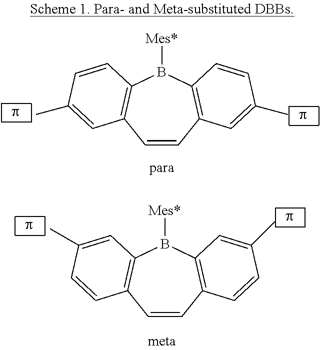

The meta isomer could facilitate the delocalization of π-electrons through the stilbene-like carbon moiety by essentially isolating the boron and precluding it from participating in charge delocalization. Installation of functional groups para to the boron, however, could make the boron center a more integral part of the π-conjugation pathway. To better understand these electronic issues, brominated DBBs were synthesized that allowed a series of π-conjugated para and meta isomers to be prepared to compare the effect of electron delocalization through the boron center or the stilbene-like olefin.

Accordingly, in some embodiments, the presently disclosed subject matter provides a compound of Formula (Ib)

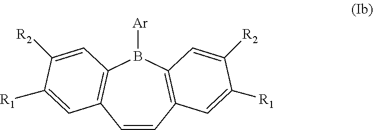

wherein Ar is selected from the group consisting of phenyl and substituted phenyl; R₁ and R₂ at each occurrence are independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings; provided that at least one of R₁ and R₂ is not H; and oligomers and polymers thereof.

In some embodiments, the compound of Formula (Ib) is selected from the group consisting of:

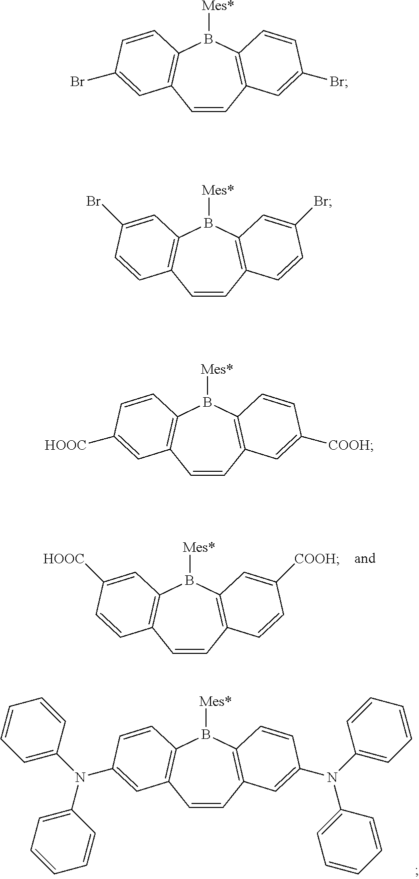

wherein Mes* is 2,4,6-tri-t-butylphenyl.

In some embodiments, the compound of Formula (Ib) is selected from the group consisting of:

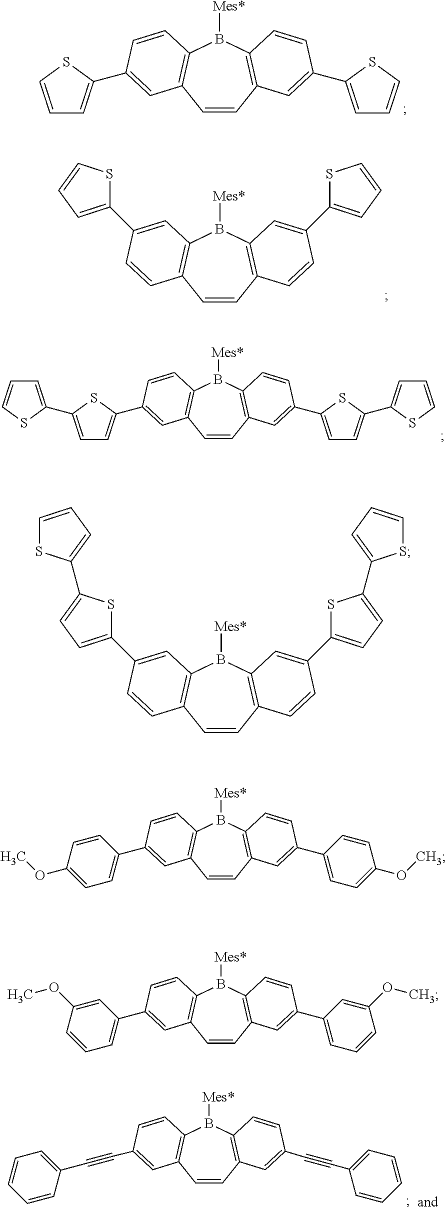

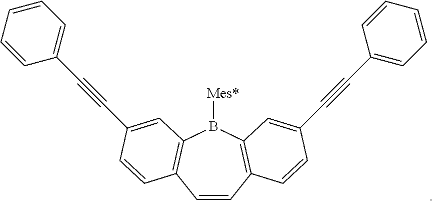

In some embodiments, the compound of Formula (Ib) is selected from the group consisting of:

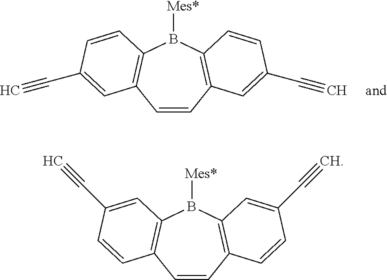

In some embodiments, the compound of Formula (Ib) comprises a DBB polymer selected from the group consisting of:

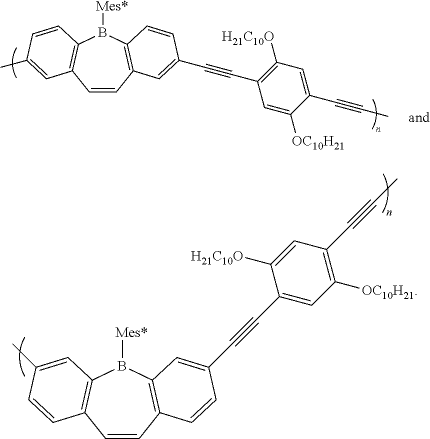

More particularly, referring now to Scheme 2, brominated DBBs 14a-b were targeted to allow for more facile cross-coupling reactions due to the anticipated enhanced reactivities of aryl bromides under palladium catalyzed cross-coupling chemistries. The syntheses of the brominated DBBs are shown in Scheme 2. The common bromoiodobenzylbromide precursors 15a-b were used to prepare phosphonium salts 16a-b via Arbuzov chemistry while N-methylmorpholine N-oxide mediated oxidations furnished benzaldehydes 17a-b. The stilbenes were assembled by Wittig reactions between 16 and 17 to form stilbenes 18a-b with a Z:E selectivity of greater than 82%. Dunne, E. C., et al., Tet. Lett. 2002, 43, 2449-2453.

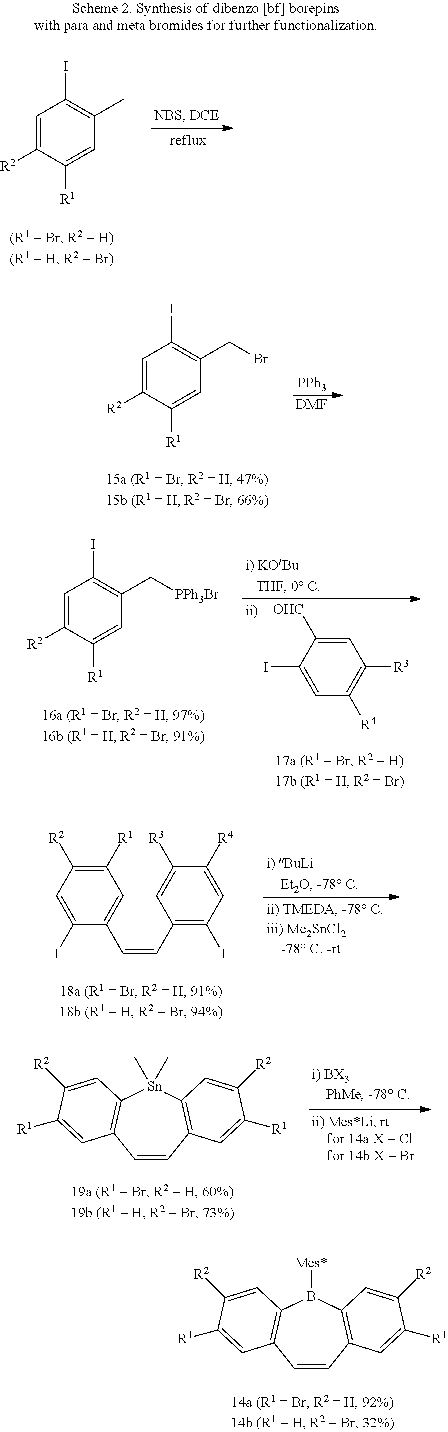

Subsequently, chemo-selective lithium-halogen exchange at the iodides of 18 followed by in situ treatment of the dilithio species with dimethyltin dichloride resulted in formation of the brominated stannepins 19a-b. Tin-boron exchange proved to be very capricious and highly sensitive to any trace air and/or moisture present especially in the toluene. Tin-boron exchange between stannepin 19a and boron trichloride furnished a B-chloro DBB that was treated in situ with Mes*Li, \check{S}terk, D., et al., J. Org. Chem. 2007, 72, 8010-8018, to form the para brominated B-Mes* DBB 14a in 92% yield; however, utilizing this procedure for the synthesis of the meta-DBB 14b resulted in yields ranging from 6-14% with the remainder of the material being B-hydroxy DBB formed through unavoidable oxidation of the intermediate B-chloro DBB species. Since a large excess (5 eq.) of Mes*Li was added, without wishing to be bound to any one particular theory, it is thought that the B-chloro DBB intermediate formed from 19b was not as reactive as that from 19a possibly due to the electronics of the meta-brominated ring system. As a result, boron tribromide was chosen for the tin-boron exchange with 19b followed by the addition of Mes*Li at room temperature. These alterations increased the yield of 14b to 32%. Installation of the Mes* group at the boron center rendered the DBBs stable against air, moisture and even nucleophiles, such as fluoride, thus allowing for standard synthetic manipulation and purification by column chromatography under ambient conditions.

Pd-Mediated Cross-Couplings.

The meta and para brominated DBBs were subjected to a variety of palladium-catalyzed cross-coupling reactions to tune electronic properties (e.g., Stille, Suzuki and Sonogashira, see Table 2). These coupling methods required a broad range of cross-coupling partners and reaction conditions, thus showing the robustness of the borepin core. Stille couplings of stannylated thiophene and bithiophene with 14a-b (in dimethyl formamide at 80° C.) led to coupled products 20a, 20e and 20b, 20f, respectively. The Suzuki coupling of 4-methoxyphenyl boronic acid with 14b (in biphasic toluene/aqueous potassium bicarbonate at reflux) led to the corresponding aryl coupled product 20g while Sonogashira couplings of 14a-b with phenylacetylene (in toluene and diisopropylamine at 75° C.) furnished products 20d, h. The borepin core survived all of these chemical exposures, and all coupling products were handled and purified under ambient conditions. These compounds also exhibited stability toward thermal decomposition, as seen by the heating of 20b to 130° C. for 45 min without noticeable decomposition by ¹H-NMR.

TABLE 2
B-Mes* dibenzo[b,ƒ]borepins functionalized by Stille (20a-b, e-f),
Suzuki (20g), and Sonogashira (20d, h) cross-coupling reactions.

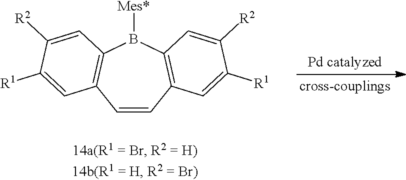

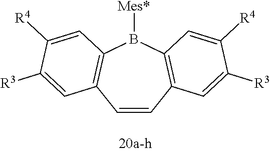

| DBB | product | R³ | R⁴ | yield |
|---|---|---|---|---|
| 14a | 20a | 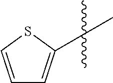 [SMILES: *c1cccs1] | H | 53% |
| 14a | 20b | 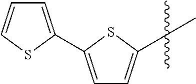 [SMILES: *c1ccc(-c2cccs2)s1] | H | 73% |
| 14a | 20c | 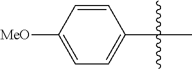 [SMILES: *c1ccc(OC)cc1] | H | ^{a} |
| 14a | 20d | 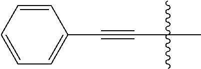 [SMILES: *C#Cc1ccccc1] | H | 56% |
| 14b | 20e | H | 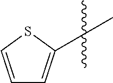 [SMILES: *c1cccs1] | quant. |
| 14b | 20f | H | 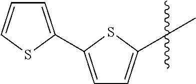 [SMILES: *c1ccc(-c2cccs2)s1] | 56% |
| 14b | 20g | H | 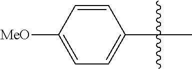 [SMILES: *c1ccc(OC)cc1] | 79% |
| 14b | 20h | H | 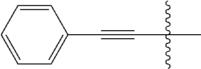 [SMILES: *C#Cc1ccccc1] | 33%^{b} |

^{a}20c was previously synthesized by Kumada cross-coupling. See Caruso Jr., A., et al., Angew. Chem. Int. Ed., 2010, 49(25), 4213-4217.
^{b}Yield determined by ¹H-NMR.

Sonogashira coupling between the DBBs and trimethylsilyl acetylene under standard conditions yielded para and meta TMS-protected diethynyl DBBs in 97% and 64% yields respectively (Scheme 3). Subsequent TMS deprotection with methanol and potassium carbonate in THF gave terminal para and meta acetylenes that were then polymerized under Sonogashira cross-coupling conditions with 1,4-bis(decyloxy)-2,5-diiodobenzene, Swager, T., et al., J. Phys. Chem. 1995, 99, 4886-4893, to form poly(arylene)ethynylene polymers 21a and 21b respectively (Scheme 3). Molecular weight determination of the polymers by gel permeation chromatography (GPC) revealed reasonable polydispersity indexes of 2.45 (21a) and 1.93 (21b); furthermore, both polymers are readily soluble in common organic solvents (i.e., chloroform, toluene), which could enable solution processing.

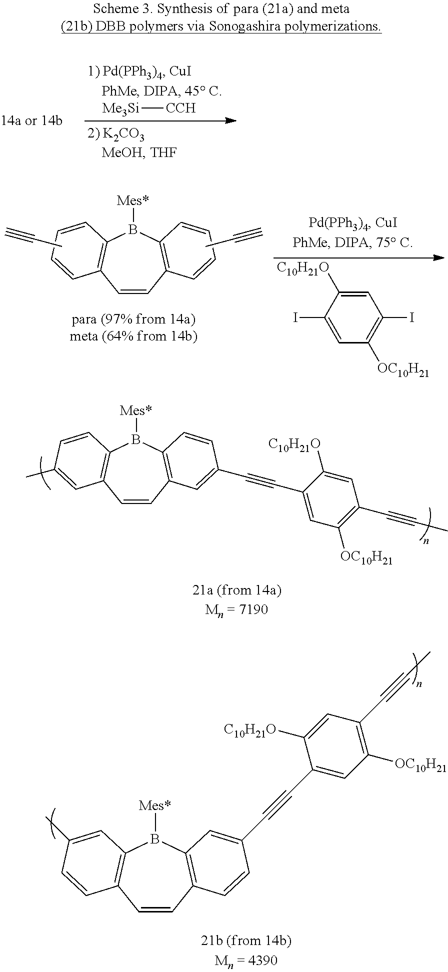

To further explore the stability of the DBBs toward even more aggressive reaction conditions, para-DBB 14a was subjected to Buchwald-Hartwig amination conditions. This cross-coupling installed diphenylamine onto the DBB core by palladium catalysis in the presence of sodium tert-butoxide in toluene at 100° C. in 60% yield with no sign of borepin decomposition (Scheme 4). Attempts to synthesize the meta bis(diphenylamino) DBB from 14b resulted in protio DBB and starting materials, suggesting that the proximity of the Mes* and the meta bromides precluded the insertion of the diphenylamine moiety due to steric restraints. DBB 20i has the general structure of D-π-A-π-D, where D is an electron donor, π is a π-conjugated bridge, and A is an acceptor, which has been shown to be an efficient chromophore motif useful for two-photon absorption processes. Albota, M., et al., Science 1998, 281, 1653. It also might be possible to use boron or nitrogen centered redox activity to control intramolecular charge-transfer processes within molecules such as 20i and analogs of the same design.

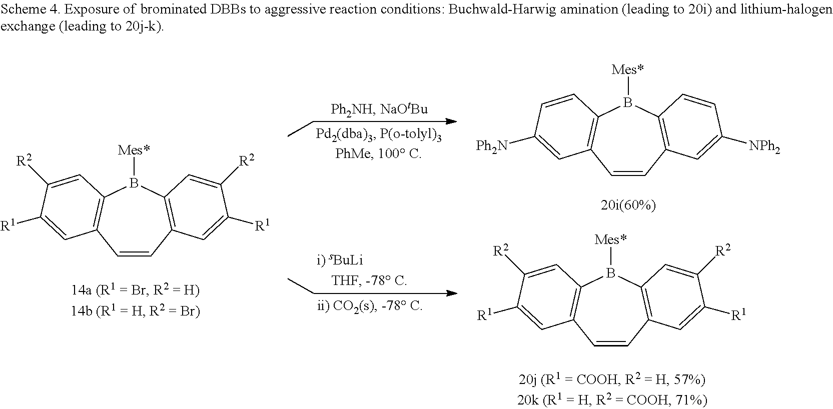

Lithium-Halogen Exchange.

The presently disclosed subject matter also demonstrates that DBBs 14a-b could undergo lithium-halogen exchange with sec-BuLi in THF at −78° C. followed by quenching with an electrophile, in this case solid carbon dioxide, to form diacid DBBs 20j-k in 57% and 71% yields respectively (Scheme 4). This general procedure should be applicable to install other functional groups, including, but not limited to, aldehydes, which could then be used to synthesize polymers or extended systems that incorporate arylene vinylene motifs through Wittig or Horner-Wadsworth olefinations.

Frontier Molecular Orbital Calculations.

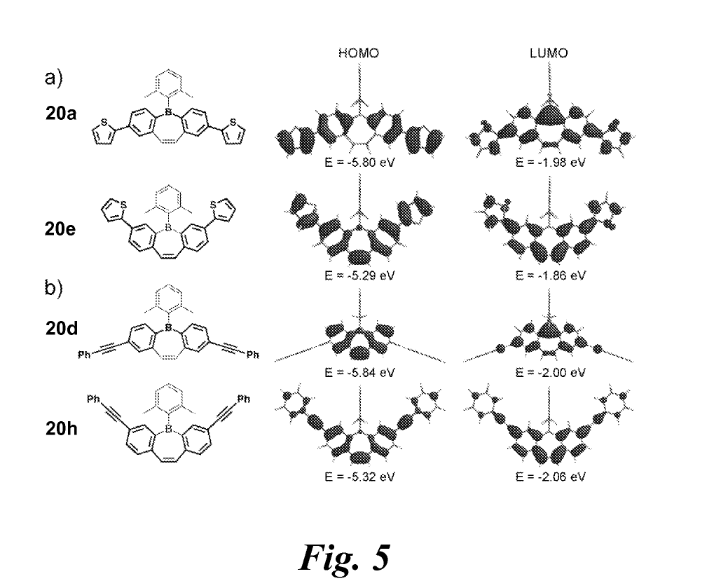

Density Functional Theory (B3LYP/6-31G*) calculations were carried out for the highest occupied molecular orbital (HOMO) and lowest unoccupied molecular orbital (LUMO) of the DBB systems (using B-2,6-dimethylphenyl rather than B-Mes*, FIG. 5) with substituents attached at the meta and para positions to gain insight into the effect of site specific functionalization on the frontier molecular orbital densities. These calculations revealed a node in the HOMO located at the boron center for DBBs 20a-c and 20e-g when functionalization was at the para position effectively dividing the HOMO in half, while the HOMO of the meta substituted DBBs were continuous and fully delocalized onto the substituents (representative surfaces shown in FIG. 5). Only the phenylacetylene functionalized DBBs 20d, h did not follow this trend due to the phenyl group of the substituent being rotated orthogonal to the DBB core; however, DFT calculations done on the para 4-ethynylanisole-substituted DBBs exhibited similar frontier molecular orbital surfaces as 20a-c. This observation suggests that electron rich substituents lead to a more planar molecule to optimize the charge-transfer interaction to the boron center as evident in the large wavefunction densities located on boron in the LUMO.

Optical Characterization.

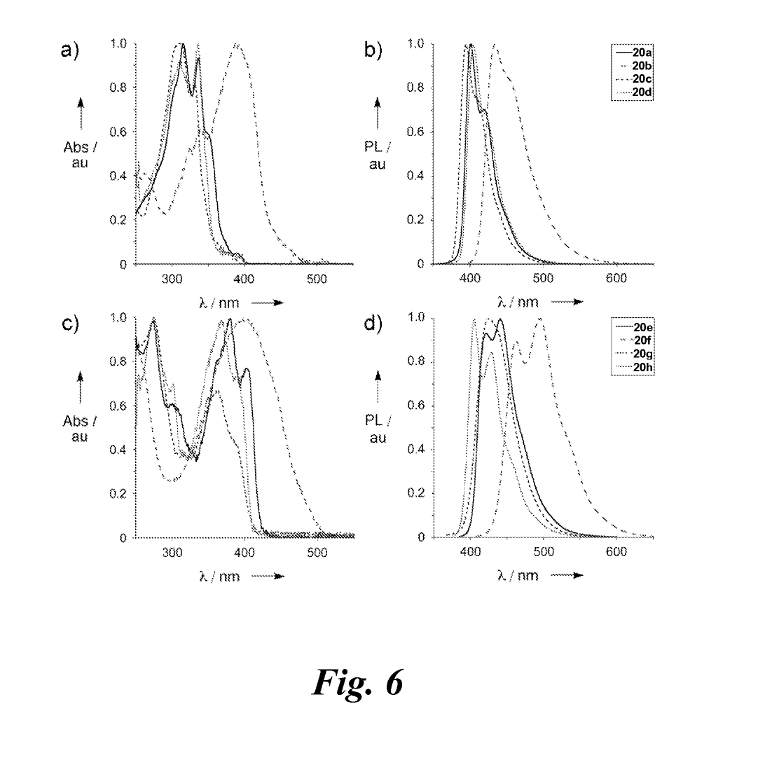

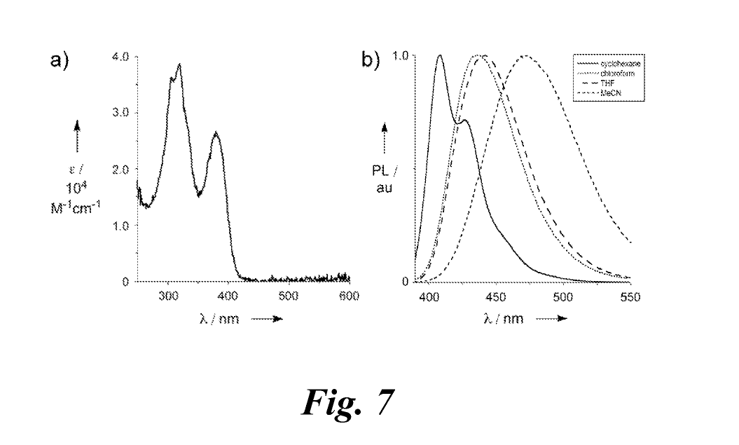

Solution-phase absorption, photoluminescence (PL), and lifetime data were measured to observe how different substituents and conjugation paths through the DBBs affected electronic properties. FIG. 6 shows the optical characterization data for the para and meta functionalized DBBs 20a-h which also have been compiled numerically in Table 3. Representatively, the para-DBB 20a had a weak low-energy charge-transfer band at 389 nm and more intense higher energy π-π signature centered at 315 nm. In contrast, the absorption profile of the meta-DBB 20e did not show the weak charge-transfer band and the π-π* transitions were red-shifted by over 50 nm. The photoluminescence maximum observed at 401 nm (with a shoulder at 419 nm) for 20a was sharp and at higher energy than that of 20e, which exhibited a bimodal emission with maxima centered at 422 and 441 nm. The para-DBB 20a had an average weighted photoluminescence lifetime (<τ>) of 5.63 ns compared to 2.75 ns for the meta-DBB 20e. The rest of the DBBs followed the same trend (see Table 3) with red-shifted absorption and emission profiles and shorter <τ> upon going from the para to meta-DBBs with a particular substituent; however, no notable trends were observed in the radiative (kᵣ) and non-radiative (kₙᵣ) rate processes among the isomeric compounds surveyed. Regardless of the regiochemistry of the substitution, all of the substituted DBBs had red-shifted absorption and emission profiles with respect to the protio-DBB. Unlike the Piers silepins, no significant solvatochromism (that is, no greater than 10 nm shifts) were observed for the corresponding borepins except for the strongly donating diphenylamine substituted DBB 20i, see FIG. 7, which showed a fluorescence λₘₐₓ red-shift of 65 nm on going from a non-polar solvent (cyclohexane) to a polar solvent (acetonitrile). While negligible solvatochromism was found for the anisole functionalized DBB 20c, the analogous silepin in the associated paper (p-1-PhOMe), Mercier, L. G., et al., Organometallics, 2011, 30, 1719-17-29, showed a 25-nm fluorescence red-shift in moving to more polar solvents. This observation is not unexpected because the wavefunctions for the borepin HOMOs and LUMOs are much more equally distributed throughout the molecular core when compared to the silepins.

TABLE 3
Optical properties of functionalized B-Mes* dibenzo[b, f]borepins.

| | Abs | | | | | |
|---|---|---|---|---|---|---|
| | λ/nm | PL | | | kᵣ/ | kₙᵣ/ |
| Compound | (logε) | λ/nm | Φ_{F}/% | <τ>/ns | 10⁹ ns⁻¹ | 10⁹ ns⁻¹ |
| protio-DBB^{†} | 357 (3.56) | 384 | 36 | n.a. | n.a. | n.a. |
| | 340 (3.76) | | | | | |
| | 321 (4.29) | | | | | |
| | 309 (4.36) | | | | | |
| 20a | 350 (5.41) | 401, 419 | 35 | 5.5 | 0.0636 | 0.118 |
| | 337 (5.60) | | | | | |
| | 315 (5.64) | | | | | |
| 20b | 388 (4.87) | 434, 454 | 45 | 0.63* | 0.714 | 0.873 |
| | 339 (4.66) | | | | | |
| 20c^{†} | 381 (3.55) | 395, 411 | 38 | 7.2 | 0.0528 | 0.0861 |
| | 363 (3.84) | | | | | |
| | 331 (4.77) | | | | | |
| | 310 (4.86) | | | | | |
| 20d | 389 (3.46) | 403, 423 | 43 | 7.1 | 0.0606 | 0.0803 |
| | 371 (3.63) | | | | | |
| | 336 (4.81) | | | | | |
| | 311 (4.77) | | | | | |
| 20e | 402 (4.12) | 422, 441 | 39 | 2.8* | 0.139 | 0.218 |
| | 380 (4.23) | | | | | |
| | 303 (4.01) | | | | | |
| | 273 (4.23) | | | | | |
| 20f | 399 (4.35) | 462, 496 | 33 | 0.71* | 0.465 | 0.944 |
| 20g | 385 (4.32) | 425 | 60 | 5.7* | 0.105 | 0.0701 |
| | 361 (4.51) | | | | | |
| | 274 (4.68) | | | | | |
| 20h | 390 (3.79) | 405, 428 | 99.8 | 1.6* | 0.624 | 0.00125 |
| | 367 (3.92) | | | | | |
| | 274 (3.93) | | | | | |
| 20i | 380 (4.42) | 437 | 23 | 5.1 | 0.0451 | 0.151 |
| | 319 (3.59) | | | | | |
| 21a | 397 (n.a.) | 442, 470 | 69 | 0.92 | 0.750 | 0.337 |
| | 339 (n.a.) | | | | | |
| | 304 (n.a.) | | | | | |
| 21b | 410 (n.a.) | 462, 491 | 64 | 0.89 | 0.720 | 0.404 |

All lifetime data were fit to single exponential decays except for those marked with an asterisk (*), which were double exponential.
^{†}Lorbach, A., et al., Angew. Chem. Int. Ed. 2009, 121, 4654-4658.

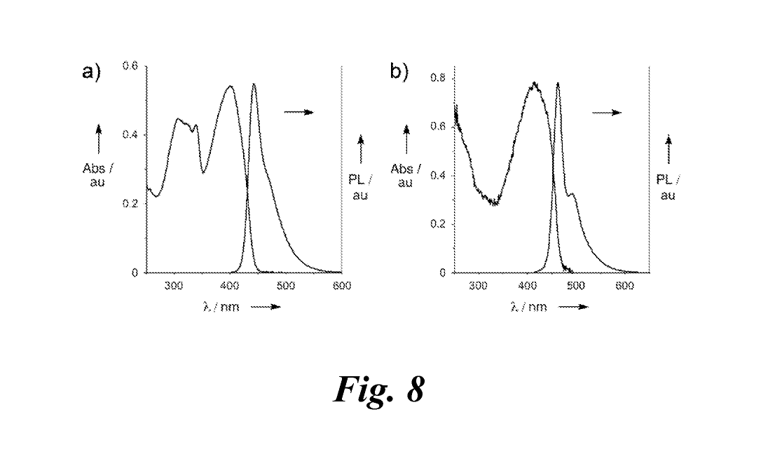

The para polymer 21a had an onset of absorption at 449 nm and a more intense band centered at 397 nm with higher energy vibrational fine structure, whereas the meta polymer 21b onset was red-shifted by 24 nm. The photoluminescence spectra for both polymers were intense with quantum yields near 70% with the maximum for meta polymer 21b observed at 462 nm being red-shifted by 20 nm compared to that of the para polymer 21a. Additionally, para polymer 21a had a <τ> of 0.92 ns and meta polymer 21b had a <τ> of 0.89 ns. It was surprising that both polymers had near identical quantum yields and lifetimes. Otherwise, these polymers exhibited the same photophysical trends (FIG. 8) as all of the previously discussed substituted DBBs with the meta isomer having red-shifted absorption and photoluminescence spectra with respect to the para isomer.

Electrochemical Characterization.

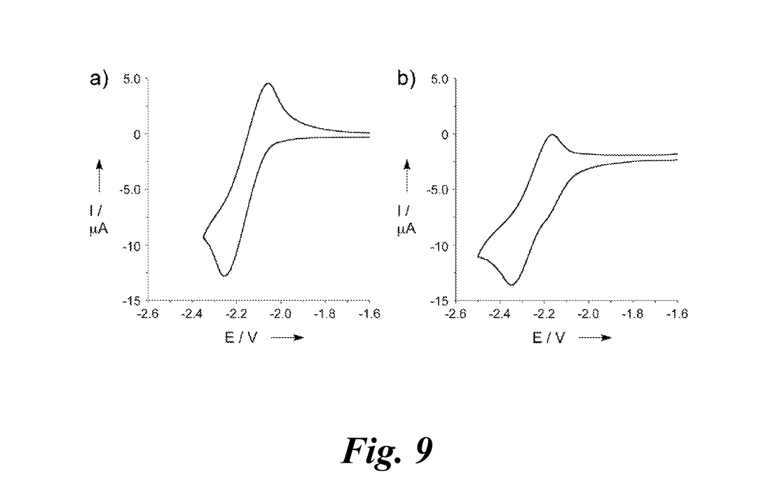

Cyclic voltammetry (CV) performed on the presently disclosed DBBs revealed reversible one-electron reduction peaks presumed to originate from the vacant p-orbitals of the boron centers. FIG. 9 shows representative CVs for the reversible reduction of 20a (E_{1/2}=−2.15 V) and 20e (E_{1/2}=−2.26 V), which shows that the reduction half-wave potential (E_{1/2}) for the para-substituted DBB was 110 mV less negative than the meta-DBB (data compiled numerically in Table 4). This difference can be rationalized by the fact that the para-DBB 20a includes the boron center in the π-electron delocalization pathway resulting in a more facile reduction, while the meta-DBB 20e extends linear conjugation through the carbon-carbon double bond moiety. In general, the reduction potentials for all of the para-DBBs were less negative than those for the corresponding meta-DBBs (see Table 4) with exception of the phenyl acetylene substituted DBBs, which showed identical reduction potentials as a result of the π-conjugating phenyl groups being orthogonal to the DBB cores. Furthermore, all substituted DBBs had more positive reduction potentials than the protio-DBB (E_{1/2}=−2.54 V) suggesting that any substitution on the ring regardless of regiochemistry helps to make the system more reducible.

TABLE 4
Electrochemical properties of functionalized B-Mes*
dibenzo[b,f]borepins.

| | Abs | | | E_{red} |
|---|---|---|---|---|
| Compound | λₒₙₛₑₜ/nm | E_{g} (eV) | E_{1/2} (V) | (eV) |
| protio-DBB^{†} | 358 | 3.46 | −2.54 | −3.47 |
| 20a | 400 | 3.10 | −2.15 | −3.06 |
| 20b | 491 | 2.53 | −2.10 | −2.99 |
| 20c^{†} | 392 | 3.16 | −2.23 | −3.12 |
| 20d | 400 | 3.10 | −2.10 | −3.09 |
| 20e | 426 | 2.91 | −2.26 | −3.14 |
| 20f | 510 | 2.43 | −2.19 | −2.98 |
| 20g | 416 | 2.98 | −2.40 | −3.24 |
| 20h | 412 | 3.01 | −2.10 | −3.09 |
| 20i | 418 | 2.97 | −2.23 | −3.32 |
| | | | +0.20 | |
| | | | +0.78 | |
| 21a | 449 | 2.76 | n.a. | n.a. |
| 21b | 473 | 2.62 | n.a. | n.a. |

E_{g} calculated from λₒₙₛₑₜ and E_{red} calculated from onset of the reduction wave and referenced to the energy level of Fc/Fc⁺ taken as −4.8 eV.
^{†}Lorbach, A., et al., Angew. Chem. Int. Ed. 2009, 121, 4654-4658.

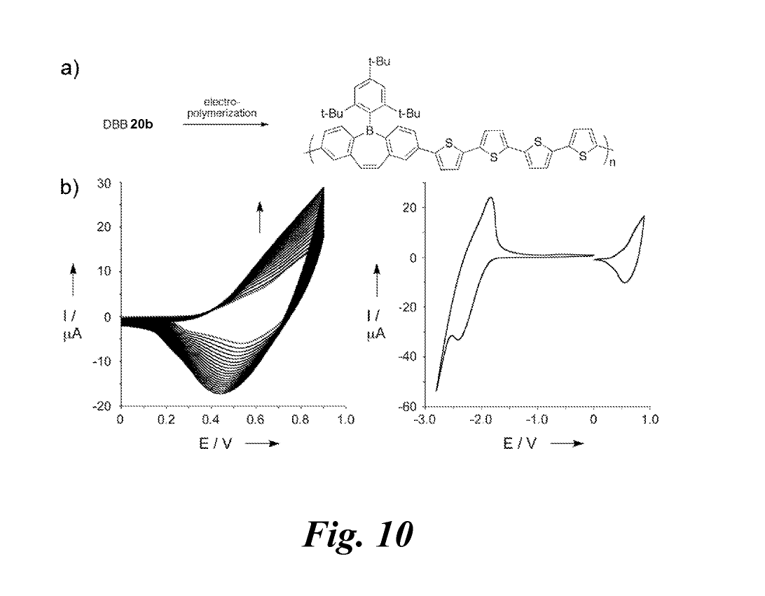

With repeated cycles to ca. +900 mV in the CV experiment, monomer 20b eventually polymerized due to oxidation of the bithiophene segment and subsequent follow-up oligomerization. Under comparably positive applied potentials, monomers 20a, e, and f appeared to oxidize irreversibly but did not polymerize or otherwise deposit on the working electrode. The CVs recorded during the polymerization of 20b and the subsequent polymer CV of poly(20b) recorded in monomer-free electrolyte are shown in FIG. 10. Poly(20b) showed a reversible reduction with an E_{1/2} of −2.12 V (vs −2.10 for the monomer) and an anodic peak potential (Eₚₐ) of 0.81 V. This observation indicates that the borepin cores remain electronically isolated along the polymer; furthermore, anodic polymerization is a fairly destructive technique compared to chemical cross-coupling methods, and the borepin appears to be no more susceptible to oxidative damage than do typical electropolymerizable monomers. Attempts to chemically polymerize 20b via iron (III) chloride oxidation were unsuccessful; however, it should be noted that the failed attempts resulted in recovery of the monomer, testifying to the stability of the DBB core under oxidizing conditions.

Comparison to dibenzo[b,f]silepins

Boron and silicon are emerging as two attractive constituents for main-group functional π-conjugated electronic materials. In an associated paper, Mercier, L. G., et al., Organometallics, 2011, 30, 1719-17-29, present the synthesis of a variety of para and meta functionalized dibenzo[b,f]silepins in parallel for comparison to the DBBs disclosed herein. The syntheses of their silicon-containing compounds utilized Wittig chemistry to form halogenated cis-stilbene precursors that could be converted into the silepins by quenching the appropriate dilithio stilbene with dimethylsilicon dichloride. Similar to the DBBs, the silepin cores withstood a variety of palladium catalyzed cross-coupling conditions. The Piers strategy was to use these functionalized silepins as substrates for borepin formation via silicon-boron exchange, and they demonstrated one example of this transformation. In comparing the photophysical properties, the para- and meta-DBBs all had smaller HOMO-LUMO energy gaps than the corresponding silepins, which is evidenced by the red-shifted absorption profiles. This observation suggests that the tri-coordinate boron center is crucial for complete electron delocalization in the para-DBBs and imparts a more planar geometry relative to the boat-shaped silepin cores. In the meta-DBBs and silepins, the boron and silicon centers are not intimately involved in the conjugation pathway; however, they act to planarize the stilbene portion of the molecule which the trigonal planar boron does more effectively than the tetrahedral silicon as witnessed by the red-shifted onsets of absorption. The meta-silepins were more easily reduced than the corresponding para silepins; however, this trend was opposite for the borepins indicating that π-conjugation to the vacant p-orbital stabilizes the LUMOs.

In summary, the presently disclosed subject matter provides a synthetic approach that enables the formation of extended DBB systems through a variety of palladium catalyzed cross-coupling reactions, including Suzuki, Stille, Buchwald-Hartwig and Sonogashira chemistries, as well as the ability to install electrophiles after lithium-halogen exchange. This approach has been made possible by the installation of bromides on robust B-Mes* DBB cores and has led to the rapid diversification with aryl, heteroaromatic, alkynyl and carbonyl substituents from common core scaffolds. These molecules also could be included in π-conjugated polymer architectures through chemical or even electrochemical polymerization techniques. These synthetic investigations have allowed for a study of how the substitution patterns influence photophysical and electrochemical properties. The presently disclosed subject matter demonstrates that meta-substitution decreases the optical band gap while para-substitution raises the electron affinity of the system. This observation enables the selective tuning of the HOMO and LUMO energy levels and wavefunctions of the DBB system by altering the substituent and/or its location around the DBB core. The ability to functionalize the DBB core from a common dibromo DBB scaffold under a variety of reaction conditions, which leads to a diverse array of functional groups, makes it a new π-conjugated building block for application-specific electronic fine-tuning in future studies.

### D. Conjugated “B-Entacenes:” Polycyclic Aromatics Containing Two Borepin Rings

The synthesis of new organic electronic materials has been given considerable attention in recent years as a result of the ability to readily tune physical, electrochemical and photophysical properties. Acenes and heteroacenes have become leading candidates for replacing amorphous silicon and other inorganic materials in systems that require low cost, highly tunable and easily processable materials for applications such as thin film transistors (TFTs), Gundlach, D. J., et al., Nature Materials 2008, 7, 216-221, sensors Khan, H. U., et al., Chem. Mater. 2011, Article ASAP, and photovoltaics. Anthony, J. E., et al., Adv. Mater. 2010, 22, 3876-3892; Ling, M. M., et al., Adv. Mater. 2007, 19, 1123-1127.

In fact, in some areas pentacene already rivals the performance of amorphous silicon. Dimitrakopoulos, C. D.; Malenfant, P. R. L. Adv. Mater. 2002, 14, 99-117. To date, the majority of acenes and heteroacenes synthesized and studied have been p-channel (hole-transporting) semiconductors due to the difficulty in synthesizing air-stable n-channel (electron-transporting) semiconductors.

More recently, progress has been made in preparing n-channel materials by the functionalization of acenes and heteroacenes as well as their incorporation into polymers. For example, Bao et al., see Okamoto, T., et al., Chem. Mater. 2011, Article ASAP; Tang, M. L., et al., J Am Chem Soc 2009, 131, 3733-3740; Tang, M. L., et al., J Am Chem Soc 2006, 128, 16002-16003; and Anthony, et al., see Anthony, J. E., et al., Adv. Mater. 2010, 22, 3876-3892; Swartz, C. R., et al., Org. Lett. 2005, 7, 3163-3166, have independently reported the functionalization of acenes and heteroacenes with electron deficient groups as a method of increasing the electron-transporting ability of these materials.

Further, Wu et al., see Sun, Z., et al., Org. Lett. 2010, 12, 4690-4693, has synthesized soluble and stable zethrenebis (dicarboximide)s and their corresponding quinones. Bunz and co-workers systematically replace carbons in the acene backbone with heteroatoms (specifically nitrogen) resulting in hole- and electron-transporting materials, Wu, J. I., et al., J. Org. Chem. 2009, 74, 4343-4349; Miao, S., et al., Chem. Eur. J. 2009, 15, 4990-4993, while Yamaguchi, et al., see Wakamiya, A., et al., J. Am. Chem. Soc. 2009, 131, 10850-10851; Wakamiya, A., et al., Chem. Commun. 2008, 579-581; Yamaguchi, S.; Wakamiya, A. Pure Appl. Chem. 2006, 78, 1413-1424; Yamaguchi, S., et al., J. Am. Chem. Soc. 2002, 124, 8816-8817, and Perepichka et al., see Lepeltier, M., et al., Chem. Commun. 2010, 46, 7007-7009, have inserted boron centers into p-conjugated systems such as boroles and azaborine-thiophene heteroacenes, respectively.

The insertion of neutral, planar boron centers, which are inherently electron deficient, into pi-conjugated materials results in electron-accepting materials. Polycyclic borepin aromatics that could undergo reversible cathodic processes have previously been reported. Caruso, A., et al., Angew. Chem. Int. Ed. 2010, 49, 4213-4217. The presently disclosed subject matter provides the synthesis of extended fused polycyclic aromatics containing two formally aromatic borepin rings and the study of a series of phenyl acetylene functionalized systems with electron donating, withdrawing and neutral substituents.

In some embodiments, the presently disclosed synthetic approach can be extended to pentacyclic aromatics bearing two fused borepin rings in a sense analogous to pentacyclic aromatic hydrocarbons, such as pentacene or dibenz[a,h]anthracene, or as model systems for extended ladder polymers. See Yamaguchi, et al., Pure Appl. Chem. 2006, 78, 721-730.

Accordingly, in some embodiments, the presently disclosed subject matter provides a compound of Formula (IV):

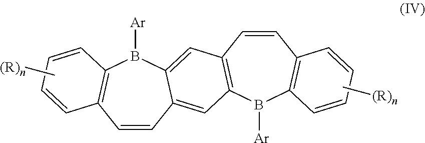

wherein n is an integer from 0 to 4; Ar is selected from the group consisting of phenyl and substituted phenyl; R at each occurrence is independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings; and oligomers and polymers thereof.

In some embodiments, the substituted phenyl is selected from the group consisting of 2,6-dimethylphenyl, 2,4,6-tri-iso-propylphenyl, 2,4,6-tri-tert-butylphenyl, 2,4,6-trimethyl phenyl, and 4-cyanophenyl. One of ordinary skill in the art would appreciate that other bulky, steric groups also would be suitable for use with the presently disclosed compounds.

In some embodiments, the compound of Formula (IV) has a structure selected from the group consisting of:

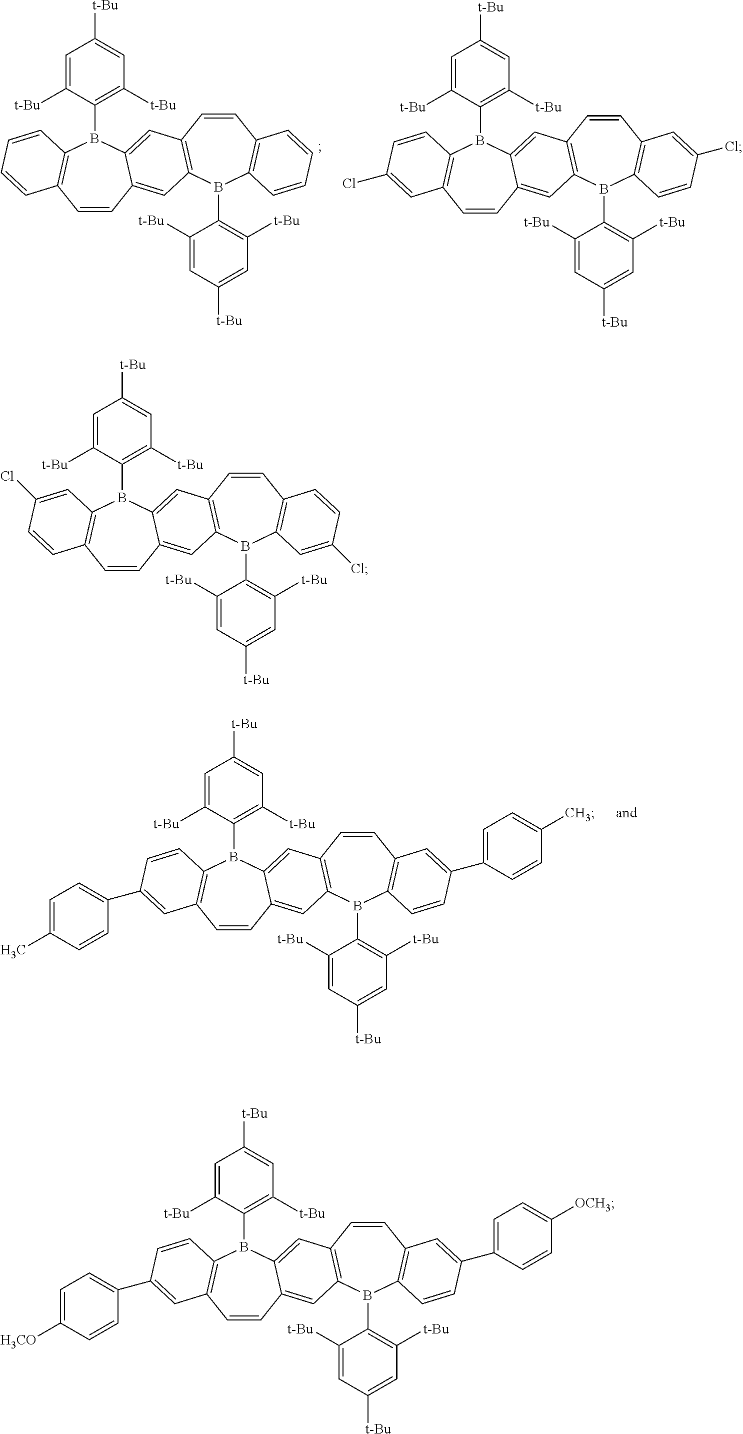

wherein t-Bu is a tertiary butyl group.

In some embodiments, the compound of Formula (IV) is selected from the group consisting of:

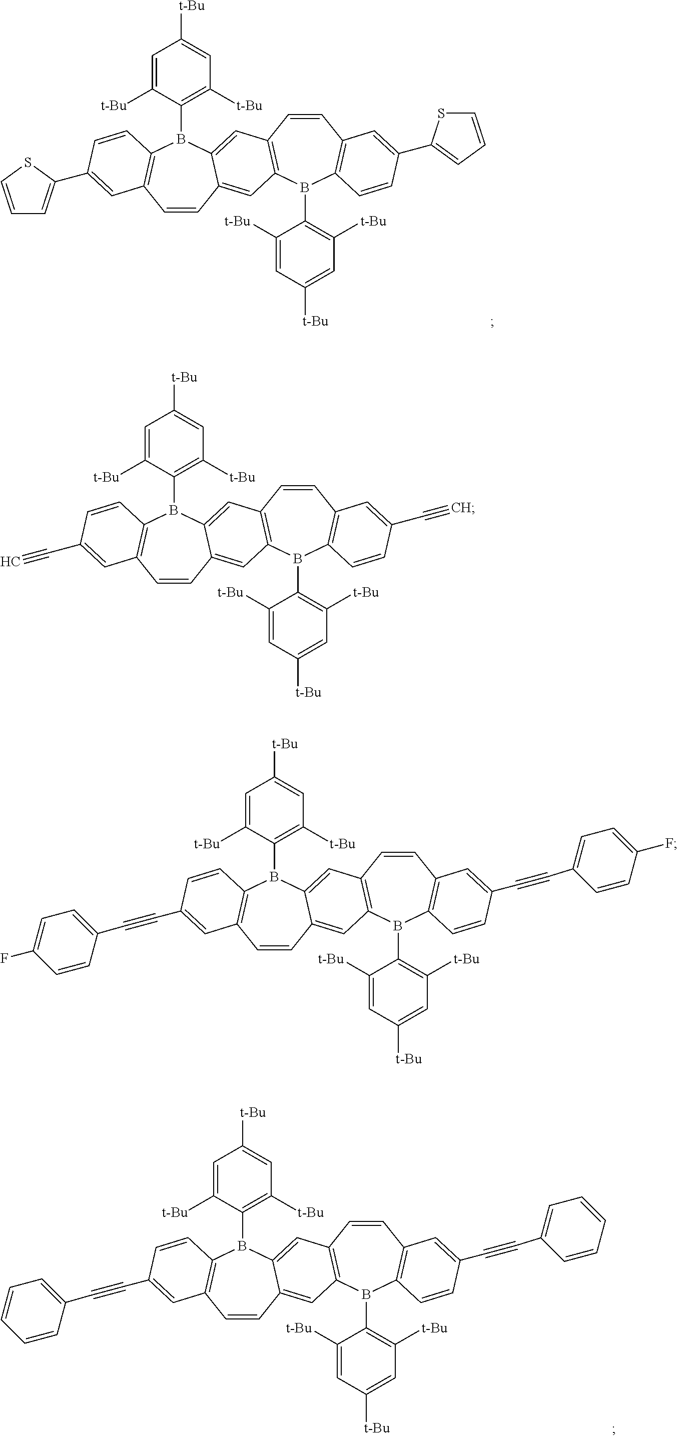

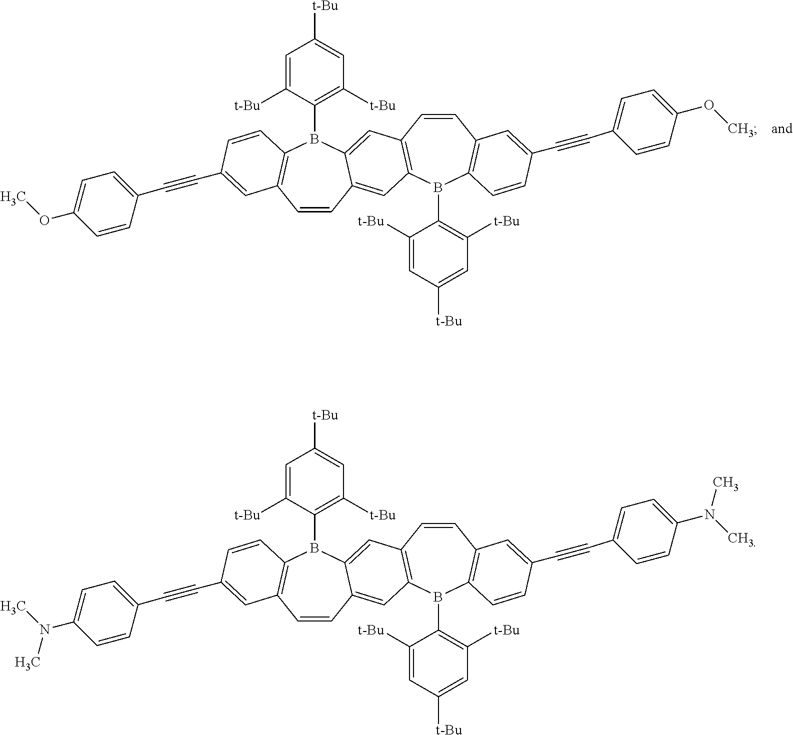 [SMILES: COc1ccc(C#Cc2ccc3c(c2)C=Cc2cc4c(cc2B3c2c(C(C)(C)C)cc(C(C)(C)C)cc2C(C)(C)C)C=Cc2cc(C#Cc3ccc(OC)cc3)ccc2B4c2c(C(C)(C)C)cc(C(C)(C)C)cc2C(C)(C)C)cc1 ; CN(C)c1ccc(C#Cc2ccc3c(c2)C=Cc2cc4c(cc2B3c2c(C(C)(C)C)cc(C(C)(C)C)cc2C(C)(C)C)C=Cc2cc(C#Cc3ccc(N(C)C)cc3)ccc2B4c2c(C(C)(C)C)cc(C(C)(C)C)cc2C(C)(C)C)cc1]

In some embodiments, the compound of Formula (IV) is a polymer having the following formula:

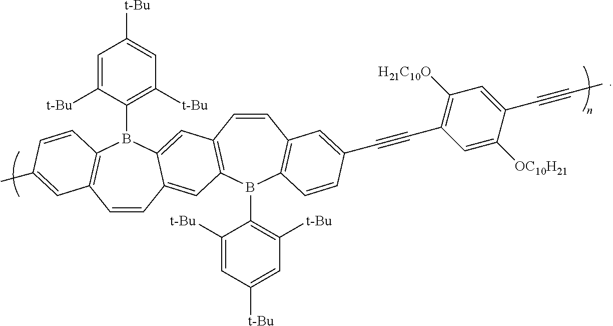

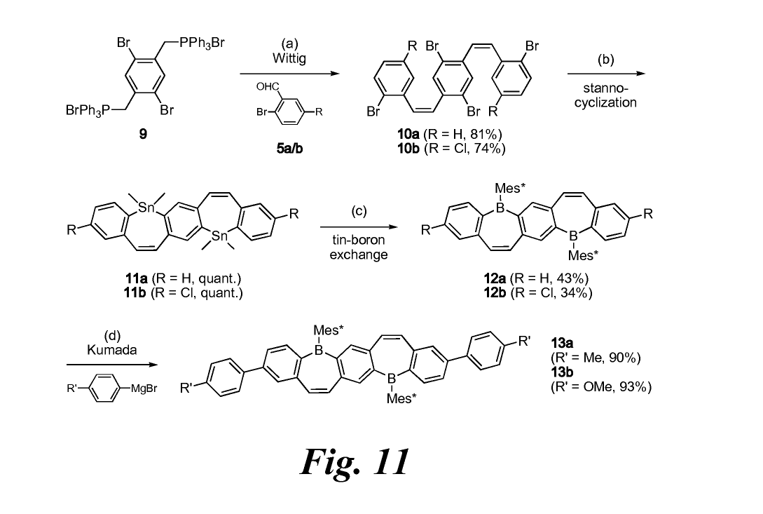

Accordingly, the general synthetic approach described hereinabove was applied to even larger fused polycyclic aromatics (see FIG. 11). The bis(phosphonium salt) 9, see Bonifacio, M. C., et al., J. Org. Chem. 2005, 70, 8522-8526, was subjected to a double-Wittig olefination with bromo-benzaldehyde 5a to yield tetrabromide 10a. Tetra-lithiation of 10a followed by double stanocyclization led to 11a. A double tin-boron exchange with BCl₃ generated a bis-B—Cl intermediate that, when treated in situ with Mes*Li, ultimately yielded the fused pentacyclic aromatic 12a.

This structure is fundamentally different from the DBB core because it now contains a para-phenylene diborane core, see Kaim, W., Schulz, A., Angew. Chem. Intl. Ed. Engl. 1984, 23, 615-616, or from another angle, a central benzene core fused with two borepin rings. Like the B-Mes* DBBs, 12a could be handled under ambient conditions with no obvious decomposition. Using the same strategy as for 1e, chlorides were installed para to the boron centers of 12b and successfully underwent transformation under Ni catalysis to provide bench-stable aryl-substituted compounds 13a/b. These compounds were thermally robust: 13a showed no signs of decomposition after being held under ambient conditions at 130° C. for 30 min, and the low energy spectral signatures associated with the tricoordinate boron-based heteroaromatic persisted after heating a sample over 250° C. in a melting-point apparatus.

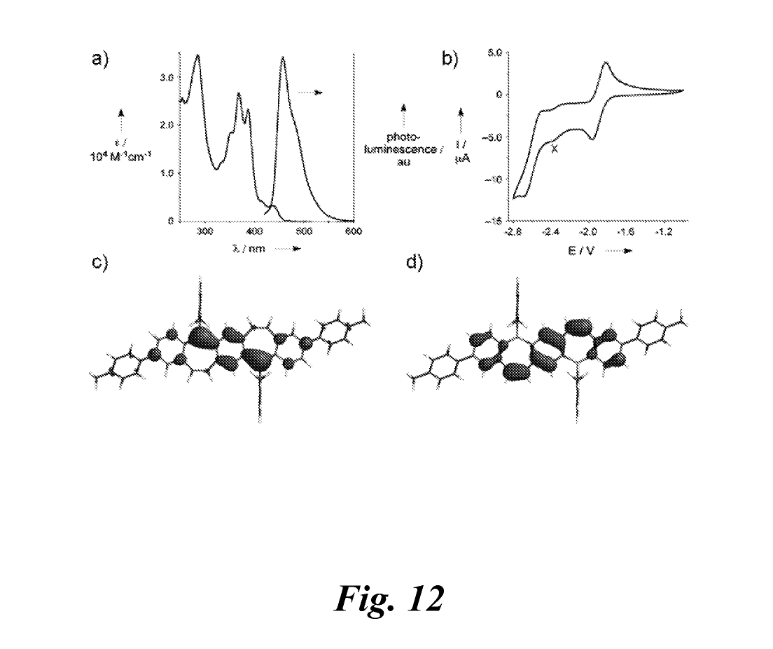

FIG. 12 provides representative characterization data for the unfunctionalized ring system 12a. Like the smaller DBB and other common polycyclic aromatics, the absorption profile of 12a revealed a low-energy feature at 439 nm with low oscillator strength attributed to intramolecular charge transfer along with much more intense absorptions at higher energy including some with strong vibronic coupling around 375 nm (FIG. 12a). The photoluminescence observed at 456 nm was fairly intense with a quantum yield (F_{F}) of 73% relative to quinine sulfate. The cathodic CV indicated two reversible reduction steps with E_{1/2} values of −1.89 and −2.59 V (FIG. 12b), both of which were much less negative than those found for standard triarylboranes.

As described hereinabove, the spacing between the two cathodic processes for 7 (DE_{1/2}) was 230 mV, whereas that for 12a was even larger (DE_{1/2}=700 mV). This observation is consistent with the proximity of the boron centers being separated formally by an intervening phenyl group in 12a and a biphenyl unit in 7. The smaller DE_{1/2} for 7 also could be due to Coulombic effects that place electronically isolated radical anions at a greater distance than for 12a, but it is important to note that the initial E_{1/2} for dimer 7 is almost 600 mV less negative than that for 1c, thus indicating some extent of existing electronic communication that facilitates the reduction. Importantly, all cathodic processes observed for these molecules were reversible thus suggesting that their use as electron accepting organic semiconducting materials will be achievable.

Unexpectedly, the attachment of the aryl groups did not dramatically affect the photophysical or electrochemical behavior relative to the parent 12a. DFT (B3LYP/6-31G*) calculations were carried out for the LUMO and HOMO of 13a (but using B-2,6-dimethylphenyl rather than B-Mes*, FIGS. 12c and 12d). The HOMO level is localized on the polycyclic aromatic core with a node at the site of tolyl attachment, and the LUMO has very minimal delocalization onto the aryl substituents. More electronic influence could be exerted by substituents placed elsewhere onto the fused core as determined by the choice of benzaldehyde precursors 5 that ultimately sets the site for functionalization.

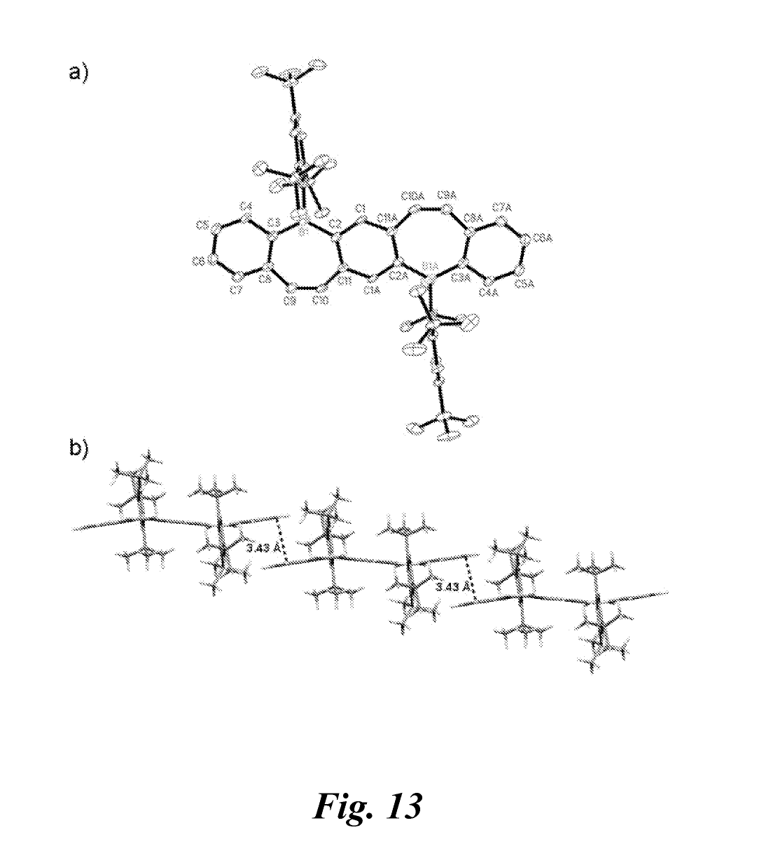

A single crystal (grown from a mixture of THF, CH₂Cl₂ and water) suitable for X-ray structure determination verified the molecular connectivity (FIG. 13a) and revealed important packing-induced distortions within the pentacyclic core (ca. 14° deviation from planarity, FIG. 13b). Analytical data are as follows: C₅₈H₇₂B₂, Mᵣ=790.78*, pale yellow plate, 0.41×0.26×0.08 mm³, triclinic, P _{1̅} (no. 2), a=9.8252(3), b=10.1043(2), c=13.8222(4) Å, α=99.775(2), β=100.226(2), γ=92.362(2), V=1327.21(6) Å³, Z=1, Dₓ=0.989 g cm⁻³,* Mo Kα radiation (λ=0.71073 Å), T=110(2) K, μ=0.055 mm⁻¹,* abs. corr. range: 0.984-0.997. 13951 reflections were measured up to a resolution of (sin θ/λ)ₘₐₓ=0.59 Å⁻¹. 4664 Reflections were unique (Rᵢₙₜ=0.0548), of which 2920 were observed [I>2σ(I)]. 290 Parameters were refined using 110 restraints. R1/wR2 [I>2σ(I)]: 0.0571/0.1480. R1/wR2 [all refl.]: 0.0944/0.1579. S=0.959. Residual electron density found between −0.25 and 0.23 e Å⁻³. *excluding the solvent contribution.

As the DFT calculations indicate a planar pentacyclic aromatic core, these deviations can be attributed to crystal packing influences, as well as deformations imposed by the Mes* group that also are apparent spectroscopically for the DBB 1c. The structural metrics of the borepin core were consistent with other borepin fragments reported previously, and the nucleus-independent chemical shift [NICS(1)], Schleyer, P. v. R., et al., J. Am. Chem. Soc. 1996, 118, 6317-6318, calculated for the borepin ring of 12a (−1.65) indicated very weak local aromaticity or perhaps even nonaromatic. Although small in absolute value, it is comparable to that calculated for the weakly aromatic B-phenylborepin (−5.75), thus indicating that the inherent borepin aromaticity is not dramatically perturbed by extended ring fusion. Finally, the Mes* groups frustrated tight packing leaving substantial void spaces within the crystal lattice. These voids are occupied by a mixture of disordered solvent molecules (CH₂Cl₂ and THF), and their contributions have been subsequently removed for the last stage of refinement using the program SQUEEZE. See Spek, A. L., J. Appl. Cryst. 2003, 36, 7-13. Face-to-face pi-stacking was evident at the periphery of the pentacyclic fragment with a distance of 3.43 Å.

More particularly, the synthesis of para and meta chlorinated fused borepins is provided in Scheme 5.

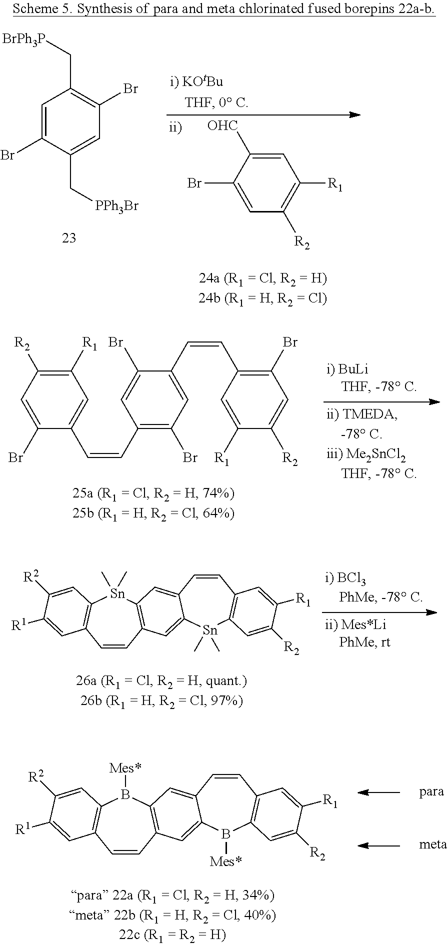

Chlorinated fused borepins 22a-b were synthesized according to the procedure reported previously and illustrated in Scheme 5. Caruso, A., et al., Angew. Chem. Int. Ed. 2010, 49, 4213-4217. The bis(phoshponium salt) 23, Bonifacio, M. C., et al., J. Org. Chem. 2005, 70, 8522-8526, was used as a common core from which double Wittig olefinations with bromochlorobenzaldehydes 24a-b resulted in both the para and meta chlorinated tetrabromides 25a-b. Chemoselective lithium-halogen exchange at the bromides followed by in situ treatment of the tetralithio species with two equivalents of dimethyltin dichloride yielded fused stannepin 26a-b. Simultaneous tin-boron exchanges between boron trichloride and the dimethyltin centers of 26a followed by treatment with Mes*Li resulted in the formation of para chloro fused borepin 22a; however, when this procedure was utilized for the formation of meta chloro fused borepin 22b it resulted in yields of only 3-8%. As a result, 22b was treated with boron trichloride followed by the addition of Mes*Li at room temperature and heated to 100° C. for 18 h which increased the yield of 22b to 40%. Utilization of the Mes* protecting group rendered all borepins air and moisture stable.

Initial attempts to perform palladium catalyzed cross-couplings on the para chloride functionalized fused borepin 22a were not successful; however, the more active palladium catalyzed cross-coupling conditions resulted in the desired transformation (see Scheme 5). Stille coupling between 22a and 2-tributylstannyl thiophene using Fu's Pd(PtBu₃)₂ catalyst, see Littke, A. F., et al., J. Am. Chem. Soc. 2002, 124, 6343-6348, resulted in para thienyl fused borepin 27a in 34% yield. The transformation was quantitative by crude ¹H-NMR; however, purification of these compounds often resulted in lower isolated yields due to poor solubility. Furthermore, by using the Pd(MeCN)₂Cl₂/XPhos catalyst system developed by Buchwald and co-workers, Gelman, D.; Buchwald, S. L. Angew. Chem. Int. Ed. 2003, 42, 5993-5996, Sonogashira couplings resulted in a series of para substituted phenylethynyl fused borepins 27b-e. The series included electron withdrawing 4-fluorophenyl acetylene, neutral phenylacetylene and electron donating anisole and N,N-dimethylaminophenyl acetylene fused borepins. Unexpectedly, the meta chlorinated fused borepin 22b would not react under any active palladium cross-coupling conditions resulting in the isolation of starting material in each case. As a result, 22b was subjected to Kumada coupling conditions using Ni(dppp)Cl₂, which is known to be more reactive towards chlorides; however, surprisingly no reaction occurred. A lack of reactivity of the meta chloride fused borepin 22b was unforeseen since the functionalization of meta bromide DBBs by common cross-coupling procedures was reported previously. For this reason, without wishing to be bound to any one particular theory, electronic factors are thought to be the barrier preventing successful cross-couplings and not steric encumbrance.

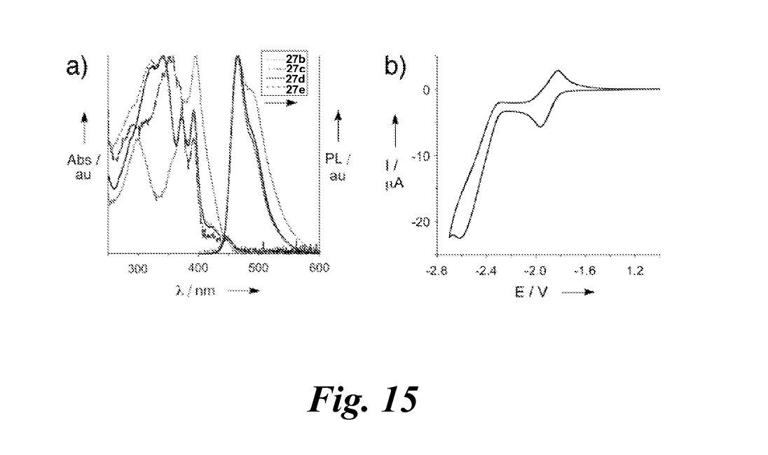

All borepins were subjected to photophysical and electrochemical characterization including UV-vis, photoluminescence, fluorescence decay and cyclic voltammetry (data compiled numerically in Table 5). FIG. 15 shows the photophysical and electrochemical characterization data for the para substituted phenyl ethynyl fused borepin series 27b-e. Borepins 27a and 27c-e showed low energy, low oscillator strength bands at 445 nm attributed to charge-transfer between the appended electron-rich handle and the electron-deficient boron center and more intense higher energy p-p* transitions. The much stronger donating dimethylamino phenylacetylene substituent appended to the fused borepin (27b) had a much more intense but ill-defined low energy absorption. The emission spectra of the fused borepins 27a-e were bimodal with a more intense higher energy λₘₐₓ and a less intense low energy shoulder. Additionally, time-resolved spectroscopy on the fused borepins revealed single exponential decays with lifetimes between 6.8 and 9.3 ns. Little change was observed among the photophysical data, specifically the onset of absorption and PL λₘₐₓ.

TABLE 5
Summary of Photophysical and Electrochemical Data.

| | abs | PL | | | |
|---|---|---|---|---|---|
| Compound | λₒₙₛₑₜ [nm] | λ [nm] | Φ | τ [ns]^{a} | E_{1/2} [V]^{b} |
| 22c† | 458 | 456 | 0.71 | 9.3 | −1.89 |
| | | | | | −2.46 |
| 27a | 459 | 460 | 0.36 | 7.3 | −1.99 |
| | | | | | −2.52 |
| 27b | 462 | 465 | 0.69 | 6.8 | −1.93 |
| | | | | | −2.49 |
| 27c | 463 | 463 | 0.52 | 9.2 | −1.85 |
| | | | | | −2.62 |
| 27d | 466 | 465 | 0.45 | 8.9 | −1.89 |
| | | | | | −2.38 |
| 27e | 471 | 464 | 0.28 | 9.1 | −1.84 |
| | | | | | −2.34 |
| 28 | 459 | 466 | 0.45 | 8.6 | −1.86 |
| | | | | | −2.37 |

^{a}All lifetimes are single exponential.
^{b}E_{1/2}s are reported relative to the Ag/Ag+ couple with which the Fc/Fc+ couple was found to be 205 mV.
†Caruso, A., et al., Angew. Chem. Int. Ed. 2010, 49, 4213-4217.

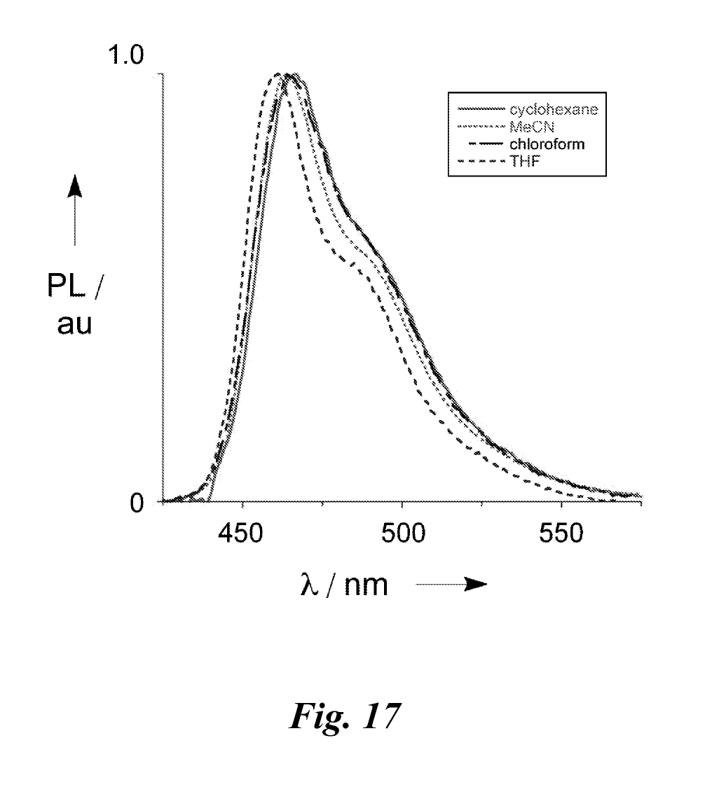

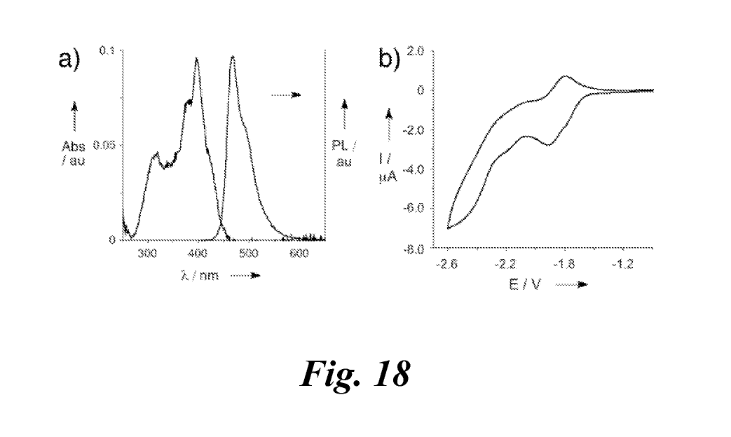

The photoluminescence spectra of the donating fused borepins 27b-c were also acquired in tetrahydrofuran, acetonitrile and cyclohexane (in addition to chloroform) to determine if there were any solvatochromic effects due to the push-pull character of the molecule. The methoxy phenylacetylene fused borepin 27c showed no more than a 6-nm shift in going from nonpolar to polar solvents (see FIG. 17); however, the dimethylamino phenylacetylene fused borepin 27b showed a shift of nearly 100 nm (see FIG. 18). DFT calculationsat the B3LYP/6-31G* level of theory supported this trend by revealing a large shift in electron density between the HOMO and LUMO surface.

FIG. 15(b) shows a representative cyclic voltammagram for the reversible reduction of 27b (E_{1/2}=−1.91 and −2.52 V), which revealed two, one electron reduction waves. The first reduction half-wave potential (E_{1/2}) was −1.91 V while the second E_{1/2} was almost 600 mV more difficult to reduce at −2.46 V. All of the functionalized fused borepins had exhibited similar cathodic electrochemistry with two reversible one-electron reductions; furthermore, as expected the more electron rich fused borepins 27a-c were more difficult to reduce than the neutral and electron-deficient fused borepins 27d-e. In addition to the highly reversible nature of these cathodic processes, the ability to tune the LUMO level by changing the functional handle para to the boron center could enable the use of fused borepins electron-deficient materials.

The ability to perform Sonogashira couplings on 22a allowed for the synthesis of para TIPS-ethynyl substituted fused borepins that could be deprotected by treatment with tetrabutylammonium fluoride in THF and methanol to provide the intermediate terminal alkyne in 34% yield over two steps as shown in Scheme 6. The para ethynyl fused borepin was then polymerized by Sonogashira coupling with bis(decyloxy)-2,5-diiodobenzene to form polymer 28 in 70% yield. Additionally, polymer 28 was readily dissolved in common organic solvents such as dichloromethane, chloroform and toluene, which would allow for solution processability.

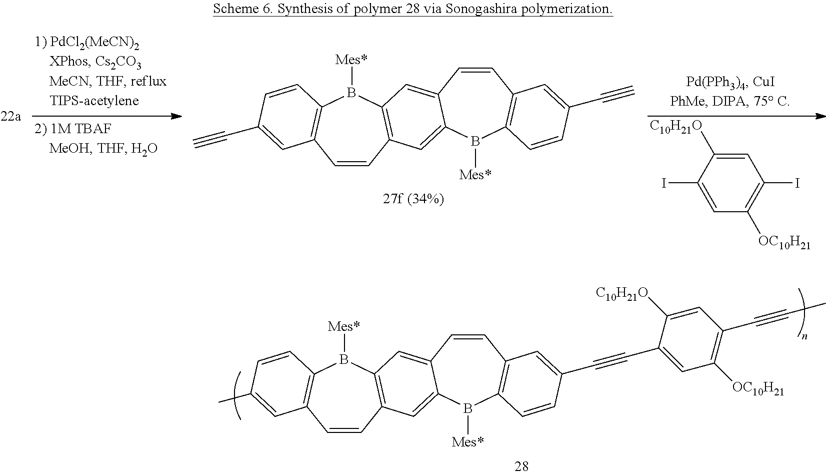

Polymer 28 had an onset of absorption at 459 nm and a more intense higher energy band at 396 nm. The typical lower energy, low oscillator strength bands associated with a charge-transfer interaction were more intense, but overlapping with the p-p* transition. Photoluminescence spectra for polymer 28 showed a peak at 466 nm that had a low-energy shoulder at 490 nm and a quantum yield of 45%. The CV spectrum of polymer 28 showed two reversible reductions (E_{1/2}=−1.86, −2.37 V) that were more broad than those seen for the monomers. The photophysical and electrochemical data suggested that the polymer behaved like functionalized monomers rather than an extended system with any sort of long range communication between the fused borepins.

In summary, the presently disclosed subject matter provides the synthesis of para and meta chlorinated fused borepins and the subsequent functionalization of the para system by Stille and Sonogashira cross-coupling reactions. With an expanded cross-coupling repertoire, a series of electron donating, withdrawing and neutral phenyl acetylenes were synthesized. Optical and electrochemical characterization revealed that the band gap remains quantitatively the same, as seen by the similar λₒₙₛₑₜs of absorption for 27b-e, while the LUMO was tuned by changing the electronic character of the substituted phenyl acetylene. The ability to design and synthesize electron deficient acceptor materials in which the HOMO and LUMO levels can be tuned to optimze interaction with electron rich donor materials is of great interest for device fabrication. The presently disclosed borepin-containing polycyclic aromatics can be used as new electronic materials.

### F. Stannepin Analogues

In some embodiments, the presently disclosed subject matter includes stannepin analogues of the presently disclosed borepins. Accordingly, in some embodiment, the presently disclosed subject matter provides a compound selected from the group consisting of:

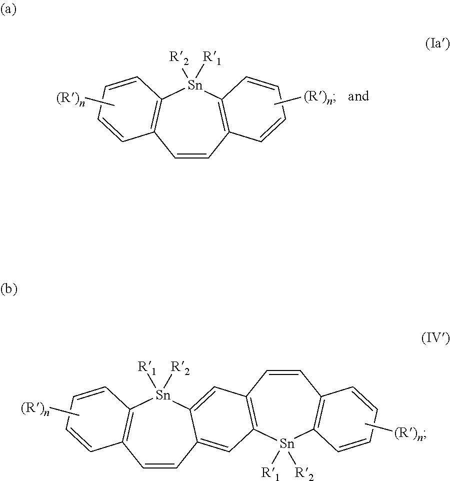

wherein:
n is an integer from 0 to 4;
R′₁, and R′₂ are each independently alkyl or substituted alkyl;
R′ at each occurrence is independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings.

In some embodiments, the compound of Formula (Ia′) is selected from the group consisting of:

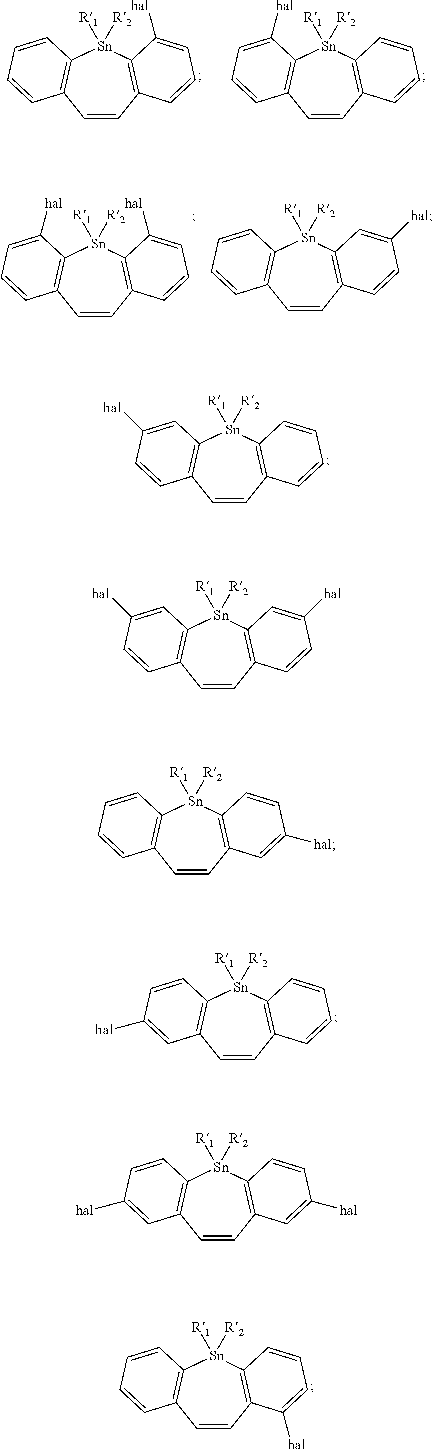

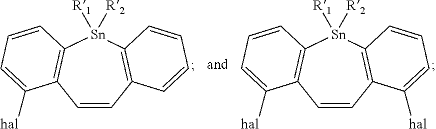

wherein R′₁, and R′₂ each “hal” substituent group is independently a halogen selected from the group consisting of F, Cl, Br, and I.

In some embodiments, the compound of formula (Ia′) is selected from the group consisting of:

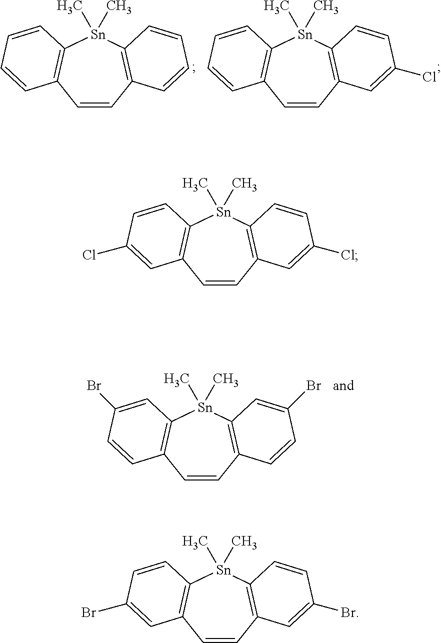

In some embodiments, the compound of formula (IV′) is selected from the group consisting of:

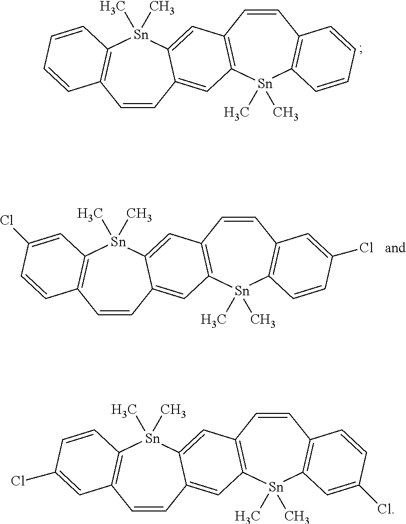 [SMILES: [CH3][Sn]1([CH3])[c]2ccccc2C=Cc2c[c]3c(c[c]21)C=Cc1cccc[c]1[Sn]3([CH3])[CH3] ; [CH3][Sn]1([CH3])[c]2ccc(Cl)cc2C=Cc2c[c]3c(c[c]21)C=Cc1ccc(Cl)c[c]1[Sn]3([CH3])[CH3] ; [CH3][Sn]1([CH3])[c]2ccc(Cl)cc2C=Cc2c[c]3c(c[c]21)C=Cc1ccc(Cl)c[c]1[Sn]3([CH3])[CH3]]

### F. Use of the Presently Disclosed Materials

Representative products comprising the presently disclosed materials include, but are not limited to, materials for transistor devices (electron transporting), liquid crystal materials, anion sensors, and any functional applications thereof, including photovoltaics or organic light emitting diodes.

### G. Definitions

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth. Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments f 0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

While the following terms in relation to compounds of Formulae I-IV are believed to be well understood by one of ordinary skill in the art, the following definitions are set forth to facilitate explanation of the presently disclosed subject matter. These definitions are intended to supplement and illustrate, not preclude, the definitions that would be apparent to one of ordinary skill in the art upon review of the present disclosure.

When the term “independently selected” is used, the substituents being referred to (e.g., R groups, such as groups R₁, R₂, and the like, or variables, such as “m” and “n”), can be identical or different. For example, both R₁ and R₂ can be substituted alkyls, or R₁ can be hydrogen and R₂ can be a substituted alkyl, and the like.

A named “R” or group will generally have the structure that is recognized in the art as corresponding to a group having that name, unless specified otherwise herein. For the purposes of illustration, certain representative “R” groups as set forth above are defined below.

As used herein the term “alkyl” refers to C₁₋₂₀ inclusive, linear (i.e., “straight-chain”), branched, or cyclic, saturated or at least partially and in some cases fully unsaturated (i.e., alkenyl and alkynyl)hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein, oxo, and/or alkylene. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include cyclopentyl, cyclohexyl, and cycloheptyl. Multicyclic cycloalkyl rings include adamantyl, octahydronaphthyl, decalin, camphor, camphane, and noradamantyl.

The term “cycloalkylalkyl,” as used herein, refers to a cycloalkyl group as defined hereinabove, which is attached to the parent molecular moiety through an alkyl group, also as defined above. Examples of cycloalkylalkyl groups include cyclopropylmethyl and cyclopentylethyl.

The terms “cycloheteroalkyl” or “heterocycloalkyl” refer to a non-aromatic ring system, such as a 3- to 7-member substituted or unsubstituted cycloalkyl ring system, including one or more heteroatoms, which can be the same or different, and are selected from the group consisting of N, O, and S, and optionally can include one or more double bonds. The cycloheteroalkyl ring can be optionally fused to or otherwise attached to other cycloheteroalkyl rings and/or non-aromatic hydrocarbon rings. Representative cycloheteroalkyl ring systems include, but are not limited to pyrrolidinyl, pyrrolinyl, imidazolidinyl, imidazolinyl, pyrazolidinyl, pyrazolinyl, piperidyl, piperazinyl, indolinyl, quinuclidinyl, morpholinyl, thiomorpholinyl, thiadiazinanyl, tetrahydrofuranyl, and the like.

The term “alkenyl” as used herein refers to a straight or branched hydrocarbon of a designed number of carbon atoms containing at least one carbon-carbon double bond. Examples of “alkenyl” include vinyl, allyl, 2-methyl-3-heptene, and the like.

The term “cycloalkenyl” as used herein refers to a cyclic hydrocarbon containing at least one carbon-carbon double bond. Examples of cycloalkenyl groups include cyclopropenyl, cyclobutenyl, cyclopentenyl, cyclopentadiene, cyclohexenyl, 1,3-cyclohexadiene, cycloheptenyl, cycloheptatrienyl, and cyclooctenyl.

The term “alkynyl” as used herein refers to a straight or branched hydrocarbon of a designed number of carbon atoms containing at least one carbon-carbon triple bond. Examples of “alkynyl” include propargyl, propyne, and 3-hexyne. The term “alkynylaryl” refers to an aryl group as defined hereinbelow further substituted with an alkynyl group, i.e., Ar—C≡C—, where Ar is defined as an aryl group.

“Alkylene” refers to a straight or branched bivalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂-); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The common linking group also can be a carbonyl, as in benzophenone, or oxygen, as in diphenylether, or nitrogen, as in diphenylamine. The term “aryl” specifically encompasses heterocyclic aromatic compounds. The aromatic ring(s) can comprise phenyl, naphthyl, biphenyl, diphenylether, diphenylamine and benzophenone, among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon and heterocyclic aromatic rings.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Specific examples of aryl groups include, but are not limited to, cyclopentadienyl, phenyl, furan, thiophene, pyrrole, pyran, pyridine, imidazole, benzimidazole, isothiazole, isoxazole, pyrazole, pyrazine, triazine, pyrimidine, quinoline, isoquinoline, indole, carbazole, and the like.

The term “heteroaryl” refers to an aromatic ring system, such as, but not limited to a 5- or 6-member ring system, including one or more heteroatoms, which can be the same or different, and are selected from the group consisting of N, O, and S. The heteroaryl ring can be fused or otherwise attached to one or more heteroaryl rings, aromatic or non-aromatic hydrocarbon rings, or heterocycloalkyl rings. Representative heteroaryl ring systems include, but are not limited to, pyridyl, pyrimidyl, pyrrolyl, pyrazolyl, azolyl, oxazolyl, isoxazolyl, oxadiazolyl, thiazolyl, isothiazolyl, imidazolyl, furanyl, thienyl, quinolinyl, isoquinolinyl, indolinyl, indolyl, benzothienyl, benzothiazolyl, enzofuranyl, benzimidazolyl, benzisoxazolyl, benzopyrazolyl, triazolyl, tetrazolyl, and the like.

A structure represented generally by the formula:

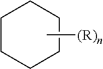

as used herein refers to a ring structure, for example, but not limited to a 3-carbon, a 4-carbon, a 5-carbon, a 6-carbon, a 7-carbon, and the like, aliphatic and/or aromatic cyclic compound, including a saturated ring structure, a partially saturated ring structure, and an unsaturated ring structure, comprising a substituent R group, wherein the R group can be present or absent, and when present, one or more R groups can each be substituted on one or more available carbon atoms of the ring structure. The presence or absence of the R group and number of R groups is determined by the value of the variable “n,” which is an integer generally having a value ranging from 0 to the number of carbon atoms on the ring available for substitution. Each R group, if more than one, is substituted on an available carbon of the ring structure rather than on another R group. For example, the structure above where n is 0 to 2 would comprise compound groups including, but not limited to:

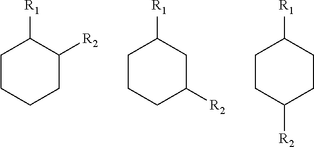

and the like.

A dashed line representing a bond in a cyclic ring structure indicates that the bond can be either present or absent in the ring. That is, a dashed line representing a bond in a cyclic ring structure indicates that the ring structure is selected from the group consisting of a saturated ring structure, a partially saturated ring structure, and an unsaturated ring structure.

When a named atom of an aromatic ring or a heterocyclic aromatic ring is defined as being “absent,” the named atom is replaced by a direct bond.

As used herein, the term “acyl” refers to an organic acid group wherein the —OH of the carboxyl group has been replaced with another substituent (i.e., as represented by RCO—, wherein R is an alkyl or an aryl group as defined herein). As such, the term “acyl” specifically includes arylacyl groups, such as an acetylfuran and a phenacyl group. Specific examples of acyl groups include acetyl and benzoyl.

“Alkoxyl” refers to an alkyl-O— group wherein alkyl is as previously described. The term “alkoxyl” as used herein can refer to C₁₋₂₀ inclusive, linear, branched, or cyclic, saturated or unsaturated oxo-hydrocarbon chains, including, for example, methoxyl, ethoxyl, propoxyl, isopropoxyl, butoxyl, t-butoxyl, and pentoxyl.

The term “alkoxyalkyl” as used herein refers to an alkyl-O-alkyl ether, for example, a methoxyethyl or an ethoxymethyl group.

“Aryloxyl” refers to an aryl-O— group wherein the aryl group is as previously described, including a substituted aryl. The term “aryloxyl” as used herein can refer to phenyloxyl or hexyloxyl, and alkyl, substituted alkyl, halo, or alkoxyl substituted phenyloxyl or hexyloxyl.

The term “alkyl-thio-alkyl” as used herein refers to an alkyl-5-alkyl thioether, for example, a methylthiomethyl or a methylthioethyl group.

“Aralkyl” refers to an aryl-alkyl-group wherein aryl and alkyl are as previously described, and included substituted aryl and substituted alkyl. Exemplary aralkyl groups include benzyl, phenylethyl, and naphthylmethyl.

“Aralkyloxyl” refers to an aralkyl-O— group wherein the aralkyl group is as previously described. An exemplary aralkyloxyl group is benzyloxyl.

“Alkoxycarbonyl” refers to an alkyl-O—CO— group. Exemplary alkoxycarbonyl groups include methoxycarbonyl, ethoxycarbonyl, butyloxycarbonyl, and t-butyloxycarbonyl.

“Aryloxycarbonyl” refers to an aryl-O—CO— group. Exemplary aryloxycarbonyl groups include phenoxy- and naphthoxy-carbonyl.

“Aralkoxycarbonyl” refers to an aralkyl-O—CO— group. An exemplary aralkoxycarbonyl group is benzyloxycarbonyl.

“Carbamoyl” refers to an H₂N—CO— group. “Alkylcarbamoyl” refers to a R′RN—CO— group wherein one of R and R′ is hydrogen and the other of R and R′ is alkyl and/or substituted alkyl as previously described. “Dialkylcarbamoyl” refers to a R′RN—CO— group wherein each of R and R′ is independently alkyl and/or substituted alkyl as previously described.

“Acyloxyl” refers to an acyl-O— group wherein acyl is as previously described.

The term “amino” refers to the —NH₂ group and also refers to a nitrogen containing group as is known in the art derived from ammonia by the replacement of one or more hydrogen radicals by organic radicals. For example, the terms “acylamino” and “alkylamino” refer to specific N-substituted organic radicals with acyl and alkyl substituent groups respectively.

The term “alkylamino” refers to an —NHR group wherein R is an alkyl group and/or a substituted alkyl group as previously described. Exemplary alkylamino groups include methylamino, ethylamino, and the like.

“Dialkylamino” refers to an —NRR′ group wherein each of R and R′ is independently an alkyl group and/or a substituted alkyl group as previously described. Exemplary dialkylamino groups include ethylmethylamino, dimethylamino, and diethylamino.

“Acylamino” refers to an acyl-NH— group wherein acyl is as previously described. “Aroylamino” refers to an aroyl-NH— group wherein aroyl is as previously described.

The term “carbonyl” refers to the —(C═O)— group.

The term “carboxyl” refers to the —COOH group.

The terms “halo,” “halide,” or “halogen” as used herein refer to fluoro, chloro, bromo, and iodo groups.

The term “hydroxyl” refers to the —OH group.

The term “hydroxyalkyl” refers to an alkyl group substituted with an —OH group.

The term “mercapto” refers to the —SH group.

The term “oxo” refers to a compound described previously herein wherein a carbon atom is replaced by an oxygen atom.

The term “nitro” refers to the —NO₂ group.

The term “thio” refers to a compound described previously herein wherein a carbon or oxygen atom is replaced by a sulfur atom.

The term “sulfate” refers to the —SO₄ group.

Throughout the specification and claims, a given chemical formula or name shall encompass all tautomers, congeners, and optical- and stereoisomers, as well as racemic mixtures where such isomers and mixtures exist.

As used herein the term “monomer” refers to a molecule that can undergo polymerization, thereby contributing constitutional units to the essential structure of a macromolecule or polymer.

As used herein, an “oligomer” includes a few monomer units, for example, in contrast to a polymer that potentially can comprise an unlimited number of monomers. Dimers, trimers, and tetramers are non-limiting examples of oligomers.

A “polymer” is a molecule of high relative molecule mass, the structure of which essentially comprises the multiple repetition of unit derived from molecules of low relative molecular mass, i.e., a monomer.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The following Examples are offered by way of illustration and not by way of limitation.

### Example 1

### Synthesis of Functionalizable Boron-Containing Pi-Electron Materials Incorporating One and Two Formally Aromatic Fused Borepin Rings

### General Considerations

All reactions and manipulations were carried out under an atmosphere of prepurified nitrogen or argon using a glovebox or Schlenk techniques. Non-aqueous solvents were degassed by sparging with nitrogen for 15 minutes prior to use and toluene, diethyl ether and THF were distilled over sodium/benzophenone ketyl. Nickel (II) chloride, NiCl₂, and 1,3-bis(diphenylphosphino)propane nickel(II) chloride, Ni(dppp)Cl₂, were obtained from Strem Chemicals. All other chemicals were obtained from Sigma-Aldrich or Fisher and used without further purification; silica gel was obtained from Dynamic Adsorbents, Inc. ¹H NMR, ¹³C NMR and ¹¹B NMR spectra (BF₃-Et₂O used as external reference and set to 0 ppm) were obtained in deuterated chloroform (the signal for residual protio solvent was set at 7.26 ppm for ¹H NMR and 77.16 ppm for ¹³C NMR) or deuterated methylene chloride (the signal for residual protio solvent was set at 5.32 ppm for ¹H NMR and 54 ppm for ¹³C NMR) using a Bruker Avance 400 MHz FTNMR spectrometer. Mass spectra were obtained using VG Instruments VG70S magnetic sector mass spectrometer, with EI and FAB ionization. UV-vis spectra were obtained using a Varian Cary50 Bio UV-Visible spectrophotometer and fluorescence spectra were obtained using a PTI QuantaMaster fluorometer; data was collected at room temperature. X-ray crystallographic analysis was done on an Oxford Diffraction KM4/Xcalibur diffractometer with a Sapphire3 detector. Calculations of equilibrium geometry and HOMO/LUMO surfaces at ground state with Density Functional Theory at the B3LYP/6-31G* level were performed with Spartan '04. Nucleus independent chemical shift (NICS) calculations were performed with Gaussian '03 by using the GIAO method with Density Functional Theory at the B3LYP level of theory. Melting point data was collected on a MeI-Temp II Laboratory Devices apparatus.

The following compounds were synthesized according to literature: (2-bromobenzyl) triphenylphosphonium bromide (4a), Wyatt, P., et al., Org. & Biomolecular Chem. 4: 2218-2232 (2006); (2-bromo-5-chlorobenzyl)-triphenylphosphonium bromide (4b), Plater, M. J. Tet. Lett. 35(33):6147-6150 (1994); 2-bromo-5-chlorobenzaldehyde (5b), Wyatt, P., et al., supra; (Z)-1,2-bis(2-bromophenyl)ethane (2a), Harrowven, D. C., et al., Synlett. 18:2977-2980 (2006); and ((2,5-dibromo-1,4-phenylene)bis(methylene))bis(bromotriphenylphosphorane) (9), Bonifacio, M., et al., J. Org. Chem. 70(21):8522-8526 (2005).

### Electrochemical Methods

Generally, cyclic voltammetry was performed in a one-chamber, three-electrode cell using PARSTAT 2273 and Autolab PGSTAT 302 potentiostats. A 2 mm² Pt button electrode was used as the working electrode with a platinum wire counter electrode relative to a quasi-internal Ag wire reference electrode submersed in 0.01 M AgNO₃/0.1 M n-Bu₄NPF₆ in anhydrous acetonitrile (obtained from BioAnalytical Systems, West Lafayette, Ind., USA). Measurements were taken on mM analyte concentrations in 0.1 M n-Bu₄PF₆ (in THF) electrolyte solutions recorded at a scan rate of 100 mV/s. Potentials are reported relative to the Ag/Ag⁺ couple with which the Fc/Fc⁺ couple was found to be 205 mV.

More particularly, electrochemical data was obtained using a PARSTAT 2273 potentiostat or an Autolab PGSTAT302 potentiostat/galvanostat relative to a quasi-internal Ag wire reference electrode submersed in 0.01 M AgNO₃/0.1 M n-Bu₄NPF₆ in anhydrous acetonitrile. Cyclic voltammograms were recorded using a 2 mm² platinum button electrode as the working electrode and platinum wire as the counter electrode and was performed in 0.1 M n-Bu₄PF₆ (in THF) under an inert atmosphere of nitrogen measured at a scan rate of 100 mV/s. All electrochemical potentials are reported and discussed relative to this reference electrode. Tetrabutylammonium hexafluorophosphate was obtained from Aldrich and recrystallized from ethanol prior to use. All electrolyte concentrations were 0.1 M in THF and the monomer concentrations were 2.5 mM in THF unless otherwise noted.

### Photophysical Methods

Spectroscopic measurements were conducted in CHCl₃ solution at room temperature. UV-vis absorption spectra were recorded on a Varian Cary 50 Bio UV-Visible spectrophotometer. Photoluminescence spectra were recorded on a Photon Technologies QuantaMaster 4 fluorometer with a 75 W Xenon lamp, maintaining optical densities below 0.05 au. Quantum yields were determined relative to quinine sulfate in 0.1 NH₂SO₄ (55%).

### Computational Methods

Molecular orbital calculations were performed at the DFT level (B3LYP/6-31G*) on equilibrium geometries using Spartan '04 (Wavefunction Inc., Irvine, Calif.). NICS calculations were performed using Gaussian 03 using the GIAO method (B3LYP/6-31G*). See M. J. Frisch, et al., Gaussian 03, Revision C.01; Gaussian, Inc.; Wallingford, Conn.; 2004.

Synthetic Methods

As provided hereinabove, all synthetic manipulations were conducted using standard Schlenk air-free techniques.

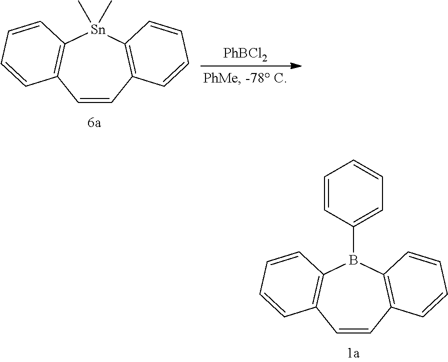 [SMILES: "PhBCl2" ; [CH3][Sn]1([CH3])[c]2ccccc2C=Cc2cccc[c]21 ; C1=Cc2ccccc2B(c2ccccc2)c2ccccc21]

### 5-phenzyldibenzo[b,f]borepin (1a)

A solution of stannepin 6a (107 mg, 0.321 mmol) in toluene (1.6 mL) was cooled to −78° C. in a dried 25 mL Schlenk tube under static nitrogen. Dichlorophenylborane (53.7 mg, 0.328 mmol) was added dropwise with stirring, after which the reaction mixture was allowed to slowly warm to room temperature and left stirring for 18 h. The volatiles were removed under reduced pressure on the Schlenk line yielding 1a as an off white solid. 1a not isolated in pure form due to its air and moisture sensitivity. ¹H-NMR (400 MHz, CDCl₃) δ: 8.17 (d, 2H, J=7.7 Hz), 7.85 (dd, 2H, J=7.7 Hz), 7.77 (td, 2H, J=7.7, 1.4 Hz), 7.64 (dd, 2H, J=7.7, 1.9 Hz), 7.55 (m, 5H), 7.4 (s, 2H); ¹¹B-NMR (128 MHz, CDCl₃) δ: 62.4 ppm.

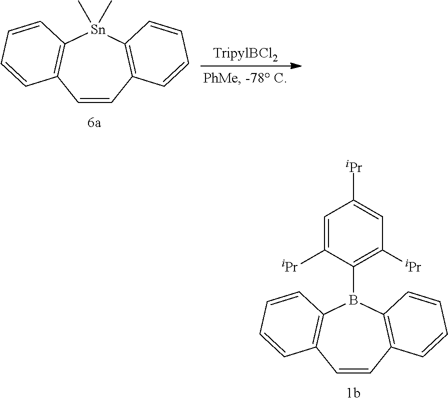 [SMILES: [CH3][Sn]1([CH3])[c]2ccccc2C=Cc2cccc[c]21 ; "TripylBCl2" ; CC(C)c1cc(C(C)C)c(B2c3ccccc3C=Cc3ccccc32)c(C(C)C)c1]

### 5-(2,4,6-tri-iso-propylphenyl)dibenzo[b,f]borepin (1b)

A solution of stannepin 6a (290 mg, 0.66 mmol) in toluene (2.5 mL) was cooled to −78° C. in a dried 25 mL Schlenk tube under static nitrogen. Dichlorotripylborane (0.75 mL, 0.66 mmol) was added dropwise with stirring, after which the reaction mixture was allowed to slowly warm to room temperature and left stirring for 18 h. The volatiles were removed under reduced pressure on the Schlenk line yielding 1b as a brown oil. 1b not isolated in pure form due to its air and moisture sensitivity. ¹H-NMR (400 MHz, CDCl₃) δ: 8.89 (d, 2H, J=7.8 Hz), 7.59 (m, 4H), 7.49 (td, 2H, J=7.8, 1.5 Hz), 7.09 (s, 2H), 6.96 (s, 1H), 6.91 (s, 1H), 2.85 (m, 2H), 2.39 (m, 1H), 1.23 (d, 18H, 6.9 Hz); ¹¹B-NMR (128 MHz, CDCl₃) δ: 61.9 ppm.

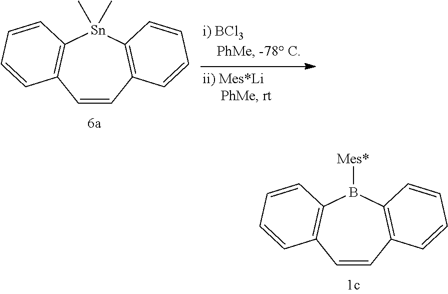

### 5-(2,4,6-tri-tert-butylphenyl)dibenzo[b,f]borepin (1c)

A solution of stannepin 6a (102 mg, 0.309 mmol) in toluene (3 mL) was cooled to −78° C. in a dried 25 mL Schlenk tube under nitrogen. A solution of BCl₃ in hexane (1.0 M, 0.31 mL, 0.31 mmol) was added dropwise with stirring after which the reaction mixture was allowed to slowly warm to room temperature over 1 h. A solution of Mes*Li, Wakamiya, A., et al., Chem. Comm. 579-581 (2008), (86.1 mg, 0.341 mmol) in toluene (2 mL) was added dropwise and the resulting mixture was left stirring at room temperature for 18 h. The reaction mix was partitioned between 1:1 water:diethyl ether and washed with brine (2×). The aqueous layer was removed and extracted with diethyl ether (2×) and the combined organics were dried with MgSO₄, filtered and the solvent removed under reduced pressure to a yellow oil that was further purified by column chromatography (SiO₂: 20% EtOAc in hexane) to yield 75 mg (0.17 mmol, 56%) of 1c as an off white solid. ¹H-NMR (400 MHz, CDCl₃) δ: 7.99 (d, 1H, J=7.8 Hz), 7.65 (d, 2H, J=7.8 Hz), 7.58 (t, 2H, J=7.5 Hz), 7.51 (s, 2H), 7.33 (t, 2H, J=7.5 Hz), 7.19 (s, 2H), 1.31 (s, 27H); HRMS (EI/CI) m/z calculated for C₃₂H₃₉B [M⁺]; 434.3145. found 434.3145.

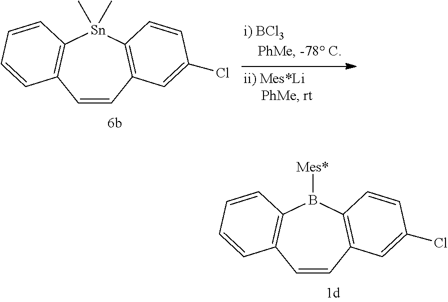

### 2-chloro-5-(2,4,6-tri-tert-butylphenyl)dibenzo[b,f]borepin (1d)

A solution of stannepin 6b (201 mg, 0.553 mmol) in toluene (5.5 mL) was cooled to −78° C. in a dried 25 mL Schlenk tube under nitrogen. A solution of BCl₃ in hexane (1.0 M, 0.55 mL, 0.55 mmol) was added dropwise with stirring after which the reaction mixture was allowed to slowly warm to room temperature over 1 h. A solution of Mes*Li, see Wakamiya, A., Chem. Comm. 579-581 (2008), (146 mg, 0.581 mmol) in toluene (3 mL) was added dropwise and the resulting mixture was left stirring at room temperature for 18 h. The reaction mix was partitioned between 1:1 water:EtOAc and washed with brine (2×). The aqueous layer was removed and extracted with EtOAc (2×) and the combined organics were dried with MgSO₄, filtered and the solvent removed under reduced pressure to provide a yellow oil that was further purified by column chromatography (SiO₂: hexane) to yield 120 mg (0.54 mmol, 46%) of 1d as an off white solid. ¹H-NMR (400 MHz, CDCl₃) δ: 7.99 (d, 1H, J=8.9 Hz), 7.94 (d, 1H, J=8.4 Hz), 7.66 (m, 2H), 7.59 (td, 1H, J=8.3, 1.5 Hz), 7.51 (s, 2H), 7.36 (td, 1H, J=8.3, 1.5 Hz), 7.29 (dd, 1H, J=8.4, 2.1 Hz), 7.24 (d, 1H, J=12.8 Hz), 7.09 (d, 1H, J=12.8 Hz) and 1.32 (s, 27H); ¹³C-NMR (100 MHz, CD₂Cl₂) δ: 150.8, 150.2, 148.6, 143.7, 143.4, 142.1, 141.5, 137.4, 135.5, 133.1, 132.4, 131.8, 131.7, 127.3, 126.9, 123.1, 119.5, 100.1, 35.0, 34.9, 31.4, 31.3; HRMS (EI/CI) m/z calculated for C₃₂H₃₈ClB [M⁺]; 468.2755. found 468.2763.

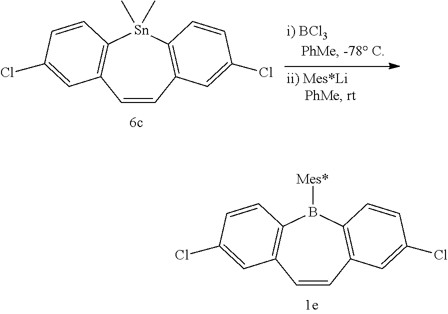

### 2,8-dichloro-5-(2,4,6-tri-tert-butylphenyl)dibenzo[b,f]borepin (1e)

A solution of stannepin 6c (299 mg, 0.743 mmol) in toluene (7.5 mL) was cooled to −78° C. in a dried 25 mL Schlenk tube under nitrogen. A solution of BCl₃ in hexane (1.0 M, 0.743 mL, 0.743 mmol) was added dropwise with stirring after which the reaction mixture was allowed to slowly warm to room temperature over 1 h. A solution of Mes*Li⁴ (206 mg, 0.817 mmol) in toluene (4 mL) was added dropwise and the resulting mixture was left stirring at room temperature for 18 h. The reaction mix was partitioned between 1:1 water:EtOAc and washed with brine (2×). The aqueous layer was removed and extracted with EtOAc (2×) and the combined organics were dried with MgSO₄, filtered and the solvent removed under reduced pressure to provide a yellow oil that was further purified by column chromatography (SiO₂: hexane) to yield 176 mg (0.349 mmol, 47%) of 1e as an off white solid. ¹H-NMR (400 MHz, CDCl₃) δ: 7.93 (d, 2H, J=8.4 Hz), 7.61 (d, 2H, J=2.1 Hz), 7.48 (s, 2H), 7.29 (dd, 2H, J=8.4, 2.1 Hz), 7.08 (s, 2H), 1.34 (s, 27H) ¹³C-NMR (100 MHz, CDCl₃) δ: 150.9, 150.1, 148.8, 143.9, 142.9, 137.8, 134.0, 132.2, 127.5, 123.2, 119.6, 35.4, 35.1, 31.8, 31.7; HRMS (EI) m/z calculated for C₃₂H₃₂Cl₂B [M⁺]; 502.2365. found 502.2367.

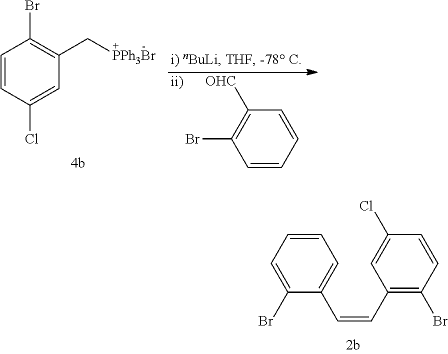

### (Z)-1-bromo-2-(2-bromostyryl)-4-chlorobenzene (2b)

A solution of phosphonium salt 4b (1.99 g, 3.66 mmol) in THF (36 mL) was cooled to 0° C. in a 100 mL Schlenk flask under nitrogen with stirring. Potassium ^{t}butoxide (494 mg, 4.33 mmol) was added portionwise and the resulting mixture was held at 0° C. for 30 min. A solution of benzaldehyde 5a (616 mg, 3.33 mmol) in THF (36 mL) was added dropwise at 0° C. and the reaction was allowed to warm up to room temperature and left stirring for 24 h. The reaction mix was partitioned between 1:1 water:diethyl ether. The aqueous layer was removed and extracted with diethyl ether (3×) and the combined organics were washed with brine (2×), dried with MgSO₄, filtered and the solvent removed under reduced pressure to yield 1.13 g (3.03 mmol, 91%) of 2b as a pale yellow oil that was used without further purification. ¹H-NMR (400 MHz, CDCl₃) δ: 7.59 (m, 1H), 7.49 (d, 1H, J=8.6 Hz), 7.05 (m, 3H), 6.96 (m, 2H), 6.83 (d, 1H, 11.9 Hz), 6.69 (d, 1H, 11.9 Hz); ¹³C-NMR (100 MHz, CDCl₃) δ: 138.8, 136.6, 133.9, 133.2, 133.1, 132.3, 130.9, 130.8, 129.9, 129.5, 129.1, 127.4, 124.3, 122.2.

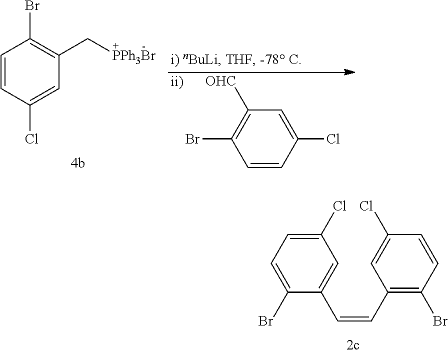

### (Z)-1,2-bis(2-bromo-5-chlorophenyl)ethane (2c)

A solution of phosphonium salt 4b (3.02 g, 5.54 mmol) in THF (55 mL) was cooled to 0° C. in a 250 mL Schlenk flask under nitrogen with stirring. Potassium ^{t}butoxide (746 mg, 6.52 mmol) was added portionwise and the resulting mixture was held at 0° C. for 30 min. A solution of benzaldehyde 5b (1.1 g, 5.1 mmol) in THF (55 mL) was added dropwise at 0° C. and the reaction was allowed to warm up to room temperature and left stirring for 24 h. The reaction mix was partitioned between 1:1 water:diethyl ether. The aqueous layer was removed and extracted with diethyl ether (3×) and the organics were dried with MgSO₄, filtered and the solvent removed under reduced pressure to provide an off white solid that was further purified by a short plug (SiO₂: 5% diethyl ether in hexane) to yield 1.83 g (4.49 mmol, 90%) of 2c as an off white solid. ¹H-NMR (400 MHz, CDCl₃) δ: 7.50 (d, 2H, J=8.5 Hz), 7.07 (dd, 2H, J=10.1, 2.6 Hz), 6.92 (d, 2H, J=2.5 Hz), 6.73 (s, 2H); ¹³C-NMR (100 MHz, CDCl₃) δ: 138.1, 134.1, 133.3, 130.9, 130.5, 129.4, 122.1; HRMS (FAB) m/z calculated for C₁₆H₁₄Br₂Cl₂ [M⁺]; 403.8370. found 403.8377.

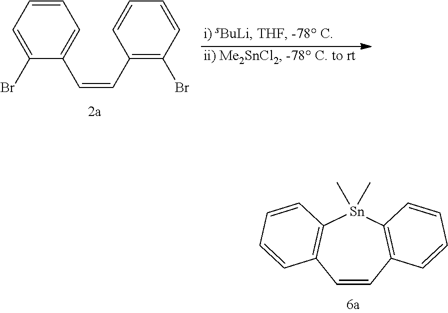

### (Z)-5,5-dimethyldibenzo[b,f]stannepin (6a)

A solution of stilbene 2a (0.99 g, 2.8 mmol) in THF (105 mL) was cooled to −78° C. in a dried 250 mL Schlenk flask under nitrogen with stirring. A solution of ^{s}BuLi in hexanes (4.5 mL, 6.3 mmol) was added dropwise and the resulting reaction mixture was held at −78° C. for 2 h. A solution of dimethyltin dichloride (570 mg, 2.5 mmol) in THF (12 mL) was added dropwise and the reaction mixture was allowed to warm to room temperature and left stirring for 18 h. The reaction mixture was partitioned between 1:1 water:diethyl ether. The aqueous layer was removed and extracted with diethyl ether (2×). The combined organics were washed with water (2×), dried with MgSO₄, filtered and the solvent removed under reduced pressure to provide a clear oil that was further purified by column chromatography (SiO₂: 5% diethyl ether in hexane) to yield 991 mg (3.03 mmol, 93%) of 6a as a clear oil. ¹H-NMR (400 MHz, CDCl₃) δ: 7.47 (dd, 2H, J=6.7, 1.8 Hz), 7.27 (m, 6H), 6.90 (s, 2H), 0.50 (s, 6H); ¹³C-NMR (100 MHz, CDCl₃) δ: 143.8, 142.0, 135.0, 134.5, 129.4, 128.7, 127.4, −11.3; HRMS (FAB) m/z calculated for C₁₆H₁₆Sn [M⁺]; 329.0352. found 329.0354.

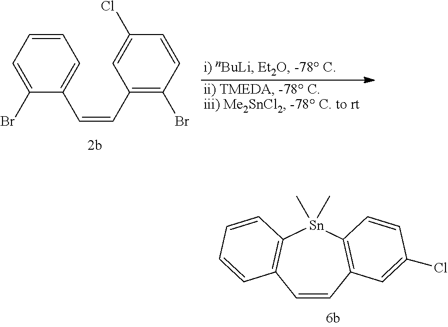

### (Z)-2-chloro-5,5-dimethyldibenzo[b,f]stannepin (6b)

A solution of 2b (1.01 g, 2.69 mmol) in diethyl ether (85 mL) was cooled to −78° C. in a 100 mL Schlenk flask under nitrogen with stirring. A solution of ⁿbutyl lithium in hexanes (1.6 M, 3.71 mL, 5.93 mmol) was added dropwise and the resulting mixture was held at −78° C. for 10 min after which TMEDA (599 mg, 5.93 mmol) was added. The reaction mixture was held at temperature for 2 h after which a solution of dimethyltin dichloride (624 mg, 2.69 mmol) in diethyl ether (3 mL) was added dropwise and the resulting mixture was allowed to warm to room temperature and left stirring for 18 h. The reaction mixture was partitioned between 1:1 water:diethyl ether. The aqueous layer was removed and extracted with diethyl ether (3×) and the organics were washed with 0.2 M HCl(1×) and water (1×). The combined organics were dried with MgSO₄, filtered and the solvent removed under reduced pressure to yield 963 mg (2.66 mmol, 99%) of 6b as a yellow oil that was used without further purification. ¹H-NMR (400 MHz, CDCl₃) δ: 7.45 (d, 1H, J=7.4 Hz), 7.37 (dd, 1H, J=9.4, 1.5 Hz), 7.29 (m, 3H), 7.22 (m, 2H), 6.94 (d, 1H, J=14.1 Hz), 6.81 (d, 1H, J=14.1 Hz), 0.51 (d, 6H, J=1.5 Hz); ¹³C-NMR (100 MHz, CDCl₃) δ: 144.9, 143.1, 141.4, 141.2, 139.9, 135.8, 135.3, 134.7, 132.8, 129.2, 128.8, 128.5, 128.4, 127.3, 127.1, −11.5 ppm; HRMS (EI/CI) m/z calculated for C₁₆H₁₅ClSn [M⁺]; 361.9884. found 361.9957.

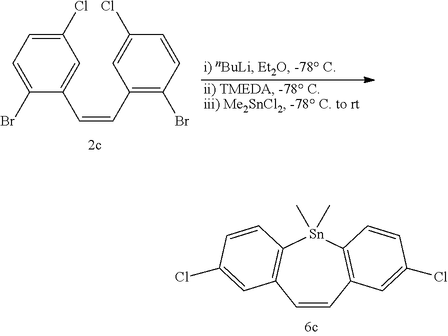

### (Z)-2,8-dichloro-5,5-dimethyldibenzo[b,f]stannepin (6c)

A solution of 2c (3.97 g, 7.63 mmol) in diethyl ether (380 mL) was cooled to −78° C. in a 500 mL Schlenk flask under nitrogen with stirring. A solution of ⁿbutyl lithium in hexanes (1.59 M, 10.5 mL, 16.8 mmol) was added dropwise and the resulting mixture was held at −78° C. for 10 min after which TMEDA (1.97 g, 16.8 mmol) was added. The reaction mixture was held at temperature for 2 h after which a solution of dimethyltin dichloride (1.74 g, 7.63 mmol) in diethyl ether (15 mL) was added dropwise and the resulting mixture was allowed to warm to room temperature and left stirring for 18 h. The reaction mixture was partitioned between 1:1 water:diethyl ether. The aqueous layer was removed and extracted with diethyl ether (3×) and the organics were washed with 0.2 M HCl (1×) and water (1×). The combined organics were dried with MgSO₄, filtered and the solvent removed under reduced pressure to provide a yellow oil that was further purified by column chromatography (SiO₂: 5% diethyl ether in hexane) to yield 3.44 g (8.69 mmol, 97%) of 6c as a pale yellow oil. ¹H-NMR (400 MHz, CDCl₃) δ: 7.39 (d, 2H, J=7.8 Hz), 7.34 (d, 2H, J=2.0 Hz), 7.36 (dd, 7.8, 2.0 Hz), 6.88 (s, 2H), 0.53 (s, 6H); HRMS (FAB) m/z calculated for C₁₆H₁₄Cl₂Sn [M⁺]; 394.9539. found 394.9548.

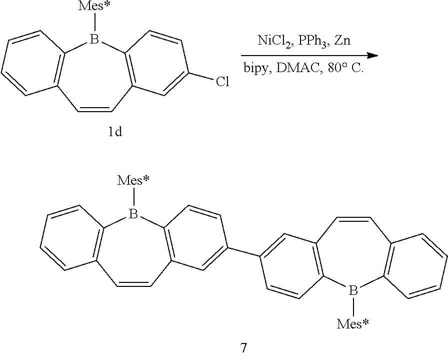

### 5,5′-bis(2,4,6-tri-tert-butylphenyl)-2,2′-bidibenzo[b,f]borepin (7)

A solution of NiCl₂ (3.4 mg, 0.026 mmol), zinc powder (77 mg, 1.2 mmol), PPh₃ (27.2 mg, 0.102 mmol), 2,2′-bipyridine (4.1 mg, 0.026 mmol) in N,N-dimethylacetamide (DMAc) (1 mL) was heated to 50° C. in a dried 25 mL Schlenk flask under nitrogen. A solution of borepin 1d (101 mg, 0.213 mmol) in DMAc (1 mL) was added dropwise at 50° C. when the reaction mixture became reddish-brown in color. The resulting mixture was heated to 90° C. and left stirring under nitrogen for 48 h. The reaction mixture was allowed to cool to room temperature after which it was partitioned between 1:1 water:diethyl ether. The aqueous layer was extracted with diethyl ether (2×) and the combined organics were washed with NH₄Cl_{(aq)} (2×), brine (2×) and 30% H₂O_{2(aq)} (to remove residual PPh₃). The combined organics were dried with MgSO₄, filtered and the solvent removed under reduced pressure to provide an off white solid that was further purified by a short plug (SiO₂: EtOAc) to yield 102 mg (0.107 mmol, quant.) of 7 as an off white solid. ¹H-NMR (400 MHz, CD₂Cl₂) δ: 8.11 (d, 2H, J=8.2 Hz), 8.02 (m, 4H), 7.73 (dd, 2H, J=8.7, 1.8 Hz), 7.64 (m, 6H), 7.53 (s, 4H), 7.24 (s, 4H), 1.45 (s, 9H), 1.31 (s, 18H); ¹³C-NMR (100 MHz, CD₂Cl₂) δ: 150.9, 150.2, 148.5, 142.9, 142.7, 142.5, 142.1, 141.8, 134.6, 134.0, 132.9, 132.8, 131.6, 131.5, 131.3, 123.1, 119.6, 35.1, 35.0, 31.5, 31.4; HRMS (FAB) m/z calculated for C₆₄H₇₆B [M⁺]; 866.6133. found 866.6137.

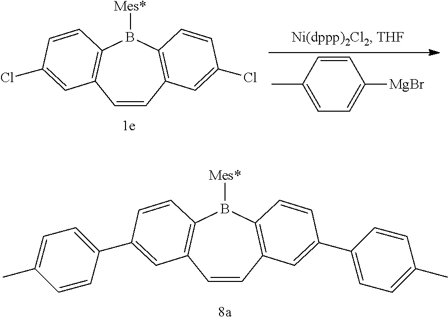

### 2,8-di-p-tolyl-5-(2,4,6-tri-tert-butylphenyl)dibenzo[b,f]borepin (8a)

A solution of borepin 1e (62.5 mg, 0.124 mmol) and Ni(dppp)Cl₂ (3.5 mg, 0.0063 mmol) in THF (3 mL) and Ni(dppp)Cl₂ was stirred in a dried 25 mL Schlenk tube under nitrogen. A solution of p-tolylmagnesium bromide, Organ, M. G., et al., Chem. Eur. J. 13:150-157 (2007), (0.25 M, 1.49 mL, 0.373 mmol) in THF was added dropwise and the resulting mixture was allowed to stir for 18 h at room temperature. The reaction mix was partitioned between 1:1 water:diethyl ether and washed with brine (2×) and water (2×). The aqueous layer was removed and extracted with diethyl ether (3×) and the combined organics were dried with MgSO₄, filtered and the solvent removed under reduced pressure to yield 76 mg (0.123 mmol, 99%) of 8a as an off white solid that was used without further purification. ¹H-NMR (400 MHz, CDCl₃) δ: 8.05 (d, 2H, J=8.1 Hz), 7.91 (d, 2H, J=1.9 Hz), 7.65 (d, 4H, J=8.1 Hz), 7.59 (dd, 2H, J=1.9, 8.1 Hz), 7.54 (s, 2H), 7.31 (s, 2H), 7.29 (d, 4H, J=8.1 Hz), 3.05 (s, 6H), 1.45 (s, 9H), 1.32 (s, 18H); ¹³C-NMR (100 MHz, CDCl₃) δ: 143.4, 142.9, 142.6, 142.2, 138.0, 137.1, 134.3, 130.7, 129.6, 129.4, 127.3, 126.9, 125.1, 122.9, 119.4, 38.5, 34.9, 31.3, 20.9; HRMS (EI) m/z calculated for C₄₆H₅₁B [M⁺]; 614.4084. found 614.4092.

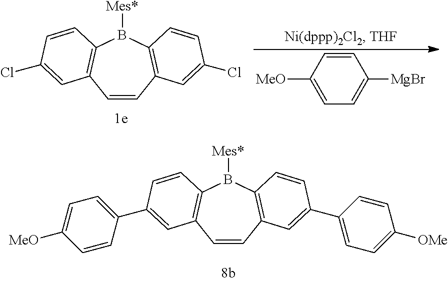

### 2,8-bis(4-methoxyphenyl)-5-(2,4,6-tri-tert-butylphenyl)dibenzo[b,f]borepin (8b)

A solution of borepin 1e (62.5 mg, 0.124 mmol) in THF (3 mL) and Ni(dppp)Cl₂ was stirred in a dried 25 mL Schlenk tube under nitrogen. A solution of 4-methoxyphenyl magnesium bromide, see Organ, M. G., et al., Chem. Eur. J. 13:150-157 (2007), (0.65 M, 0.76 mL, 0.49 mmol) in THF was added dropwise and the resulting mixture was allowed to stir for 18 h at room temperature. The reaction mix was partitioned between 1:1 water:diethyl ether and washed with brine (2×) and water (2×). The aqueous layer was removed and extracted with diethyl ether (3×) and the combined organics were dried with MgSO₄, filtered and the solvent removed under reduced pressure to an off white solid that was further purified by column chromatography (SiO₂: 10% EtOAc:hexane) to yield 52 mg (0.081 mmol, 65%) of 8b as an off white solid. ¹H-NMR (400 MHz, CDCl₃) δ: 8.05 (d, 2H, J=8.1 Hz), 7.83 (d, 2H, J=1.8 Hz), 7.67 (d, 4H, J=8.9 Hz), 7.55 (dd, 2H, J=1.9, 8.1 Hz), 7.51 (s, 2H), 7.26 (s, 2H), 6.99 (d, 4H, J=8.9 Hz); ¹³C-NMR (100 MHz, CDCl₃) δ: 159.8, 150.8, 148.2, 143.1, 142.9, 142.2, 134.5, 132.9, 130.5, 128.5, 125.1, 122.9, 114.5, 55.5, 38.8, 35.4, 31.7, 29.9; HRMS (EI) m/z calculated for C₄₆H₅₁B [M⁺]; 614.4084. found 614.4092.

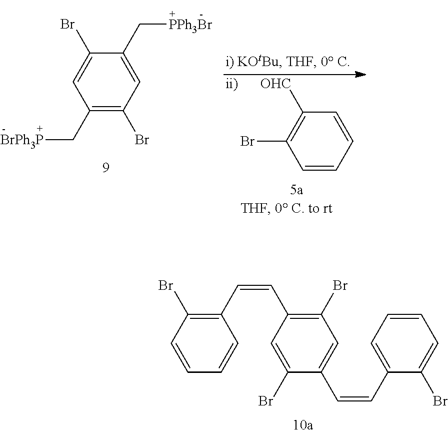

### 2,2′-(1Z,1′Z)-2,2′-(2,5-dibromo-1,4-phenylene)bis(ethene-2,1-diyl)bis(bromobenzene) (10a)

A solution of phosphonium salt 9 (7.22 g, 7.63 mmol) in THF (63 mL) was cooled to 0° C. in a 250 mL 2-neck round bottom under nitrogen with stirring. Potassium ^{t}butoxide (2.09 g, 18.3 mmol) was added portionwise and the resulting mixture was held at 0° C. for 30 min. A solution of benzaldehyde 5a (2.74 g, 14.5 mmol) in THF (63 mL) was added dropwise at 0° C. and the reaction was allowed to warm up to room temperature and left stirring for 24 h. The reaction mix was partitioned between 1:1 water:EtOAc and washed with brine (2×). The aqueous layer was removed and extracted with EtOAc (3×) and the organics were dried with MgSO₄, filtered and the solvent removed under reduced pressure to provide a yellow solid that was rinsed with ethanol and filtered to yield 3.51 g (5.87 mmol, 81%) of 10a as a yellow solid that was used without further purification. ¹H-NMR (400 MHz, CDCl₃) δ: 7.61 (m, 2H), 7.15 (s, 2H), 7.11 (m, 2H), 6.98 (m, 2H), 6.79 (d, 2H), 6.63 (d, 2H); ¹³C-NMR (100 MHz, CDCl₃) δ: 137.7, 136.6, 134.4, 133.2, 132.3, 130.9, 129.5, 129.5, 127.3, 124.2, 122.5; HRMS (FAB) m/z calculated for C₂₂H₁₄Br₄ [M⁺]; 593.7829. found 595.8 (M⁺, ⁸¹Br).

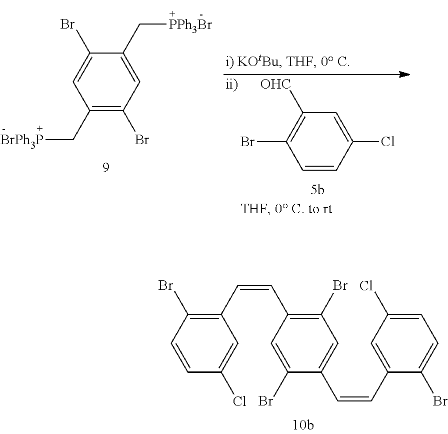

### 2,2′-(1Z,1′Z)-2,2′-(2,5-dibromo-1,4-phenylene)bis(ethene-2,1-diyl)bis(1-bromo-4-chlorobenzene) (10b)

A solution of phosphonium salt 9 (2.79 g, 2.94 mmol) in THF (30 mL) was cooled to 0° C. in a 100 mL 2-neck round bottom under nitrogen with stirring. Potassium ^{t}butoxide (808 mg, 7.06 mmol) was added portionwise and the resulting mixture was held at 0° C. for 30 min. A solution of benzaldehyde 5b (1.23 g, 5.58 mmol) in THF (30 mL) was added dropwise at 0° C. and the reaction was allowed to warm up to room temperature and left stirring for 24 h. The reaction mix was partitioned between 1:1 water:EtOAc and washed with brine (2×). The aqueous layer was removed and extracted with EtOAc (3×) and the organics were dried with MgSO₄, filtered and the solvent removed under reduced pressure to a yellow solid that was rinsed with ethanol and filtered to yield 1.46 g (2.19 mmol, 74%) of 10b as a yellow solid that was used without further purification. ¹H-NMR (400 MHz, CDCl₃) δ: 7.52 (d, 2H, J=8.6 Hz), 7.16 (s, 2H), 7.09 (dd, 2H, J=8.6, 2.6 Hz), 6.99 (d, 2H, J=2.6 Hz), 6.72 (d, 2H, J=12 Hz), 6.68 (d, 2H, J=12 Hz); ¹³C-NMR (100 MHz, CDCl₃) δ: 138.1, 137.3, 134.4, 134.2, 133.4, 131.0, 130.5, 130.4, 129.5, 122.5, 121.9; HRMS (FAB) m/z calculated for C₂₂H₁₂Br₄Cl₂ [M⁺]; 661.7050. found 661.7055.

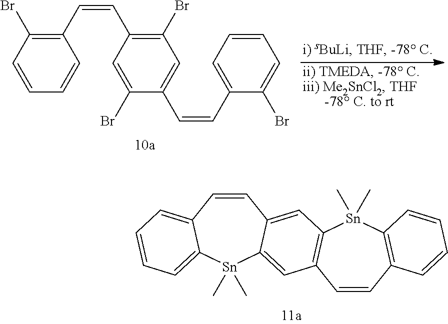

### Fused Stannacycle (11a)

A solution of 10a (501 mg, 0.836 mmol) in THF (65 mL) was cooled to −78° C. in a 100 mL Schlenk flask under nitrogen with stirring. A solution of ^{s}butyl lithium in hexanes (1.4 M, 4.8 mL, 6.7 mmol) was added dropwise and the resulting mixture was held at −78° C. for 10 min after which TMEDA (780 mg, 6.7 mmol) was added. The reaction mixture was held at temperature for 2 h after which a solution of Me₂₅SnCl₂ (387 mg, 1.67 mmol) in THF (8 mL) was added dropwise and the resulting mixture was allowed to warm to room temperature and left stirring for 18 h. The reaction mixture was partitioned between 1:1 water:diethyl ether. The aqueous layer was removed and extracted with diethyl ether (3×) and the organics were washed with 0.2 M HCl (1×) and water (1×). The combined organics were dried with MgSO₄, filtered and the solvent removed under reduced pressure to yield 499 mg (0.836 mmol, quant.) of 11a as a pale yellow solid that was used without further purification. ¹H-NMR (400 MHz, CDCl₃) δ: 7.46 (m, 4H), 7.27 (m, 8H), 6.93 (s, 4H), 0.51 (s, 12H); ¹³C-NMR (100 MHz, CDCl₃) δ: 143.9, 142.6, 142.2, 142.1, 135.5, 135.2, 134.9, 134.5, 129.5, 128.8, 127.6, −11.4; HRMS (FAB) m/z calculated for C₂₆H₂₆¹²⁴Sn₂ [M⁺]; 575.0218. found 575.0126.

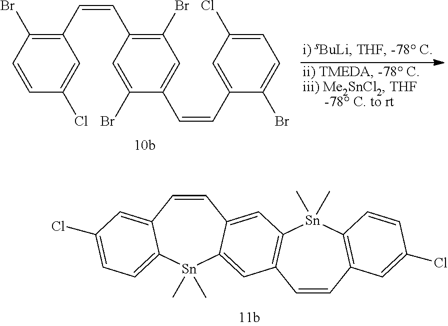

### Bis-chloro-fused stannepin (11b)

A solution of 10b (310 mg, 0.45 mmol) in THF (45 mL) was cooled to −78° C. in a 100 mL Schlenk flask under nitrogen with stirring. A solution of ^{s}butyl lithium in hexanes (1.4 M, 2.6 mL, 3.6 mmol) was added dropwise and the resulting mixture was held at −78° C. for 10 min after which TMEDA (420 mg, 3.6 mmol) was added. The reaction mixture was held at temperature for 2 h after which a solution of Me₂SnCl₂ (208 mg, 0.899 mmol) in THF (3 mL) was added dropwise and the resulting mixture was allowed to warm to room temperature and left stirring for 18 h. The reaction mixture was partitioned between 1:1 water:diethyl ether. The aqueous layer was removed and extracted with diethyl ether (3×) and the organics were washed with 0.2 M HCl (1×), water (1×) and brine (1×). The combined organics were dried with MgSO₄, filtered and the solvent removed under reduced pressure to provide an orange solid that was rinsed with methanol to yield 290 mg (0.45 mmol, quant.) of 11b as a pale yellow solid that was used without further purification. ¹H-NMR (400 MHz, CD₂Cl₂) δ: 7.41 (s, 2H), 7.37 (d, 2H, J=7.8 Hz), 7.29 (d, 2H, J=2.1 Hz), 7.21 (dd, 2H, J=7.8, 2.1 Hz), 6.95 (d, 2H, J=13.7 Hz), 6.82 (d, 2H, J=13.7 Hz), 0.49 (s, 12H); ¹³C-NMR (100 MHz, CDCl₃) δ: 144.9, 142.0, 141.8, 139.8, 135.9, 135.2, 135.1, 134.8, 133.3, 128.9, 127.2, −11.4; HRMS (FAB) m/z calculated for C₂₆H₂₄Cl₂Sn₂ [M⁺]; 645.9299. found 645.9347.

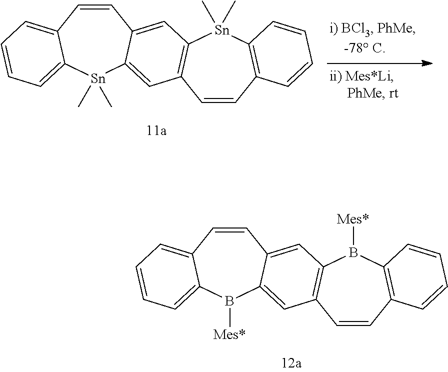

### Fused B-Mes* borepin (12a)

A solution of fused stannepin 11a (126 mg, 0.218 mmol) in toluene (4 mL) was cooled to −78° C. in a dried 25 mL Schlenk tube under nitrogen. A solution of BCl₃ in hexanes (1.0 M, 0.44 mL, 0.44 mmol) was added dropwise with stirring after which the reaction mixture was allowed to slowly warm to room temperature over 1 h. A solution of Mes*Li, see Wakamiya, A., et al., Chem. Comm. 579-581 (2008), (438 mg, 1.74 mmol) in toluene (4 mL) was added dropwise and the resulting mixture was left stirring at room temperature for 18 h. The reaction mix was partitioned between 1:1 water:diethyl ether and washed with brine (2×). The aqueous layer was removed and extracted with diethyl ether (2×) and the combined organics were dried with MgSO₄, filtered and the solvent removed under reduced pressure to provide a yellow solid that was further purified by a short plug (SiO₂: 5% EtOAc in hexane) to yield 74 mg (0.094 mmol, 43%) of 12a as a yellow solid. ¹H-NMR (CD₂Cl₂) δ: 8.27 (s, 2H), 8.09 (d, 2H, J=7.7 Hz), 7.64 (m, 4H), 7.59 (s, ⁴H), 7.38 (t, 2H, J=6.6 Hz), 7.14 (d, 2H, J=12.9 Hz), 7.05 (d, 2H, J=12.9 Hz), 1.51 (s, 18H), 1.12 (s, 36H). HRMS (FAB) m/z calculated for C₅₈H₇₂B₂ [M⁺]; 790.5820. found 790.5826.

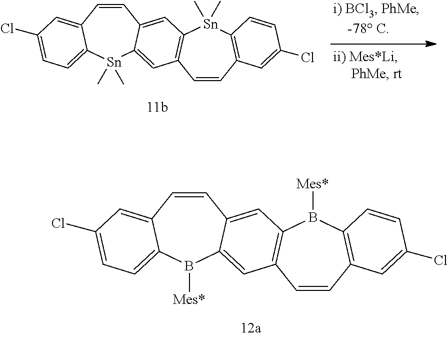

### Fused dichloro-B-Mes* borepin (12b)

A solution of fused dichlorostannepin 11b (201 mg, 0.309 mmol) in toluene (4 mL) was cooled to −78° C. in a dried 25 mL Schlenk tube under nitrogen. A solution of BCl₃ in hexanes (1.0 M, 0.62 mL, 0.62 mmol) was added dropwise with stirring after which the reaction mixture was allowed to slowly warm to room temperature over 1 h. A solution of Mes*Li, see Wakamiya, A., et al., Chem. Comm. 579-581 (2008), (626 mg, 2.48 mmol) in toluene (4 mL) was added dropwise and the resulting mixture was left stirring at room temperature for 18 h. The reaction mix was partitioned between 1:1 water:diethyl ether and washed with brine (2×). The aqueous layer was removed and extracted with diethyl ether (2×) and the combined organics were dried with MgSO₄, filtered and the solvent removed under reduced pressure to provide a yellow solid that was further purified by column chromatography (SiO₂: 5% DCM in hexane) to yield 92 mg (0.11 mmol, 34%) of 12b as a yellow solid. ¹H-NMR (400 MHz, CD₂Cl₂) δ: 8.22 (s, 2H), 7.99 (d, 2H, J=8.4 Hz), 7.61 (d, 2H, J=2.1 Hz), 7.55 (s, 4H), 7.29 (dd, 2H, J=8.4, 2.1 Hz), 7.04 (d, 2H, J=12.8 Hz), 6.99 (d, 2H, J=12.8 Hz), 1.47 (s, 18H), 0.97 (s, 36H); HRMS (FAB) m/z calculated for C₅₈H₇₀B₂Cl₂ [M⁺]; 858.5041. found 858.5016.

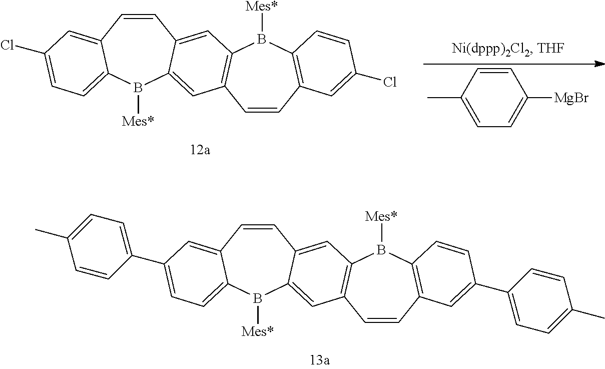

### Fused bis(p-tolyl)B-Mes* borepin (13a)

A solution of borepin 12b (40.2 mg, 0.0468 mmol) in THF (2 mL) and Ni(dppp)Cl₂ (1.5 mg, 0.0023 mmol) was stirred in a dried 25 mL Schlenk tube under nitrogen. A solution of 4-tolylmagnesium bromide, see Organ, M. G., et al., Chem. Eur. J. 13:150-157 (2007), (0.5 M, 0.56 mL, 0.28 mmol) in THF was added dropwise and the resulting mixture was heated to 50° C. for 18 h. The reaction mixture was allowed to cool to room temperature, partitioned between 1:1 water:diethyl ether and washed with 1 M HCl_{(aq)}, water (1×) and brine (1×). The aqueous layer was removed and extracted with diethyl ether (3×) and the combined organics were dried with MgSO₄, filtered and the solvent removed under reduced pressure to a yellow solid that was further purified by column chromatography (SiO₂: 5% EtOAc in hexane) to yield 41 mg (0.042 mmol, 90%) of 13a as a yellow solid. When heated, 13a lost crystallinity at ˜151° C. and began to change color from bright green-yellow to orange at 258° C. UV-vis of the melting point sample afterwards showed mostly desired product and some decomposition (peak growing in at 262 nm). A sample of 13a was heated to 130° C. for 30 min, after which the ¹H-NMR (400 MHz, CD₂Cl₂) was retaken and there was no evidence of decomposition. ¹H-NMR (400 MHz, CD₂Cl₂) δ: 8.27 (s, 2H), 8.11 (d, 2H, J=8.1 Hz), 7.86 (d, 2H, J=1.8 Hz), 7.61 (m, 10H), 7.29 (d, 4H, J=7.9 Hz), 7.19 (d, 2H, J=12.9 Hz), 7.06 (d, 2H, J=12.9 Hz), 2.40 (s, 6H), 1.50 (s, 18H), 1.03 (s, 36H); HRMS (FAB) m/z calculated for C₇₂H₈₄B₂ [M⁺]; 970.6759. found 970.6763.

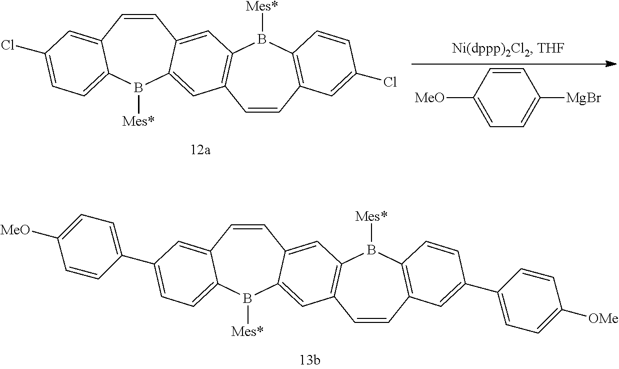

### Fused bis(p-methoxybenzene)B-Mes* borepin (13b)

A solution of borepin 12b (38.6 mg, 0.0449 mmol) in THF (2 mL) and Ni(dppp)Cl₂ (1.1 mg, 0.0018 mmol) was stirred in a dried 25 mL Schlenk tube under nitrogen. A solution of 4-methoxyphenyl magnesium bromide, see Organ, M. G., et al., Chem. Eur. J. 13:150-157 (2007), (0.5 M, 0.36 mL, 0.18 mmol) in THF was added dropwise and the resulting mixture was allowed to stir for 18 h. The reaction mix was partitioned between 1:1 water:diethyl ether and washed with 1 M HCl_{(aq)}, water (1×) and brine (1×). The aqueous layer was removed and extracted with diethyl ether (3×) and the combined organics were dried with MgSO₄, filtered and the solvent removed under reduced pressure to provide a yellow solid that was further purified by column chromatography (SiO₂: 15% DCM in hexane) to yield 42 mg (0.0042 mmol, 93%) of 13b as a yellow solid. ¹H-NMR (400 MHz, CD₂Cl₂) δ: 8.17 (s, 2H), 8.01 (d, 2H, J=8.1 Hz), 7.75 (d, 2H, J=2.0 Hz), 7.59 (d, 41-1, J=8.9 Hz), 7.48 (m, 6H), 7.09 (d, 2H, J=13.3 Hz), 6.97 (d, 2H, J=13.3 Hz), 6.92 (d, 4H, J=8.9 Hz), 3.77 (s, 6H), 1.41 (s, 18H), 0.94 (s, 36H); HRMS (FAB) m/z calculated for C₇₂H₈₄B₂O₂ [M⁺]; 1002.6657. found 1002.6651.

Additional electrochemical and photophysical data for the presently disclosed borepins are provided in Table 6 and Table 7.

TABLE 6
Electrochemical Data for Representative Borepins.

| | |
|---|---|
| Compound | E_{1/2}/V |

| | | |
|---|---|---|
| 1c | −2.54 | |
| 7 | −1.97 | −2.20 |
| 8a | −2.24 | |
| 8b | −2.23 | |
| 12a | .1.89 | −2.59 |
| 13a | −1.87 | −2.48 |
| 13b | −1.88 | −2.46 |

TABLE 7
Photophysical Data for Representative Borepins.

| | | | | log(ε) (molar |
|---|---|---|---|---|
| Compound | UV λₘₐₓ/nm | PL λₘₐₓ/nm [exc] | PL QY | absorptivity) |
| 2a | 272 | n/a | | |
| 6a | 283 | n/a | | |
| 1c | 358 | 384 [342] | 36 | 3.55 |
| | 342 | | | 3.74 |
| | 322 | | | 4.29 |
| | 309 | | | 4.35 |
| 7 | 379 | 404 [317] | 58 | 3.43 |
| | 364 | | | 3.59 |
| | 331 | | | 4.43 |
| | 316 | | | 4.50 |
| | 298 | | | 4.46 |
| | 263 | | | 4.42 |
| 8a | 382 | 396 [362] | 23 | 2.97 |
| | 362 | | | 3.14 |
| | 298 | | | 4.31 |
| 8b | 380 | 395 [365] | 38 | 3.55 |
| | 331 | | | 4.77 |
| | 310 | | | 4.86 |
| 12a | 439 | 456 [415] | 73 | 3.52 |
| | 387 | | | 4.37 |
| | 368 | | | 4.43 |
| | 286 | | | 4.54 |
| 13a | 442 | 459 [391] | 56 | 3.33 |
| | 391 | | | 4.22 |
| | 372 | | | 4.24 |
| | 321 | | | 4.41 |
| 13b | 438 | 459 [390] | 50 | 3.36 |
| | 391 | | | 4.22 |
| | 372 | | | 4.24 |
| | 320 | | | 4.41 |

### Example 2

### Functionalized Dibenzoborepins as Components of Small Molecule and Polymeric π-Conjugated Electronic Materials

### General Considerations

All reaction manipulations were carried out under an atmosphere of prepurified nitrogen or argon using Schlenk techniques. Non-aqueous solvents were degassed by sparging with nitrogen for 15 minutes prior to use and toluene, diethyl ether and THF were distilled over sodium/benzophenone ketyl.

Tetrakis(triphenylphosphine) palladium was obtained from Strem Chemicals and 32-63 micron silica gel was used. ¹H NMR and ¹³C NMR were obtained in deuterated chloroform (the signal for residual protio solvent was set at 7.26 ppm for ¹H NMR and 77.16 ppm for ¹³C NMR), deuterated methylene chloride (the signal for residual protio solvent was set at 5.32 ppm for ¹H NMR and 54 ppm for ¹³C NMR) or deuterated dimethyl sulfoxide (the signal for residual protio solvent was set at 2.50 ppm for ¹H NMR and 39.52 ppm for ¹³C NMR) using a 400 MHz FT-NMR spectrometer. All efforts to obtain ¹³C NMR were unsuccessful due to the low solubility of the functionalized DBBs (overnight scans did not result in spectra with reasonable signal to noise) and quadrupolar relaxation of boron. Mass spectra were obtained with EI (70 eV) and FAB ionization (matrix for FAB was 3-nitrobenzyl alcohol) and GPC analyses were done on a 5μ, 300×75 mm column.

### Photophysical Considerations

Spectroscopic measurements were conducted in CHCl₃ solution at room temperature. UV-vis absorption spectra were recorded on UV-Visible spectrophotometer. Photoluminescence spectra were recorded on a fluorometer with a 75 W Xenon lamp, maintaining optical densities below 0.05 au and lifetime data were collected on a generic LED system. Quantum yields were determined relative to quinine sulfate in 0.1 NH₂SO₄ (55%).

### Electrochemical Considerations

Cyclic voltammetry was performed in a one-chamber, three-electrode cell using a potentiostat. A 2 mm² Pt button electrode was used as the working electrode with a platinum wire counter electrode relative to a quasi-internal Ag wire reference electrode submersed in 0.01 M AgNO₃/0.1 M n-Bu₄NPF₆ in anhydrous acetonitrile. Measurements were taken on mM analyte concentrations in 0.1 M n-Bu₄PF₆ (in THF) electrolyte solutions recorded at a scan rate of 100 mV/s. Potentials are reported relative to the Ag/Ag⁺ couple with which the Fc/Fc⁺ couple was found to be 205 mV.

### Computational Considerations

Molecular orbital calculations were performed at the DFT level (B3LYP/6-31G*) on equilibrium geometries using Spartan '04 (Wavefunction Inc., Irvine, Calif.).

For reference, the numbering scheme for dibenzo[b,f]borepins as shown below is used throughout.

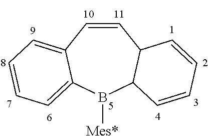

### 2,8-dibromo-5-(2,4,6-tri-tert-butylphenyl)dibenzo[b,f]borepin (14a)

A solution of stannepin 19a (102 mg, 0.209 mmol) in toluene (2 mL) was cooled to −78° C. in a dried 25 mL Schlenk tube under nitrogen. A solution of BCl₃ in hexane (1.0 M, 0.23 mL, 0.23 mmol) was added dropwise with stirring after which the reaction mixture was allowed to slowly warm to room temperature over 1 h. A solution of Mes*Li (265 mg, 1.05 mmol) in toluene (3 mL) was added dropwise and the resulting mixture was left stirring at room temperature for 18 h. The reaction mix was partitioned between 1:1 water:diethyl ether and the organic phase was washed with brine (2×). The aqueous layer was removed and extracted with diethyl ether (2×) and the combined organics were dried with MgSO₄, filtered and the solvent removed under reduced pressure to a yellow oil that was further purified by column chromatography (SiO₂: hexane) to yield 114 mg (0.193 mmol, 92%) of 14a as an off-white solid. ¹H-NMR (400 MHz, CD₂Cl₂) δ: 7.84 (m, 4H), 7.50 (s, 2H), 7.47 (dd, 2H, J=8.3, 2.0 Hz), 7.11 (s, 2H), 1.42 (s, 9H), 0.94 (s, 18H); ¹³C-NMR (100 MHz, CD₂Cl₂) δ: 151.1, 149.1, 143.9, 143.3, 139.2, 135.4, 134.1, 130.7, 130.5, 126.7, 123.5, 38.7, 35.3, 31.5, 30.1; HRMS (FAB) m/z calculated for C₃₂H₃₇BBr₂ [M⁺]; 590.1355. found 590.1314.

### 3,7-dibromo-5-(2,4,6-tri-tert-butylphenyl)dibenzo[b,f]borepin (14b)

A solution of stannepin 19b (80.4 mg, 0.166 mmol) in toluene (2 mL) was cooled to −78° C. in a dried 25 mL Schlenk tube under nitrogen. A solution of BBr₃ in hexane (1.0 M, 0.18 mL, 0.18 mmol) was added dropwise with stirring after which the reaction mixture was allowed to slowly warm to room temperature over 1 h. A solution of Mes*Li (209 mg, 0.829 mmol) in toluene (2 mL) was added dropwise and the resulting mixture was left stirring at room temperature for 18 h. The reaction mix was partitioned between 1:1 water:diethyl ether and the organic phase was washed with brine (2×). The aqueous layer was removed and extracted with diethyl ether (2×) and the combined organics were dried with MgSO₄, filtered and the solvent removed under reduced pressure to an off white solid that was further purified by column chromatography (SiO₂: hexane) to yield 31.5 mg (0.053 mmol, 32%) of 14b as an off-white solid. ¹H-NMR (400 MHz, CD₂Cl₂) δ: 8.06 (d, 2H, J=2.3 Hz), 7.70 (dd, 2H, J=8.3, 2.3 Hz), 7.54 (m, 4H), 7.16 (s, 2H), 1.45 (s, 9H), 0.97 (s, 18H); ¹³C-NMR (100 MHz, CDCl₃) δ: 150.8, 149.1, 145.7, 145.64, 145.62, 144.1, 140.2, 134.6, 134.5, 133.5, 132.0, 128.2, 123.2, 121.8, 38.6, 35.3, 31.6, 29.9; HRMS (FAB) m/z calculated for C₃₂H₃₇BBr₂ [M⁺]; 590.1355. found 590.1363.

### 4-bromo-2-iodotoluene

A solution of acetic acid (100 mL) and acetic anhydride (50 mL) was cooled to 0° C. in a 500 mL 3-neck round bottom under nitrogen with stirring. NaIO₄ (15.4 g, 71.9 mmol) and I₂ (12.2 g, 48.1 mmol) were added portionwise at 0° C. after which H₂SO₄ (21 mL) was added dropwise while maintaining a temperature of 0-5° C. Bromotoluene (23.1 g, 135 mmol) was added portionwise at 0° C. and after 2 h the resulting mixture was allowed to warm to room temperature and stir overnight. The reaction mixture was poured into 10% NaHCO₃ (aq) (200 mL) and ice (250 g) and extracted with methylene chloride (3×). The combined organics were washed with water (3×), dried with MgSO₄, filtered and the solvent removed under reduced pressure to provide a reddish oil that was further purified by vacuum distillation (92° C. at 1 mm Hg) yielding 30 g (10 mmol, 66%) of 4-bromo-2-iodotoluene as a colorless oil. ¹H-NMR (400 MHz, CDCl₃) δ: 7.92 (s, 2H), 7.34 (d, 2H, J=8.1 Hz), 7.08 (d, 2H, J=8.1 Hz), 2.36 (s, 3H); ¹³C-NMR (100 MHz, CDCl₃) δ: 140.8, 131.3, 130.8, 119.6, 101.5, 27.8; HRMS (EI) m/z calculated for C₇H₆BrI [M⁺]; 295.8698. found 295.8696

### 5-bromo-1-(bromomethyl)-2-iodobenzene (15a)

A solution of 5-bromo-2-iodotoluene (6.75 g, 22.7 mmol) and 1,2-dichlorethane (25 mL) was stirred at room temperature in a 50 mL two neck round bottom under nitrogen. Benzoyl peroxide (281 mg, 1.14 mmol) and NBS (4.5 g, 25 mmol) were added at once and the resulting mixture was heated to reflux and irradiated with a 250 W incandescent flood lamp (12 in away from round bottom) for 5 h. The reaction mixture was allowed to cool to room temperature after which precipitates were filtered off and rinsed with hexane. The filtrate was dried with MgSO₄, filtered and the solvent removed under reduced pressure to provide an orange solid that was then rinsed with cold methanol yielding 3.99 g (10.6 mmol, 47%) of an off-white solid that was used without further purification. Characterization data matched that found in literature. Amijs, C. H. M., et al., Green Chem. 2003, 5, 470-474.

### 4-bromo-1-(bromomethyl)-2-iodobenzene (15b)

A solution of 4-bromo-2-iodotoluene (3.94 g, 13.3 mmol) and 1,2-dichlorethane (19 mL) was stirred at room temperature in a 50 mL two neck round bottom under nitrogen. Benzoyl peroxide (164 mg, 0.663 mmol) and NBS (2.63 g, 14.6 mmol) were added at once and the resulting mixture was heated to reflux for 5 h. The reaction mixture was allowed to cool to room temperature after which precipitates were filtered off and washed with hexane. The filtrate was dried with MgSO₄, filtered and the solvent removed under reduced pressure to provide an orange solid that was then rinsed with cold methanol yielding 3.27 g (8.75 mmol, 66%) of an off-white solid that was used without further purification. ¹H-NMR (400 MHz, CDCl₃) δ: 8.01 (d, 1H, J=2.0 Hz), 7.47 (dd, 1H, J=8.3, 2.0 Hz), 7.33 (d, 1H, J=8.3 Hz), 4.54 (s, 2H); HRMS (EI) m/z calculated for C₇H₅Br₂I [M⁺]; 377.7762. found 377.7759.

### 5-bromo-2-iodobenzyltriphenylphosphonium bromide (16a)

A solution of benzyl bromide 15a (3.74 g, 9.96 mmol) in DMF (10 mL) was stirred at room temperature in a dried 25 mL round bottom under nitrogen. Triphenyl phosphine (2.9 g, 11 mmol) was added portionwise at room temperature and the resulting reaction mixture was allowed to stir overnight. After 18 h, the reaction mixture was poured into toluene and the resulting suspension was filtered. The solid was added to diethyl ether rinsing with a minimal amount of DCM as necessary. The resulting suspension was filtered yielding 6.18 g (9.68 mmol, 97%) of 16a as an off white solid. ¹H-NMR (400 MHz, CDCl₃) δ: 7.74 (m, 15H), 7.53 (m, 2H), 7.10 (dt, 1H, J=8.4, 2.4 Hz), 5.84 (d, 2H, J=14.5 Hz); HRMS (FAB) m/z calculated for C₂₅H₂₀BrIP [M⁺-⁷⁹Br]; 556.9531. found 556.9527.

### 4-bromo-2-iodobenzyltriphenylphosphonium bromide (16b)

A solution of benzyl bromide 15b (2.42 g, 6.45 mmol) in DMF (6 mL) was stirred at room temperature in a dried 25 mL round bottom under nitrogen. Triphenyl phosphine (1.9 g, 7.1 mmol) was added portionwise at room temperature and the resulting reaction mixture was allowed to stir overnight. After 18 h, the reaction mixture was poured into toluene and the resulting suspension was filtered. The solid was added to diethyl ether rinsing with a minimal amount of DCM as necessary. The resulting suspension was filtered yielding 3.73 g (5.85 mmol, 91%) of 16b as an off white solid. ¹H-NMR (400 MHz, CD₂Cl₂) δ: 7.87 (m, 4H), 7.69 (m, 12H), 7.37 (m, 2H), 5.55 (d, 21-1, J=14.3 Hz); HRMS (FAB) m/z calculated for C₂₅H₂₀BrIP [M⁺-⁷⁹Br]; 556.9531. found 556.9535.

### 5-bromo-2-iodobenzaldehyde (17a)

A solution of N-methyl morpholine-N-oxide (870 mg, 7.2 mmol) and 4 Å sieves (5.8 g) in acetonitrile (18 mL) in a dried 250 mL Schlenk flask under nitrogen was cooled to 0° C., and benzyl bromide 15a (880 mg, 2.3 mmol) was added at once. The reaction mixture was held at 0° C. for 2 h before warming to room temperature. The reaction mixture was then filtered through a short plug (SiO₂: hexane) to yield 761 mg (2.44 mmol, 99%) of 17a as an off-white solid. Characterization data matches that found in literature. Zhou, N., e.g., Org. Lett. 2008, 10, 3001-3004.

### 4-bromo-2-iodobenzaldehyde (17b)

A solution of N-methyl morpholine-N-oxide (2.81 g, 23.2 mmol) and 4 Å sieves (19 g) in acetonitrile (60 mL) in a dried 250 mL Schlenk flask under nitrogen was cooled to 0° C., and benzyl bromide 15b (2.9 g, 7.7 mmol) was added at once. The reaction mixture was held at 0° C. for 2 h before warming to room temperature. The reaction mixture was then filtered through a short plug (SiO₂: hexane) to yield 2.15 g (6.92 mmol, 90%) of 17b as an off-white solid. ¹H-NMR (400 MHz, CDCl₃) δ: 9.99 (s, 1H), 8.13 (d, 1H, J=0.8 Hz), 7.73 (dd, 1H, 8.3, 0.8 Hz), 7.61 (dd, 1H, J=8.3, 0.8 Hz); ¹³C-NMR (100 MHz, CDCl₃) δ: 194.7, 142.8, 134.1, 132.3, 131.1, 130.2, 100.9; HRMS (EI) m/z calculated for C₇H₄BrIO [M⁺]; 309.8490. found 309.8489.

### (Z)-1,2-bis(5-bromo-2-iodophenyl)ethene (18a)

A solution of phosphonium salt 16a (3.84 g, 6.02 mmol) in THF (60 mL) was cooled to 0° C. in a 250 mL Schlenk flask under nitrogen with stirring. Potassium ^{t}butoxide (815 mg, 7.12 mmol) was added portionwise and the resulting mixture was held at 0° C. for 30 min. A solution of benzaldehyde 17a (1.7 g, 5.5 mmol) in THF (60 mL) was added dropwise at 0° C. and the reaction was allowed to warm up to room temperature and left stirring for 24 h. The reaction mix was partitioned between 1:1 water:diethyl ether. The aqueous layer was removed and extracted with diethyl ether (3×) and the organics were dried with MgSO₄, filtered and the solvent removed under reduced pressure to provide an off white solid that was further purified by a short plug (SiO₂: 10% ethyl acetate in hexane) to yield 2.95 g (4.99 mmol, 91%) 82:18 Z:E of 18a as an off-white solid that was used without further purification. ¹H-NMR (400 MHz, CDCl₃) δ: 7.70 (d, 2H, J=8.4 Hz), 7.05 (dd, 2H, J=8.4, 2.4 Hz), 7.02 (d, 2H, J=2.4 Hz), 6.58 (s, 2H); HRMS (FAB) m/z calculated for C₁₄H₈Br₂I₂ [M⁺]; 587.7082. found 587.7067.

### (Z)-1,2-bis(4-bromo-2-iodophenyl)ethene (18b)

A solution of phosphonium salt 16b (2.96 g, 4.64 mmol) in THF (42 mL) was cooled to 0° C. in a 100 mL Schlenk flask under nitrogen with stirring. Potassium ^{t}butoxide (628 mg, 5.49 mmol) was added portionwise and the resulting mixture was held at 0° C. for 30 min. A solution of benzaldehyde 17b (1.31 g, 4.22 mmol) in THF (40 mL) was added dropwise at 0° C. and the reaction was allowed to warm up to room temperature and left stirring for 24 h. The reaction mix was partitioned between 1:1 water:diethyl ether. The aqueous layer was removed and extracted with diethyl ether (3×) and the organics were dried with MgSO₄, filtered and the solvent removed under reduced pressure to provide an off white solid that was further purified by a short plug (SiO₂: 5% ethyl acetate in hexane) to yield 2.34 g (3.98 mmol, 94%) 85:15 Z:E of 18b as an off-white solid that was used without further purification. ¹H-NMR (400 MHz, CDCl₃) δ: 7.99 (d, 2H, J=2.0 Hz), 7.21 (dd, 2H, J=8.3, 2.0 Hz), 6.73 (d, 2H, J=8.3 Hz), 6.55 (s, 2H); HRMS (FAB) m/z calculated for C₁₄H₈Br₂I₂ [M⁺]; 587.7082. found 587.7087.

### 2,8-dibromo-5,5-dimethyldibenzo[b,f]stannepin (19a)

A solution of 18a (1.51 g, 2.05 mmol) in diethyl ether (70 mL) was cooled to −78° C. in a 200 mL Schlenk flask under nitrogen with stirring. A solution of ⁿbutyl lithium in hexanes (1.73 M, 2.61 mL, 4.52 mmol) was added dropwise and the resulting mixture was held at −78° C. for 10 min followed by the addition of TMEDA (525 mg, 4.52 mmol). The reaction mixture was held at −78° C. for 2 h after which a solution of dimethyltin dichloride (451 mg, 2.05 mmol) in THF (5 mL) was added dropwise. The resulting mixture was allowed to warm to room temperature and left to stir for 18 h. The reaction mixture was partitioned between 1:1 water:diethyl ether. The aqueous layer was removed and extracted with diethyl ether (3×) and the organics were washed with 0.2 M HCl (1×) and water (1×). The combined organics were dried with MgSO₄, filtered and the solvent removed under reduced pressure to provide a yellow oil that was further purified by column chromatography (SiO₂: hexane) to yield 476 mg (0.982 mmol, 60%) of 19a as a white solid. ¹H-NMR (400 MHz, CDCl₃) δ: 7.47 (d, 2H, J=1.7 Hz), 7.38 (dd, 2H, J=7.8, 1.7 Hz), 7.29 (d, 2H, H=7.8 Hz), 6.84 (s, 2H), 0.51 (s, 6H); ¹³C-NMR (100 MHz, CDCl₃) δ: 144.9, 140.3, 136.1, 134.0, 131.9, 130.3, 123.3, −11.3; HRMS (FAB) m/z calculated for C₁₆H₁₅Br₂Sn [MH⁺]; 484.8536. found 484.8553.

### 3,7-dibromo-5,5-dimethyldibenzo[b,f]stannepin (19b)

A solution of 18b (501 mg, 0.848 mmol) in diethyl ether (42 mL) was cooled to −78° C. in a 100 mL Schlenk flask under nitrogen with stirring. A solution of ⁿbutyl lithium in hexanes (1.73 M, 1.1 mL, 1.9 mmol) was added dropwise and the resulting mixture was held at −78° C. for 10 min followed by the addition of TMEDA (0.217 mg, 1.86 mmol). The reaction mixture was held at −78° C. for 2 h after which a solution of dimethyltin dichloride (187 mg, 0.848 mmol) in THF (5 mL) was added dropwise. The resulting mixture was allowed to warm to room temperature and left to stir for 18 h. The reaction mixture was partitioned between 1:1 water:diethyl ether. The aqueous layer was removed and extracted with diethyl ether (3×) and the organics were washed with 0.2 M HCl(1×) and water (1×). The combined organics were dried with MgSO₄, filtered and the solvent removed under reduced pressure to provide a yellow oil that was further purified by column chromatography (SiO₂: hexane) to yield 254 mg (0.525 mmol, 73%) of 19b as a white solid. ¹H-NMR (400 MHz, CD₂Cl₂) δ: 7.56 (d, 2H, J=2.2 Hz), 7.41 (dd, 2H, J=8.3, 2.2 Hz), 7.19 (d, 2H, 8.3 Hz), 6.86 (s, 2H), 0.54 (s, 6H); ¹³C-NMR (100 MHz, CD₂Cl₂) δ: 145.0, 142.4, 137.5, 134.1, 131.9, 131.3, 123.1, −11.0; HRMS (FAB) m/z calculated for C₁₆H₁₅Br₂Sn [MH⁺]; 484.8536. found 484.8526.

### 2,8-di(thiophen-2-yl)-5-(2,4,6-tri-tert-butylphenyl)dibenzo[b,f]borepin (20a)

A solution of borepin 14a (28 mg, 0.047 mmol) and Pd(PPh₃)₄ (3.0 mg, 0.026 mmol) in DMF (1.5 mL) was stirred in a dry 25 mL Schlenk tube under nitrogen. 2-tributylstannyl thiophene (55 mg, 0.14 mmol) was added dropwise and the resulting mixture was heated to 80° C. for 18 h. Upon cooling, the reaction was diluted with diethyl ether and stirred vigorously with KF (2×). The filtered organic layer was then partitioned between 1:1 water:diethyl ether. The aqueous layer was removed and extracted with diethyl ether (3×) and the organics were washed with brine (2×). The combined organics were dried with MgSO₄, filtered and the solvent removed under reduced pressure to provide a yellow oil that was further purified by column chromatography (SiO₂: 1% ethyl acetate in hexane) to yield 15 mg (0.025 mmol, 53%) of 20a as an off-white solid. ¹H-NMR (400 MHz, CD₂Cl₂) δ: 7.99 (d, 2H, J=7.9 Hz), 7.92 (d, 2H, J=1.6 Hz), 7.61 (dd, 2H, J=8.2, 1.9 Hz), 7.52 (m, 4H), 7.39 (dd, 2H, J=5.1, 1.0 Hz), 7.27 (s, 2H), 7.14 (m, 2H), 1.45 (s, 9H), 1.00 (s, 18H); MS (FAB) m/z calculated for C₄₀H₄₃BS₂ [M⁺]; 598.3. found 598.3.

### 2,8-di([2,2′-bithiophen]-5-yl)-5-(2,4,6-tri-tert-butylphenyl)dibenzo[b,f]borepin (20b)

A solution of borepin 14a (32.8 mg, 0.0554 mmol) and Pd(PPh₃)₄ (3.2 mg, 0.0028 mmol) in DMF (1.5 mL) was stirred in a dry 25 mL Schlenk tube under nitrogen. 2-tributylstannyl thiophene (73 mg, 0.16 mmol) was added dropwise and the resulting mixture was heated to 80° C. for 18 h. Upon cooling, the reaction was diluted with diethyl ether and stirred vigorously with KF (2×). The filtered organic layer was then partitioned between 1:1 water:diethyl ether. The aqueous layer was removed and extracted with diethyl ether (3×) and the organics were washed with brine (2×). The combined organics were dried with MgSO₄, filtered and the solvent removed under reduced pressure to provide an orange solid that was further purified by rinsing with methanol to yield 31 mg (0.041 mmol, 73%) of 20b as an orange solid. ¹H-NMR (400 MHz, CDCl₃) δ: 8.03 (d, 2H, J=8.1 Hz), 7.87 (d, 2H, J=1.8 Hz), 7.60 (dd, 2H, 8.1, 1.8 Hz), 7.52 (s, 2H), 7.41 (d, 2H, J=3.8 Hz), 7.25 (m, 4H), 7.21 (d, 2H, J=3.8 Hz), 7.08 (m, 4H), 1.47 (s, 9H), 1.02 (s, 18H); HRMS (FAB) m/z calculated for C₄₈H₄₇BS₄ [M⁺]; 762.2654. found 762.2674.

### 2,8-bis(phenylethynyl)-5-(2,4,6-tri-tert-butylphenyl)dibenzo[b,f]borepin (20d)

A solution of borepin 14a (30 mg, 0.05 mmol), CuI (1 mg, 0.005 mmol) and Pd(PPh₃)₄ (2.9 mg, 0.0025 mmol) in toluene (1 mL) and DIPA (0.2 mL) was stirred in a dried 25 mL Schlenk flask under nitrogen. Phenyl acetylene (14 mg, 0.13 mmol) was added dropwise at room temperature and the resulting reaction mixture was heated to 75° C. for 18 h. The reaction mixture was allowed to cool to room temperature after which it was partitioned between water and diethyl ether and washed with NH₄Cl(2×) and brine (2×). The aqueous layer was removed and extracted with diethyl ether (3×) and the combined organics were dried with MgSO₄, filtered and the solvent removed under reduced pressure to provide a brown solid that was further purified by column chromatography (SiO₂: 1% ethyl acetate in hexane) to yield 18.2 mg (0.0287 mmol, 56%) of 20d as an off-white solid. ¹H-NMR (400 MHz, CD₂Cl₂) δ: 7.99 (d, 2H, J=8.0 Hz), 7.85 (s, 2H), 7.58 (m, 4H), 7.54 (s, 2H), 7.49 (d, 2H, J=8.0 Hz), 7.39 (m, 6H), 7.21 (s, 2H), 1.45 (s, 9H), 0.99 (s, 18H); HRMS (FAB) m/z calculated for C₄₈H₄₇B [M⁺]; 634.3771. found 634.3784.

### 3,7-di(thiophen-2-yl)-5-(2,4,6-tri-tert-butylphenyl)dibenzo[b,f]borepin (20e)

A solution of borepin 14b (7.8 mg, 0.013 mmol) and Pd(PPh₃)₄ (1.0 mg, 0.0009 mmol) in DMF (1 mL) was stirred in a dry 25 mL Schlenk tube under nitrogen. 2-tributylstannyl thiophene (21 mg, 0.056 mmol) was added dropwise and the resulting mixture was heated to 80° C. for 18 h. Upon cooling, the reaction was diluted with diethyl ether and stirred vigorously with KF (2×). The filtered organic layer was then partitioned between 1:1 water:diethyl ether. The aqueous layer was removed and extracted with diethyl ether (3×) and the organics were washed with brine (2×). The combined organics were dried with MgSO₄, filtered and the solvent removed under reduced pressure to provide a yellow solid that was further purified by column chromatography (SiO₂: 5% ethyl acetate in hexane) to yield 7.9 mg (0.013 mmol, quant.) of 20e as an off-white solid. ¹H-NMR (400 MHz, CD₂Cl₂) δ: 8.30 (d, 2H, J=2.2 Hz), 7.85 (dd, 2H, J=8.2, 2.2 Hz), 7.68 (d, 2H, J=8.2 Hz), 7.58 (s, 2H), 7.24 (dd, 2H, J=5.1, 1.1 Hz), 7.20 (m, 4H), 7.03 (dd, 2H, J=5.1, 3.6 Hz), 1.48 (s, 9H), 0.97 (s, 18H); HRMS (FAB) m/z calculated for C₄₀H₄₃BS₂ [M⁺]; 598.2899. found 598.2906.

### 3,7-di([2,2′-bithiophen]-5-yl)-5-(2,4,6-tri-tert-butylphenyl)dibenzo[b,f]borepin (20f)

A solution of borepin 14a (11.2 mg, 0.0189 mmol) and Pd(PPh₃)₄ (1.5 mg, 0.051 mmol) in DMF (1 mL) was stirred in a dry 25 mL Schlenk tube under nitrogen. 2-tributylstannyl thiophene (38 mg, 0.083 mmol) was added dropwise and the resulting mixture was heated to 80° C. for 18 h. Upon cooling, the reaction was diluted with diethyl ether and stirred vigorously with KF (2×). The filtered organic layer was then partitioned between 1:1 water:diethyl ether. The aqueous layer was removed and extracted with diethyl ether (3×) and the organics were washed with brine (2×). The combined organics were dried with MgSO₄, filtered and the solvent removed under reduced pressure to provide an orange solid that was further purified by rinsing with methanol to yield 8.0 mg (0.01 mmol, 56%) of 20f as an orange solid. ¹H-NMR (400 MHz, CD₂Cl₂) δ: 8.29 (d, 2H, J=2.1 Hz), 7.84 (dd, 2H, J=8.2, 2.1 Hz), 7.70 (d, 2H, J=8.2 Hz), 7.61 (s, 2H), 7.152 (m, 12H), 1.51 (s, 9H), 1.01 (s, 18H); HRMS (FAB) m/z calculated for C₄₈H₄₇BS₄ [M⁺]; 762.2654. found 762.2670.

### 3,7-bis(4-methoxyphenyl)-5-(2,4,6-tri-tert-butylphenyl)dibenzo[b,f]borepin (20g)

A solution of borepin 14b (13.2 mg, 0.0223 mmol), 4-methoxyphenyl boronic acid (11 mg, 0.072 mmol), Na₂CO₃ (24.4 mg, 0.231 mmol) and Pd(PPh₃)₄ (1.6 mg, 0.0014 mmol) in toluene (1 mL), water (0.3 mL) and ethanol (0.3 mL) was stirred in a 5 mL round bottom equipped with a reflux condenser under nitrogen. The resulting mixture was heated to reflux for 18 h after which it was allowed to cool to room temperature. The reaction mixture was partitioned between water and diethyl ether and washed with NH₄Cl (2×) and brine (2×). The aqueous layer was removed and extracted with diethyl ether (3×) and the combined organics were dried with MgSO₄, filtered and the solvent removed under reduced pressure to provide a brown solid that was further purified by column chromatography (SiO₂: 5% ethyl acetate in hexane) to yield 11.3 mg (0.0175 mmol, 79%) of 7g as an off-white solid. ¹H-NMR (400 MHz, CD₂Cl₂) δ: 8.25 (d, 2H, J=2.1 Hz), 7.84 (dd, 2H, J=8.2, 2.1 Hz), 7.73 (d, 2H, J=8.2 Hz), 7.55 (s, 2H), 7.41 (d, 4H, J=8.8 Hz), 7.23 (s, 2H), 6.89 (d, 4H, J=8.8 Hz), 1.46 (s, 9H), 0.98 (s, 18H); HRMS (FAB) m/z calculated for C₄₆H₅₁BO₂ [M⁺]; 646.3982. found 646.4002.

### 3,7-bis(phenylethynyl)-5-(2,4,6-tri-tert-butylphenyl)dibenzo[b,f]borepin (20h)

A solution of borepin 14b (40.2 mg, 0.0679 mmol), CuI (1.3 mg, 0.0068 mmol) and Pd(PPh₃)₄ (3.9 mg, 0.0034 mmol) in toluene (1.5 mL) and DIPA (0.3 mL) was stirred in a dried 25 mL Schlenk flask under nitrogen. Phenyl acetylene (15.2 mg, 0.149 mmol) was added dropwise at room temperature and the resulting reaction mixture was heated to 75° C. for 18 h. The reaction mixture was allowed to cool to room temperature after which it was partitioned between water and diethyl ether and washed with NH₄Cl(2×) and brine (2×). The aqueous layer was removed and extracted with diethyl ether (3×) and the combined organics were dried with MgSO₄, filtered and the solvent removed under reduced pressure to provide a brown oil/solid that was purified by column chromatography (SiO₂: 2% ethyl acetate in hexane) to yield 20h (0.022 mmol, 33% by NMR) and stannepin 19b as an off-white solid. The mixture was further purified by dissolving in toluene (1 mL) and treating with dichlorophenylborane (0.05 mL) followed by repeating the aqueous workup. The resulting residue was purified by column chromatography (SiO₂: hexane) to yield 5.1 mg of 20h (0.008 mmol, 11%) as an off-white solid. ¹H-NMR (400 MHz, CDCl₃) δ: 8.17 (d, 2H, J=1.7 Hz), 7.69 (dd, 2H, J=8.1, 1.7 Hz), 7.61 (d, 2H, J=8.1 Hz), 7.53 (s, 2H), 7.46 (m, 4H), 7.32 (m, 6H), 7.18 (s, 2H), 1.46 (s, 9H), 1.00 (s, 18H); FIRMS (FAB) m/z calculated for C₄₈H₄₇B [M⁺]; 634.3771. found 634.3780.

### 2,8-bis(diphenylamino)-5-(2,4,6-tri-tert-butylphenyl)dibenzo[b,f]borepin (20i)

A solution of borepin 14a (19.4 mg, 0.0328 mmol), diphenylamine (13.6 mg, 0.0786 mmol), NaO^{t}Bu (9.1 mg, 0.092 mmol) Pd₂(dba)₃ (0.95 mg, 0.0016 mmol) and P(o-tolyl)₃ (1.1 mg, 0.0033 mmol) in toluene (1 mL) was stirred in a dried 25 mL Schlenk flask under nitrogen and resulting reaction mixture was heated to 100° C. for 18 h. The reaction mixture was allowed to cool to room temperature after which it was partitioned between water and diethyl ether and washed with brine (2×). The aqueous layer was removed and extracted with diethyl ether (3×) and the combined organics were dried with MgSO₄, filtered and the solvent removed under reduced pressure to provide a orange solid that was further purified by rinsing with MeOH to yield 15 mg (0.019 mmol, 60%) of 20i as tan solid. ¹H-NMR (400 MHz, CD₂Cl₂) δ: 7.72 (d, 2H, J=8.6 Hz), 7.45 (s, 2H), 7.30 (t, 8H, J=7.8 Hz), 7.14 (m, 16H), 6.91 (dd, 2H, J=8.6, 2.3 Hz), 6.79 (s, 2H), 1.37 (s, 9H), 1.02 (s, 18H); HRMS (FAB) m/z calculated for C₅₆H₅₇BN₂ [M⁺]; 768.4615. found 768.4616.

### 2,8-dicarboxylic acid-5-(2,4,6-tri-tert-butylphenyl)dibenzo[b,f]borepin (20j)

A solution of 14a (41.9 mg, 0.0601 mmol) in THF (1 mL) was cooled to −78° C. in a 25 mL Schlenk flask under nitrogen with stirring. A solution of ^{s}butyl lithium in hexanes (1.4 M, 0.152 mL, 0.213 mmol) was added dropwise and the resulting mixture was held at −78° C. for 30 min after which excess solid CO₂ was added. The resulting mixture was allowed to warm to room temperature and left to stir for 18 h. The reaction mixture was diluted with hexane and filtered rinsing with copious amounts of hexane to yield 18 mg (0.034 mmol, 57%) of 20j as an off-white solid. ¹H-NMR (400 MHz, DMSO) δ: 13.3 (s, 2H), 8.35 (d, 2H, J=1.1 Hz), 8.00 (d, 2H, J=1.1 Hz), 7.93 (dd, 2H, J=8.1, 1.1 Hz), 7.51 (s, 2H), 7.44 (s, 2H), 1.40 (s, 9H), 0.91 (s, 18H); HRMS (FAB) m/z calculated for C₃₄H₃₉BO₄ [M⁺]; 522.2941. found 522.2951.

### 3,7-dicarboxylic acid-5-(2,4,6-tri-tert-butylphenyl)dibenzo[b,f]borepin (20k)

A solution of 14b (12.1 mg, 0.0204 mmol) in THF (1 mL) was cooled to −78° C. in a 25 mL Schlenk flask under nitrogen with stirring. A solution of ^{s}butyl lithium in hexanes (1.4 M, 0.05 mL, 0.07 mmol) was added dropwise and the resulting mixture was held at −78° C. for 30 min after which excess solid CO₂ was added. The resulting mixture was allowed to warm to room temperature and left to stir for 18 h. The reaction mixture was diluted with hexane and filtered rinsing with copious amounts of hexane to yield 7.6 mg (0.014 mmol, 71%) of 20k as an off-white solid. ¹H-NMR (400 MHz, CDCl₃) δ: 8.52 (d, 2H, J=1.3 Hz), 8.03 (dd, 2H, J=7.5, 1.1 Hz), 7.57 (d, 2H, J=8.5 Hz), 7.44 (s, 2H), 7.22 (s, 2H), 1.40 (s, 9H), 0.96 (s, 18H); MS (FAB) m/z calculated for C₃₄H₃₉BO₄ [M⁺]; 522.3. found 522.3.

### 2,8-bis(trimethylsilylethynyl)-5-(2,4,6-tritert-butylphenyl)dibenzo[b,f]borepin (para bis(TMS acetylene) DBB)

A solution of borepin 14a (125 mg, 0.179 mmol), CuI (3.4 mg, 0.018 mmol) and Pd(PPh₃)₄ (10 mg, 0.009 mmol) in toluene (2 mL) and DIPA (0.4 mL) was stirred in a dried 25 mL Schlenk flask under nitrogen. TMS acetylene (39.6 mg, 0.395 mmol) was added dropwise at room temperature and the resulting reaction mixture was heated to 45° C. for 18 h. The reaction mixture was allowed to cool to room temperature after which it was partitioned between water and diethyl ether and washed with NH₄Cl (2×) and brine (2×). The aqueous layer was removed and extracted with diethyl ether (3×) and the combined organics were dried with MgSO₄, filtered and the solvent removed under reduced pressure to provide a brown oil that was further purified by column chromatography (SiO₂: hexane) to yield 109 mg (0.175 mmol, 56%) of para bis(TMS acetylene) DBB as an off-white solid. ¹H-NMR (400 MHz, CDCl₃) δ: 7.92 (d, 2H, J=8.0 Hz), 7.73 (s, 2H), 7.47 (s, 2H), 7.38 (d, 2H, J=8.0 Hz), 7.09 (s, 2H), 1.43 (s, 9H), 0.92 (s, 18H), 0.27 (s, 18H); HRMS (FAB) m/z calculated for C₄₂H₅₅BSi₂ [M⁺]; 626.3935. found 626.3927.

### 3,7-bis(trimethylsilylethynyl)-5-(2,4,6-tri-tert-butylphenyl)dibenzo[b,f]borepin (meta bis(TMS acetylene) DBB)

A solution of borepin 14a (34 mg, 0.057 mmol), CuI (1.1 mg, 0.0057 mmol) and Pd(PPh₃)₄ (3.3 mg, 0.0029 mmol) in toluene (1.5 mL) and DIPA (0.3 mL) was stirred in a dried 25 mL Schlenk flask under nitrogen. TMS acetylene (12.7 mg, 0.126 mmol) was added dropwise at room temperature and the resulting reaction mixture was heated to 45° C. for 18 h. The reaction mixture was allowed to cool to room temperature after which it was partitioned between water and diethyl ether and washed with NH₄Cl(2×) and brine (2×). The aqueous layer was removed and extracted with diethyl ether (3×) and the combined organics were dried with MgSO₄, filtered and the solvent removed under reduced pressure to provide a brown oil that was further purified by column chromatography (SiO₂: hexane) to yield 23 mg (0.037 mmol, 64%) of meta bis(TMS acetylene) DBB as an off-white solid. ¹H-NMR (400 MHz, CD₂Cl₂) δ: 8.04 (d, 2H, J=1.6 Hz), 7.59 (m, 6H), 7.19 (s, 2H), 1.47 (s, 9H), 0.98 (s, 18H), 0.19 (s, 18H); FIRMS (FAB) m/z calculated for C₄₂H₅₅BSi₂ [M⁺]; 626.3935. found 626.3927.

### 2,8-diethynyl-5-(2,4,6-tri-tert-butylphenyl)dibenzo[b,f]borepin (para diethynyl DBB)

A solution of borepin para bis(TMS acetylene) DBB (103 mg, 0.165 mmol) and potassium carbonate (91 mg, 0.66 mmol) in 3 mL of a 1:1 methanol:THF solution was stirred at room temperature for 4 h. The reaction mixture was partitioned between NH₄Cl and diethyl ether and washed with NH₄Cl (1×), brine (2×). The aqueous layer was removed and extracted with diethyl ether (2×) and the combined organics were dried with MgSO₄, filtered and the solvent removed under reduced pressure to yield 79 mg (0.165 mmol, quant.) of the para diethynyl DBB as a pale yellow solid that was used without further purification. ¹H-NMR (400 MHz, CDCl₃) δ: 7.96 (d, 2H, J=8.0 Hz), 7.76 (d, 2H, J=1.6 Hz), 7.47 (s, 2H), 7.40 (s, 2H), 7.11 (s, 2H), 3.20 (s, 2H), 1.43 (s, 9H), 0.93 (s, 18H).

### 3,7-diethynyl-5-(2,4,6-tri-tert-butylphenyl)dibenzo[b,f]borepin (meta diethynyl DBB)

A solution of borepin meta bis(TMS acetylene) DBB (22 mg, 0.035 mmol) and potassium carbonate (19 mg, 0.14 mmol) in 2 mL of a 1:1 methanol:THF solution was stirred at room temperature for 4 h. The reaction mixture was partitioned between NH₄Cl and diethyl ether and washed with NH₄Cl (1×), brine (2×). The aqueous layer was removed and extracted with diethyl ether (2×) and the combined organics were dried with MgSO₄, filtered and the solvent removed under reduced pressure to yield 17 mg (0.035 mmol, quant.) of the meta diethynyl DBB as a pale yellow solid that was used without further purification. ¹H-NMR (400 MHz, CDCl₃) δ: 8.13 (d, 2H, J=1.7 Hz), 7.65 (dd, 2H, J=8.0, 1.7 Hz), 7.57 (d, 2H, J=8.0), 7.48 (s, 2H), 7.16 (s, 2H), 3.06 (s, 2H), 1.44 (s, 9H), 0.97 (s, 18H).

### para Polymer (21a)

A solution of 1,4-bis(decyloxy)-2,5-diiodobenzene (106.5 mg, 0.165 mmol), CuI (3.2 mg, 0.017 mmol) and Pd(PPh₃)₄ (9.6 mg, 0.0083 mmol) in toluene (1 mL) and DIPA (0.4 mL) was stirred in a dried 25 mL Schlenk flask under nitrogen. The para diethynyl DBB (prepared above, 79 mg, 0.165 mmol) in toluene (1 mL) was added dropwise at room temperature and the resulting reaction mixture was heated to 75° C. for 18 h. The reaction mixture was allowed to cool to room temperature after which it was precipitated into 30 mL of stirring methanol. The resulting solid was collected by vacuum filtration and rinsed with methanol to yield 136 mg (0.156 mmol, 94%) of 21a as an orange solid. ¹H-NMR (400 MHz, CD₂Cl₂) δ: 7.98 (m, 2H), 7.80 (m, 2H), 7.50 (d, 2H, J=1.7 Hz), 7.47 (m, 2H), 7.14 (d, 2H, J=3.0 Hz), 7.05 (s, 2H), 4.03 (m, 4H), 1.86 (m, 4H), 1.45 (s, 9H), 1.39 (m, 4H), 1.25 (m, 24H), 0.97 (s, 18H), 0.85 (s, 6H). Mₙ=7190.

### meta Polymer (21b)

A solution of 1,4-bis(decyloxy)-2,5-diiodobenzene (22.6 mg, 0.0352 mmol), CuI (0.7 mg, 0.0035 mmol) and Pd(PPh₃)₄ (2.0 mg, 0.002 mmol) in toluene (0.5 mL) and DIPA (0.3 mL) was stirred in a dried 25 mL Schlenk flask under nitrogen. The meta diethynyl DBB (prepared above, 17 mg, 0.0352 mmol) in toluene (1 mL) was added dropwise at room temperature and the resulting reaction mixture was heated to 75° C. for 18 h. The reaction mixture was allowed to cool to room temperature after which it was precipitated into 30 mL of stirring methanol. The resulting solid was collected by vacuum filtration and rinsed with methanol to yield 27 mg (0.031 mmol, 88%) of 21b as an orange solid. ¹H-NMR (400 MHz, CDCl₃) δ: 8.17 (s, 2H), 7.69 (m, 2H), 7.59 (dd, 2H, J=8.0, 1.3 Hz), 7.51 (m, 2H), 7.18 (m, 2H), 6.89 (m, 2H), 3.94 (m, 4H), 1.77 (m, 4H), 1.45 (m, 13H), 1.25 (m, 24H), 1.02 (s, 18H), 0.87 (m, 6H). Mₙ=4390.

### Example 3

### Conjugated “B-entacenes”: Polycyclic Aromatics Containing Two Borepin Rings

### General Considerations

All reaction manipulations were carried out under an atmosphere of prepurified nitrogen or argon using Schlenk techniques. Non-aqueous solvents were degassed by sparging with nitrogen for 15 minutes prior to use and toluene, diethyl ether and THF were distilled over sodium/benzophenone ketyl. Tetrakis(triphenylphosphine) palladium, bis(acetonitrile) dichloropalladium and tris(dibenzylideneacetone)dipalladium were obtained from Strem Chemicals and 32-63 micron silica gel was used. ¹H NMR and ¹³C NMR were obtained in deuterated chloroform (the signal for residual protio solvent was set at 7.26 ppm for ¹H NMR and 77.16 ppm for ¹³C NMR), deuterated methylene chloride (the signal for residual protio solvent was set at 5.32 ppm for ¹H NMR and 54 ppm for ¹³C NMR) or deuterated dimethyl sulfoxide (the signal for residual protio solvent was set at 2.50 ppm for ¹H NMR and 39.52 ppm for ¹³C NMR) using a 400 MHz FT-NMR spectrometer. All efforts to obtain ¹³C NMR were unsuccessful due to the low solubility of the functionalized DBBs (overnight scans did not result in spectra with reasonable signal to noise) and quadrupolar relaxation of boron. Mass spectra were obtained with EI (70 eV) and FAB ionization (matrix for FAB was 3-nitrobenzyl alcohol) and GPC analyses were done on a 5 m, 300×75 mm column.

### Photophysical Considerations

Spectroscopic measurements were conducted in CHCl₃ solution at room temperature. UV-vis absorption spectra were recorded on UV-Visible spectrophotometer. Photoluminescence spectra were recorded on a fluorometer with a 75 W Xenon lamp, maintaining optical densities below 0.05 au and lifetime data were collected on a generic LED system. Quantum yields were determined relative to quinine sulfate in 0.1 NH₂SO₄ (55%).

### Electrochemical Considerations

Cyclic voltammetry was performed in a one-chamber, three-electrode cell using a potentiostat. A 2 mm² Pt button electrode was used as the working electrode with a platinum wire counter electrode relative to a quasi-internal Ag wire reference electrode submersed in 0.01 M AgNO₃/0.1 M n-Bu₄NPF₆ in anhydrous acetonitrile. Measurements were taken on mM analyte concentrations in 0.1 M n-Bu₄PF₆ (in THF) electrolyte solutions recorded at a scan rate of 100 mV/s. Potentials are reported relative to the Ag/Ag⁺ couple with which the Fc/Fc⁺ couple was found to be 205 mV.

### Computational Considerations

Molecular orbital calculations were performed at the DFT level (B3LYP/6-31G*) on equilibrium geometries using Spartan '04 (Wavefunction Inc., Irvine, Calif.).

The following compounds were synthesized according to literature: 22a, Caruso, A., et al., Angew. Chem. Int. Ed. 2010, 49, 4213-7; 23, Bonifacio, M. C., et al., J. of Org. Chem. 2005, 70, 8522-8526; 24a, Caruso et al., 25a, Caruso et al.; 26a, Caruso et al., 27a, Caruso et al., 4-dimethylamino phenylacetylene, Rodriguez, J. G., et al., J. Phys. Org. Chem. 2001, 14, 859-868; 2-bromo-4-chlorobenzaldehyde (24b) Capková, K., et al. Bioorg. Med. Chem. Lett. 2007, 17, 6463-6; and 1,4-bis(decyloxy)-2,5-diiodobenzene, Swager, T. M., et al., J. Phys. Chem. 1995, 99, 4886-4893.

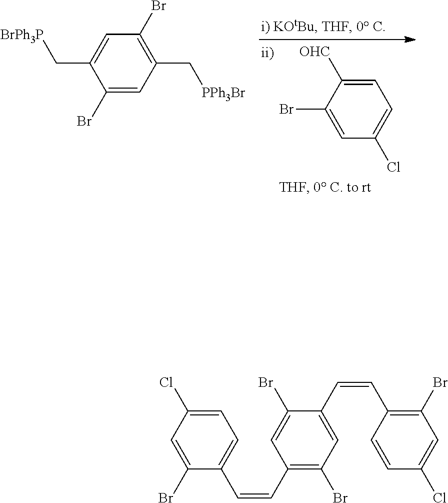

### 4,4′-(1Z,1′Z)-2,2′-(2,5-dibromo-1,4-phenylene)bis(ethene-2,1-diyl)bis(1-bromo-4-chlorobenzene) (25b)

A solution of phosphonium salt 23 (2.79 g, 2.94 mmol) in THF (30 mL) was cooled to 0° C. in a 100 mL 2-neck round bottom under nitrogen with stirring. Potassium ^{t}butoxide (808 mg, 7.06 mmol) was added portionwise and the resulting mixture was held at 0° C. for 30 min. A solution of benzaldehyde 24b (1.23 g, 5.58 mmol) in THF (30 mL) was added dropwise at 0° C. and the reaction was allowed to warm up to room temperature and left stirring for 24 h. The reaction mix was partitioned between 1:1 water:EtOAc and washed with brine (2×). The aqueous layer was removed and extracted with EtOAc (3×) and the organics were dried with MgSO₄, filtered and the solvent removed under reduced pressure to a yellow solid that was rinsed with ethanol and filtered to yield 1.46 g (2.19 mmol, 74%) of 25b as a yellow solid that was used without further purification. ¹H-NMR (400 MHz, CD₂Cl₂) δ: 7.64 (d, 2H, J=2.1 Hz), 7.18 (s, 2H), 7.10 (dd, 2H, J=2.1, 8.3 Hz), 6.92 (d, 2H, J=8.4 Hz), 6.72 (dd, 4H, J=17 Hz); ¹³C-NMR (100 MHz, CDCl₃) δ: 137.6, 135.0, 134.3, 134.2, 132.7, 131.3, 131.2, 129.9, 127.5, 124.5, 122.5; HRMS (FAB) m/z calculated for C₂₂H₁₂Br₄Cl₂ [M⁺]; 667.6988. found 667.7.

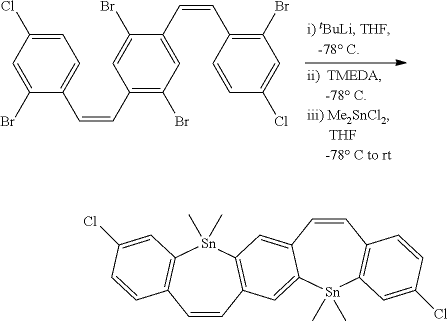 [SMILES: Clc1ccc(/C=C\c2cc(Br)c(/C=C\c3ccc(Cl)cc3Br)cc2Br)c(Br)c1 ; [CH3][Sn]1([CH3])[c]2cc(Cl)ccc2C=Cc2c[c]3c(c[c]21)C=Cc1ccc(Cl)c[c]1[Sn]3([CH3])[CH3]]

### dichloro-fused stannepin (26b)

A solution of 25b (310 mg, 0.45 mmol) in THF (45 mL) was cooled to −78° C. in a 100 mL Schlenk flask under nitrogen with stirring. A solution of ^{s}butyl lithium in hexanes (1.4 M, 2.6 mL, 3.6 mmol) was added dropwise and the resulting mixture was held at −78° C. for 10 min after which TMEDA (420 mg, 3.6 mmol) was added. The reaction mixture was held at temperature for 2 h after which a solution of Me₂SnCl₂ (208 mg, 0.899 mmol) in THF (3 mL) was added dropwise and the resulting mixture was allowed to warm to room temperature and left stirring for 18 h. The reaction mixture was partitioned between 1:1 water:diethyl ether. The aqueous layer was removed and extracted with diethyl ether (3×) and the organics were washed with 0.2 M HCl(1×), water (1×) and brine (1×). The combined organics were dried with MgSO₄, filtered and the solvent removed under reduced pressure to provide an orange solid that was rinsed with methanol to yield 290 mg (0.45 mmol, quant.) of 26b as a pale yellow solid that was used without further purification. ¹H-NMR (400 MHz, CD₂Cl₂) δ: 7.32 (m, 8H), 6.88 (dd, 4H, J=11 Hz), 0.50 (s, 9H); HRMS (FAB) m/z calculated for C₂₆H₂₄Cl₂Sn₂ [M⁺]; 645.9299. found 645.9378.

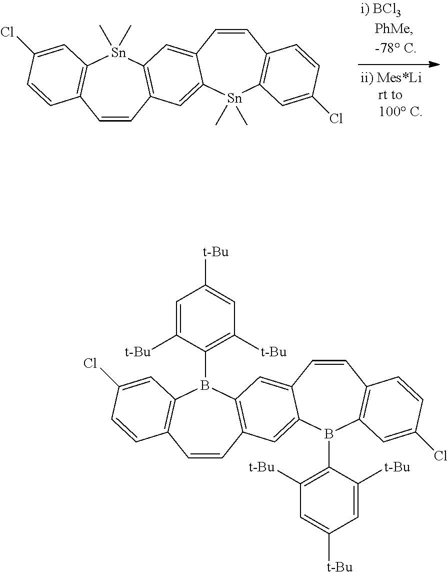 [SMILES: [CH3][Sn]1([CH3])[c]2cc(Cl)ccc2C=Cc2c[c]3c(c[c]21)C=Cc1ccc(Cl)c[c]1[Sn]3([CH3])[CH3] ; CC(C)(C)c1cc(C(C)(C)C)c(B2c3cc(Cl)ccc3C=Cc3cc4c(cc32)C=Cc2ccc(Cl)cc2B4c2c(C(C)(C)C)cc(C(C)(C)C)cc2C(C)(C)C)c(C(C)(C)C)c1]

### dichloro-B-Mes* fused borepin (22b)

A solution of fused dichlorostannepin 26b (201 mg, 0.309 mmol) in toluene (4 mL) was cooled to −78° C. in a dried 25 mL Schlenk tube under nitrogen. A solution of BCl₃ in hexanes (1.0 M, 0.62 mL, 0.62 mmol) was added dropwise with stirring after which the reaction mixture was allowed to slowly warm to room temperature over 1 h. A solution of Mes*Li⁴ (626 mg, 2.48 mmol) in toluene (4 mL) was added dropwise and the resulting mixture was left stirring at room temperature for 18 h. The reaction mix was partitioned between 1:1 water:diethyl ether and washed with brine (2×). The aqueous layer was removed and extracted with diethyl ether (2×) and the combined organics were dried with MgSO₄, filtered and the solvent removed under reduced pressure to provide a yellow solid that was further purified by column chromatography (SiO₂: 5% DCM in hexane) to yield 92 mg (0.11 mmol, 34%) of 22b as a yellow solid. ¹H-NMR (400 MHz, CD₂Cl₂) δ: 8.21 (s, 2H), 7.99 (d, 2H, J=2.3 Hz), 7.55 (m, 8H), 7.03 (dd, 4H, J=14 Hz), 1.48 (s, 18H), 0.99 (s, 36H); ¹³C-NMR (100 MHz, CD₂Cl₂) δ: 151.4, 149.5, 147.7, 141.2, 140.7, 139.8, 134.9, 134.7, 133.3, 133.2, 133.0, 123.6, 122.9, 122.0, 38.9, 35.4, 33.5, 31.8; HRMS (FAB) m/z calculated for C₅₈H₇₀B₂Cl₂[M⁺]; 858.5041. found 858.5018.

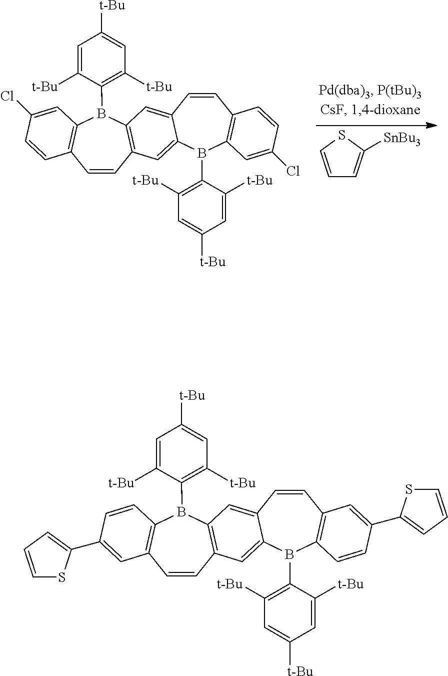

### bis(para-thienyl) B-Mes* fused borepin (27a)

A solution of borepin 22a (27.5 mg, 0.0319 mmol), Pd₂(dba)₃ (1.5 mg, 0.0016 mmol), P′Bu₃ (1M in toluene, 6.5 mL, 0.0064 mmol) and CsF (21.4 mg, 0.141 mmol) in 1,4-dioxane (1 mL) was stirred in a dry 25 mL Schlenk tube under nitrogen. 2-tributylstannyl thiophene (32 mg, 0.083 mmol) was added dropwise and the resulting mixture was heated to 95° C. for 18 h. Upon cooling, the reaction was diluted with diethyl ether and stirred vigorously with KF (2×). The filtered organic layer was then partitioned between 1:1 water:diethyl ether. The aqueous layer was removed and extracted with diethyl ether (3×) and the organics were washed with brine (2×). The combined organics were dried with MgSO₄, filtered and the solvent removed under reduced pressure to provide a yellow solid that was rinsed with methanol to yield 7.1 mg (0.0074 mmol, 23%) of 27a as a yellow solid. ¹H-NMR (400 MHz, CDCl₃) S: 8.24 (s, 2H), 8.06 (d, 2H, J=8.2 Hz), 7.81 (d, 2H, J=1.6 Hz), 7.58 (dd, 2H, J=1.6, 8.1 Hz), 7.53 (s, 4H), 7.46 (d, 2H, J=3.6 Hz), 7.34 (d, 2H, J=4.9 Hz), 7.07 (m, 6H), 1.48 (s, 18H), 1.01 (s, 36H); HRMS (FAB) m/z calculated for C₆₆H₇₆B₂S₂ [M⁺]; 954.5575. found 954.5590.

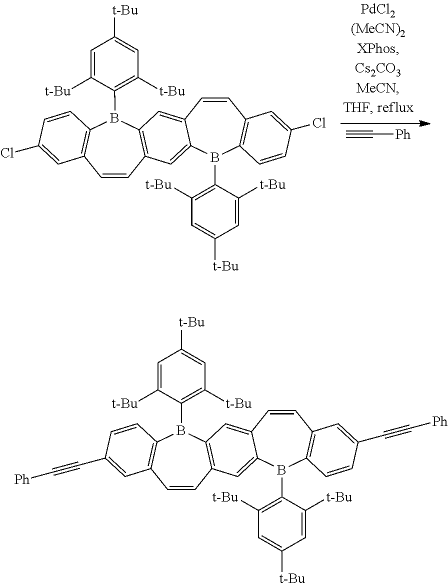

### bis(para-phenylacetylene) B-Mes* fused borepin (27c)

A solution of borepin 22a (28 mg, 0.033 mmol), PdCl₂(MeCN)₂ (0.63 mg, 0.0016 mmol), XPhos (2.4 mg, 0.0049 mmol) and Cs₂CO₃ (63.7 mg, 0.195 mmol) in THF (1 mL) and MeCN (2 mL) was stirred in a dry 25 mL Schlenk tube under nitrogen. Phenylacetylene (10.2 mg, 0.0981 mmol) was added dropwise and the resulting mixture was refluxed for 18 h. The reaction mixture was allowed to cool to room temperature after which it was partitioned between water and diethyl ether and washed with brine (2×). The aqueous layer was removed and extracted with diethyl ether (3×) and the combined organics were dried with MgSO₄, filtered and the solvent removed under reduced pressure to provide a orange-yellow solid that was further purified by column chromatography (SiO₂: hexane) to yield 11 mg (0.011 mmol, 34%) of 6c as a yellow solid. ¹H-NMR (400 MHz, CD₂Cl₂) δ: 8.23 (s, 2H), 8.06 (d, 2H, J=8.0 Hz), 7.80 (s 2H), 7.57 (s, 8H), 7.47 (d, 2H, J=7.8 Hz), 7.38 (m, 6H), 7.06 (dd, 4H, J=9.7 Hz), 1.47 (s, 18H), 0.96 (s, 36H); HRMS (FAB) m/z calculated for C₇₄H₈₀B₂ [M⁺]; 990.6446. found 990.6427.

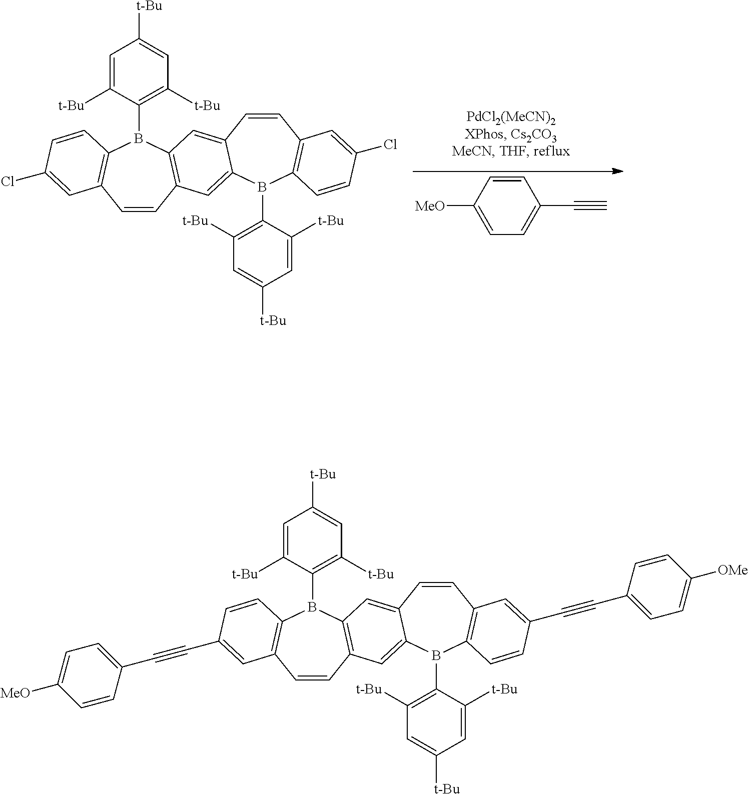

### bis(para-4-methoxyphenylethynyl) B-Mes* fused borepin (27d)

A solution of borepin 22a (21.3 mg, 0.0248 mmol), PdCl₂(MeCN)₂ (0.51 mg, 0.047 mmol), XPhos (1.9 mg, 0.0037 mmol) and Cs₂CO₃ (48.5 mg, 0.149 mmol) in THF (1 mL) and MeCN (2 mL) was stirred in a dry 25 mL Schlenk tube under nitrogen. 4-methoxyphenylacetylene (10.3 mg, 0.0743 mmol) was added dropwise and the resulting mixture was refluxed for 18 h. The reaction mixture was allowed to cool to room temperature after which it was partitioned between water and diethyl ether and washed with brine (2×). The aqueous layer was removed and extracted with diethyl ether (3×) and the combined organics were dried with MgSO₄, filtered and the solvent removed under reduced pressure to provide a brown solid that was further purified by column chromatography (SiO₂: 5% EtOAc:hexane) to yield 13.1 mg (0.0124 mmol, 50%) of 27d as a yellow solid. ¹H-NMR (400 MHz, CDCl₃) δ: 8.22 (s, 2H), 8.06 (d, 2H, J=8.3 Hz), 7.75 (s, 2H), 7.53 (m, 8H), 7.45 (d, 2H, J=8.3 Hz), 7.04 (m, 4H), 6.91 (d, 4H, J=9.9 Hz), 3.86 (s, 6H), 1.50 (s, 18H), 1.01 (s, 36H); HRMS (FAB) m/z calculated for C₇₄H₇₀B₂F₁₀ [M⁺]; 1050.6657. found 1050.6651.

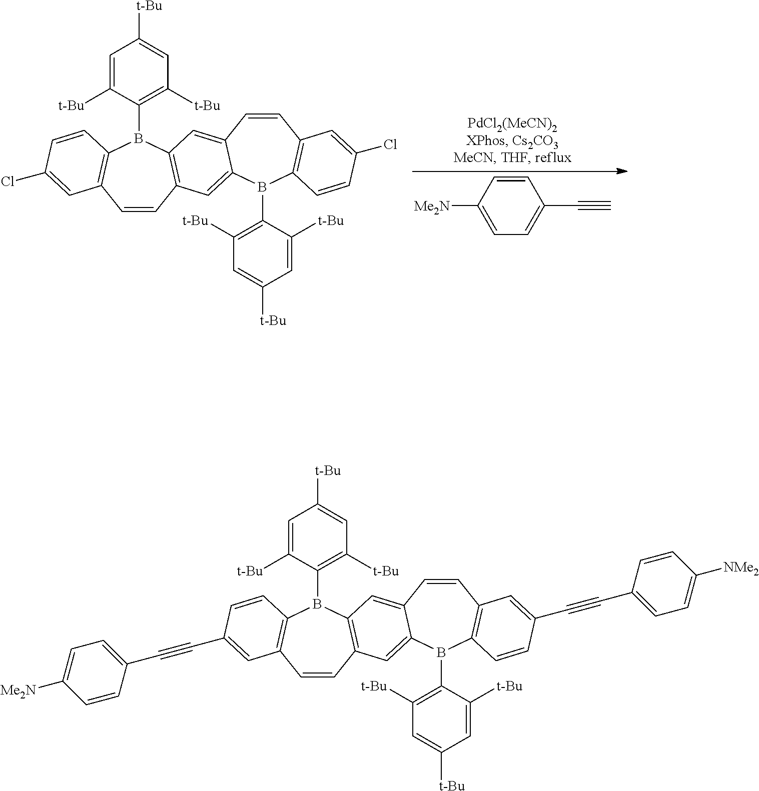 [SMILES: CC(C)(C)c1cc(C(C)(C)C)c(B2c3ccc(Cl)cc3C=Cc3cc4c(cc32)C=Cc2cc(Cl)ccc2B4c2c(C(C)(C)C)cc(C(C)(C)C)cc2C(C)(C)C)c(C(C)(C)C)c1 ; C#Cc1ccc(N(C)C)cc1 ; CN(C)c1ccc(C#Cc2ccc3c(c2)C=Cc2cc4c(cc2B3c2c(C(C)(C)C)cc(C(C)(C)C)cc2C(C)(C)C)C=Cc2cc(C#Cc3ccc(N(C)C)cc3)ccc2B4c2c(C(C)(C)C)cc(C(C)(C)C)cc2C(C)(C)C)cc1]

### bis(para-N,N-dimethyl-4-(phenylethynyl)aniline) B-Mes* fused borepin (27e)

A solution of borepin 22a (48.3 mg, 0.0562 mmol), PdCl₂(MeCN)₂ (1.1 mg, 0.0028 mmol), XPhos (4.1 mg, 0.0084 mmol) and Cs₂CO₃ (110 mg, 0.34 mmol) in THF (1 mL) and MeCN (2 mL) was stirred in a dry 25 mL Schlenk tube under nitrogen. N,N-dimethyl-4-(phenylethynyl)aniline (24.5 mg, 0.169 mmol) was added dropwise and the resulting mixture was refluxed for 18 h. The reaction mixture was allowed to cool to room temperature after which it was partitioned between water and diethyl ether and washed with brine (2×). The aqueous layer was removed and extracted with diethyl ether (3×) and the combined organics were dried with MgSO₄, filtered and the solvent removed under reduced pressure to provide a brown solid that was further purified by column chromatography (SiO₂: hexane) to yield 43 mg (0.056 mmol, quant.) of 27e as a yellow solid. ¹H-NMR (400 MHz, CD₂Cl₂) δ: 8.21 (s, 2H), 8.01 (d, 2H, J=7.8 Hz), 7.73 (s, 2H), 7.57 (s, 4H), 7.41 (m, 6H), 7.04 (d, 4H, J=10 Hz), 6.67 (d, 4H, 8.8 Hz), 2.99 (s, 12H), 1.48 (s, 18H), 1.00 (s, 36H); HRMS (FAB) m/z calculated for C₇₈H₉₀B₂N₂ [M⁺]; 1076.7290. found 1076.7304.

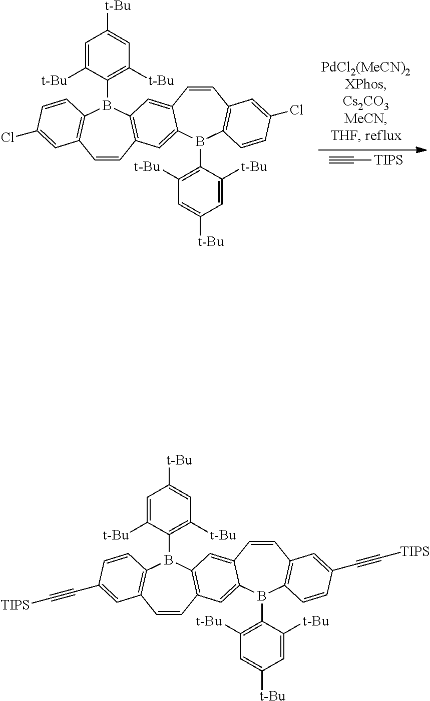

### bis(para-TIPS-acetylene) B-Mes* fused borepin

A solution of borepin x (54.6 mg, 0.0635 mmol), PdCl₂(MeCN)₂ (1.2 mg, 0.032 mmol), XPhos (4.7 mg, 0.0095 mmol) and Cs₂CO₃ (108 mg, 0.329 mmol) in THF (1 mL) and MeCN (2 mL) was stirred in a dry 25 mL Schlenk tube under nitrogen. TIPS-acetylene (35.5 mg, 0.191 mmol) was added dropwise and the resulting mixture was refluxed for 18 h. The reaction mixture was allowed to cool to room temperature after which it was partitioned between water and diethyl ether and washed with brine (2×). The aqueous layer was removed and extracted with diethyl ether (3×) and the combined organics were dried with MgSO₄, filtered and the solvent removed under reduced pressure to provide a brown solid that was further purified by column chromatography (SiO₂: hexane) to yield 24.6 mg (0.0214 mmol, 34%) of 27f as a yellow solid. ¹H-NMR (400 MHz, CD₂Cl₂) δ: 8.21 (s, 2H), 7.99 (d, 2H, J=8.0 Hz), 7.72 (d, 2H, J=1.6 Hz), 7.55 (s, 4H), 7.39 (dd, 2H, J=1.6, 8.1 Hz), 7.02 (d, 4H, J=2.2 Hz), 1.47 (s, 18H), 1.14 (s, 36H), 0.98 (s, 42H); HRMS (FAB) m/z calculated for C₈₀H₁₁₂B₂Si₂[M⁺]; 1150.8488. found 1150.8538.

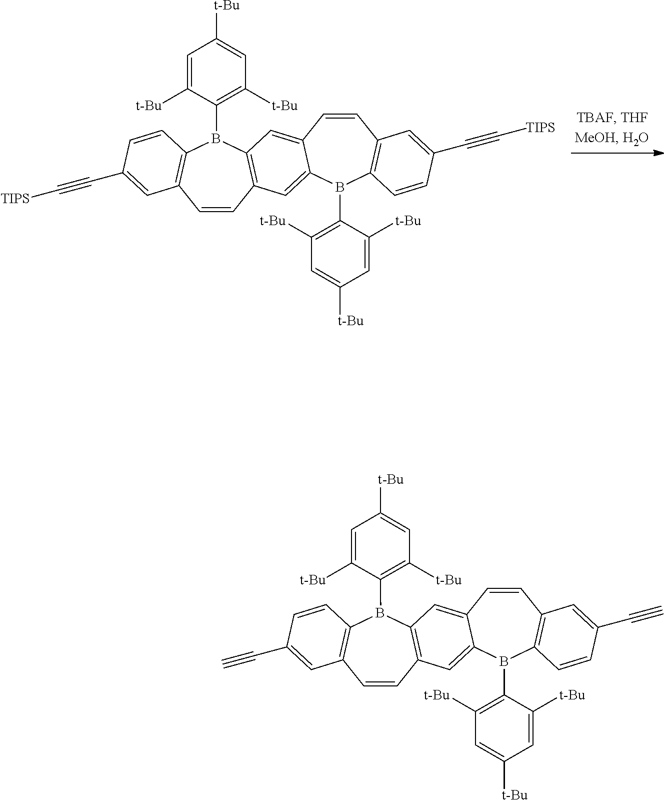

### bis(para-ethynyl) B-Mes* fused borepin

A solution of borepin 27f (24 mg, 0.021 mmol) and tetrabutylammonium fluoride (1M in THF, 1.1 mL, 1.1 mmol) in THF (2 mL), MeOH (0.25 mL) and H₂O (0.25 mL) was stirred at room temperature for 24 h. The reaction mixture was partitioned between NH₄Cl and diethyl ether and washed with brine (2×). The aqueous layer was removed and extracted with diethyl ether (3×) and the combined organics were dried with MgSO₄, filtered and the solvent removed under reduced pressure to yield 18 mg (0.021 mmol, quant.) of bis(para-ethynyl) B-Mes* fused borepin as a yellow solid that was used immediately without further purification.

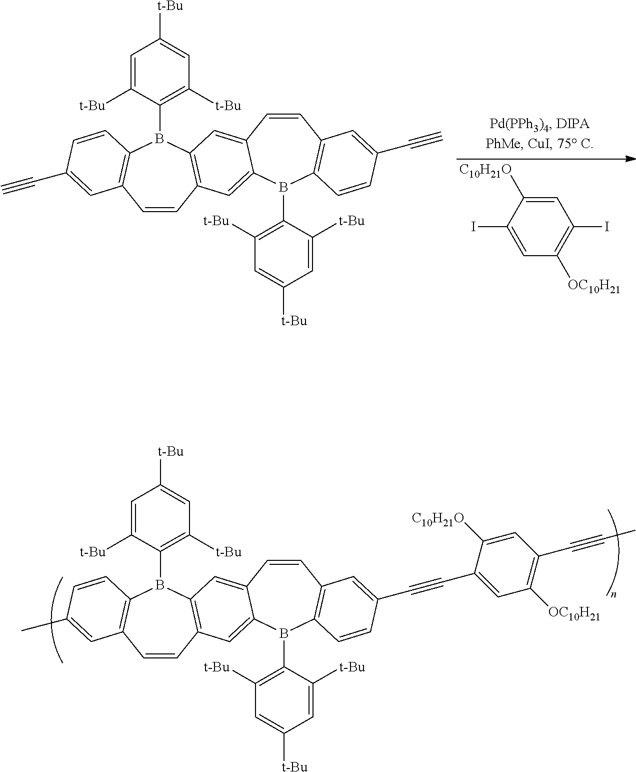

### para Polymer (28)

A solution of 1,4-bis(decyloxy)-2,5-diiodobenzene (13.5 mg, 0.021 mmol), CuI (0.4 mg, 0.002 mmol) and Pd(PPh₃)₄ (1.2 mg, 0.0011 mmol) in toluene (1 mL) and DIPA (0.6 mL) was stirred in a dried 25 mL Schlenk flask under nitrogen. bis(para-ethynyl) B-Mes* fused borepin (prepared above, 18 mg, 0.021 mmol) in toluene (1 mL) was added dropwise at room temperature and the resulting reaction mixture was heated to 75° C. for 18 h. The reaction mixture was allowed to cool to room temperature after which it was precipitated into x mL of stirring methanol. The resulting solid was collected by vacuum filtration and rinsed with methanol to yield 18 mg (0.015 mmol, 70%) of 7 as an orange solid. ¹H-NMR (400 MHz, CD₂Cl₂) δ: 8.23 (s, 2H), 8.05 (s, 2H), 7.77 (s, 2H), 7.57 (s, 4H), 7.45 (s, 2H), 7.20 (m, 2H), 7.06 (s, 4H), 4.02 (m, 4H), 1.43 (m, 92H). Mₙ=x.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.
J. C. Collings, S. Y. Poon, C. Le Droumaguet, M. Charlot, C. Katan, L. O. Palsson, A. Beeby, J. A. Mosely, H. M. Kaiser, D. Kaufmann, W. Y. Wong, M. Blanchard-Desce, T. B. Marder, Chem. Eur. J. 2009, 15, 198-208.
H. Li, F. Jäkle, Angew. Chem. Int. Ed. 2009, 48, 2313-2316.
N. Matsumi, M. Miyata, Y. Chujo, Macromolecules 1999, 32, 4467-4469.
A. Wakamiya, K. Mori, S. Yamaguchi, Angew. Chem. Int. Ed. 2007, 46, 4273-4276.
T. K. Wood, W. E. Piers, B. A. Keay, M. Parvez, Angew. Chem. Int. Ed. 2009, 48, 4009-4012.
G. Zhou, M. Baumgarten, K. Müllen, J. Am. Chem. Soc. 2008, 130, 12477-12484.
A. Lorbach, M. Bolte, H. Y. Li, H. W. Lerner, M. C. Holthausen, F. Jakle, M. Wagner, Angew. Chem. Int. Ed. 2009, 48, 4584-4588.
T. W. Hudnall, F. P. Gabbai, J. Am. Chem. Soc. 2007, 129, 11978-11986.
S. Yamaguchi, S. Akiyama, K. Tamao, J. Am. Chem. Soc. 2001, 123, 11372-11375.
B. Y. Lee, S. J. Wang, M. Putzer, G. P. Bartholomew, X. H. Bu, G. C. Bazan, J. Am. Chem. Soc. 2000, 122, 3969-3970.
A. J. Ashe, J. W. Kampf, C. M. Kausch, H. Konishi, M. O. Kristen, J. Kroker, Organometallics 1990, 9, 2944-2948.
D. A. Hoic, W. M. Davis, G. C. Fu, J. Am. Chem. Soc. 1995, 117, 8480-8481.
J. M. Schulman, R. L. Disch, Organometallics 2000, 19, 2932-2936.
G. Subramanian, P. v. R. Schleyer, H. J. Jiao, Organometallics 1997, 16, 2362-2369.
A. J. V. Marwitz, M. H. Matus, L. N. Zakharov, D. A. Dixon, S. Y. Liu, Angew. Chem. Int. Ed. 2009, 48, 973-977.
M. J. D. Bosdet, W. E. Piers, T. S. Sorensen, M. Parvez, Angew Chem. Int. Ed. 2007, 46, 4940-4943.
N. Matsumi, K. Naka, Y. Chujo, J. Am. Chem. Soc. 1998, 120, 10776-10777.
C. H. Zhao, A. Wakamiya, Y. Inukai, S. Yamaguchi, J. Am. Chem. Soc. 2006, 128, 15934-15935.
H. Y. Li, A. Sundararaman, K. Venkatasubbaiah, F. Jäkle, J. Am. Chem. Soc. 2007, 129, 5792-5793.
S. Yamaguchi, T. Shirasaka, S. Akiyama, K. Tamao, J. Am. Chem. Soc. 2002, 124, 8816-8817.
A. Caruso Jr., J. D. Tovar, in 236th ACS National Meeting, Philadelphia, Pa., United States, 2008.
L. G. Mercier, W. E. Piers, in 91st Canadian Chemistry Conference and Exhibition, Edmonton, AB, Canada, 2008.
E. E. van Tamelen, G. Brieger, K. G. Untch, Tetrahedron Lett. 1960, 14-15.
L. G. Mercier, W. E. Piers, M. Parvez, Angew. Chem. Int. Ed. 2009, 48, 6108-6111.
E. C. Dunne, E. J. Coyne, P. B. Crowley, D. G. Gilheany, Tetrahedron Lett. 2002, 43, 2449-2453.
A. Wakamiya, K. Mishima, K. Ekawa, S. Yamaguchi, Chem. Commun. 2008, 579-581.
I. Colon, D. R. Kelsey, J. Org. Chem. 1986, 51, 2627-2637.
J. L. Reddinger, J. R. Reynolds, Macromolecules 1997, 30, 479-481.
M. C. Bonifacio, C. R. Robertson, J. Y. Jung, B. T. King, J. Org. Chem. 2005, 70, 8522-8526.
W. Kaim, A. Schulz, Angew. Chem. Intl. Ed. Engl. 1984, 23, 615-616.
P. v. R. Schleyer, C. Maerker, A. Dransfeld, H. J. Jiao, N. J. R. V. Hommes, J. Am. Chem. Soc. 1996, 118, 6317-6318.
A. L. Spek, J. Appl. Cryst. 2003, 36, 7-13.
S. Yamaguchi, C. H. Xu, T. Okamoto, Pure Appl. Chem. 2006, 78, 721-730.
M. J. Frisch, G. W. Trucks, H. B. Schlegel, et al., Gaussian 03, Revision C.01; Gaussian, Inc.; Wallingford, Conn.; 2004.
Wyatt, P., Hudson, A., Charmant, J., Orpen A. G., Phetmung, H. Org. & Biomolecular Chem., 2006, 4, 2218-2232.
Plater, M. J. Tet. Lett. 1994, 35(33), 6147-6150.
Harrowven, D.C., Guy, I. L., Nanson, L. Synlett. 2006, 18, 2977-2980.
Organ, M. G., Abdel-Hadi, M., Avola, S., Hadei, N., Nasielski, J., O'Brien, C. J., Valente, C. Chem. Eur. 12007, 13, 150-157.
Caruso, A.; Siegler, M. A.; Tovar, J. D. Angew. Chem. Int. Ed. 2010, 49, 4213-7.
Bonifacio, M. C.; Robertson, C. R.; Jung, J. Y.; King, B. T. J. of Org. Chem. 2005, 70, 8522-8526.
Rodriguez, J. G.; Lafuente, A.; Martin-Villamil, R.; Martinez-Alcazar, M. P. J. Phys. Org. Chem. 2001, 14, 859-868.
Capková, K.; Yoneda, Y.; Dickerson, T. J.; Janda, K. D. Bioorg. Med. Chem. Lett. 2007, 17, 6463-6.
Swager, T. M.; Gil, C. J.; Wrighton, M. S. J. Phys. Chem. 1995, 99, 4886-4893.
Wade, C. R.; Broomsgrove, A. E. J.; Aldridge, S.; Gabbaï, F. P. Chem. Rev. 2010, 110, 3958-84.
Jäkle, F. Chem. Rev. 2010, 110, 3985-4022.
Matsumi, N.; Chujo, Y. Polym. J. 2008, 40, 77-89.
Lin, N.; Zhao, X.; Cheng, X.; Jiang, M. J. Mol. Struct.: THEOCHEM 2007, 820, 98-106.
Entwistle, C. D.; Marder, T. B. Chem. Mater. 2004, 16, 4574-4585.
Hudnall, T. W.; Chiu, C.-W.; Gabbaï, F. P. Acc. Chem. Res. 2009, 42, 388-97.
Zhou, G.; Baumgarten, M.; Müllen, K.; J. Am. Chem. Soc. 2008, 130, 12477-12484.
Hudnall, T. W.; Gabbaï, F. P. J. Am. Chem. Soc. 2007, 129, 11978-11986.
Yamaguchi, S.; Wakamiya, A. Pure Appl. Chem. 2006, 78, 1413-1424.
Nagai, A.; Kokado, K.; Nagata, Y.; Chujo, Y. Macromolecules 2008, 41, 8295.
Wakamiya, A.; Mori, K.; Yamaguchi, S. Angew. Chem. Int. Ed. 2007, 46, 4273-4276.
Qin, Y.; Kiburu, I.; Shah, S.; Jäkle, F. Org. Lett. 2006, 8, 5227-30.
Li, H.; Jäkle, F. Angew. Chem. Int. Ed. 2009, 48, 2313-2316.
Lorbach, A.; Bolte, M.; Li, H.; Lerner, H-W; Holthausen, M. C.; Jäkle, F.; Wagner, M. Angew. Chem. Int. Ed. 2009, 121, 4654-4658.
Matsumi, N.; Naka, K.; Chujo, Y. J. Am. Chem. Soc. 1998, 120, 10776-10777.
Li, H; Sundararaman, A.; Venkatasubbaiah, K; Jäkle, F. J. Am. Chem. Soc. 2007, 129(18), 5792-5793.
Jäkle, F. J. Inorg. Organomet. Polym. Mater. 2005, 15(3), 293-307.
Liu, X. Y.; Bai, D. R.; Wang, S.; Angew. Chem. Int. Ed. 2006, 45, 5475-5478.
Matsumi, N.; Naka, K.; Chujo, Y. J. Am. Chem. Soc. 1998, 120, 5112-5113.
Zhao, C. H.; Wakamiya, A.; Inukai, Y.; Yamaguchi, S. J. Am. Chem. Soc. 2006, 128, 15934-15935.
Noda, T.; Ogawa, H.; Shirota, Y. Adv. Mater. 1999, 11, 283-285.
Lepeltier, M.; Lukoyanova, O.; Jacobson, A.; Jeeva, S.; Perepichka, D. F. Chem. Commun. 2010, 46, 7007-7009.
Bosdet, M. J. D.; Jaska, C. A.; Piers, W. E.; Sorensen, T. S.; Parvez, M. Org. Lett. 2007, 9, 1395-1398.
Bosdet, M. J. D.; Piers, W. E.; Sorensen, T. S.; Parvez, M. Angew. Chem. Int. Ed. 2007, 46(26), 4940.
Jaska, C. A.; Emslie, D. J. H.; Bosdet, M. J. D.; Piers, W. E.; Sorensen, T. S.; Parvez, M. J. Am. Chem. Soc. 2006, 128, 10885-96.
Rogers, J. S.; Bu, X.; Bazan, G. C. J. Am. Chem. Soc. 2000, 122, 730-731.
Lee, B. Y.; Bazan, G. C. J. Am. Chem. Soc. 2000, 122, 8577-8578.
Hoic, D. A.; DiMare, M.; Fu, G. C. J. Am. Chem. Soc. 1997, 119, 7155-7156.
Wood, T. K.; Piers, W. E.; Keay, B. A.; Parvez, M. Chem. Eur. J. 2010, Early View.
Metz, M. V.; Schwartz, D. J.; Stern, C. L.; Nickias, P. N.; Marks, T. J. Angew. Chem. Int. Ed. 2000, 39(7), 1312-1316.
Ashe III, A. J.; Fang, X.; Kampf, J. W. Organometallics 1999, 18, 466-473.
Dewar, M. J. S.; Marr, P. A. J. Am. Chem. Soc. 1962, 84, 3782.
Ashe III, A. J.; Fang, X.; Fang, X.; Kampf, J. W. Organometallics 2001, 20, 5413-5418.
Daly, A.; Tanjaroon, C.; Marwitz, A. J. V.; Liu, S-Y.; Kukolich, S. J. Am. Chem. Soc. 2010, 132, 5501-5506.
Abbey, E. R.; Zakharov, L. N.; Liu, S-Y. J. Am. Chem. Soc. 2008, 130, 7250-7252.
Herberich, G. E.; Greiss, G.; Heil, H. F. Angew. Chem. Int. Ed. 1970, 9, 805-806.
Lee, R. A.; Lachicotte, R. J.; Bazan, G. C. J. Am. Chem. Soc. 1998, 120, 6037-6046.
Ashe III, A. J.; Fang, X.; Kampf, J. W. Organometallics 1999, 18, 466-473.
Fan, C.; Piers, W. E.; Parvez, M. Angew. Chem. Int. Ed. 2009, 48, 2955-2958.
Braunschweig, H.; Kupfer, T. Chem. Commun. 2008, 4487.
Wakamiya, A.; Mishima, K.; Ekawa, K.; Yamaguchi, S. Chem. Commun. 2008, 579-581.
Yamaguchi, S.; Shirasaka, T.; Akiyama, S.; Tamao, K. J. Am. Chem. Soc. 2002, 124, 8816-8817.
Vol'pin, M. E. Russian Chemical Reviews 1960, 29, 129-160.
Schulman, J. M.; Disch, R. L. Organometallics. 2000, 19, 2932-2936.
Subramanian, G.; Schleyer, P. v R.; Jiao, H. Organometallics 1997, 16, 2362-2369.
Tamelen, E. E. v.; Brieger, G.; Untch, K. G. Tet. Lett. 1960, 8, 14-15.
Leusink, A. J.; Drenth, W.; Noltes, J. G.; Kerk, G. J. M. v. d. Tet. Lett. 1967, 14, 1263-1266.
Ashe III, A. J.; Kampf, J. W.; Nakadaira, Y.; Pace, J. M. Angew. Chem. Int. Ed. 1992, 31(9), 1255-1258.
Ashe III, A. J.; Klein, W.; Rousseau, R. Organometallics, 1993, 12, 3224-3231.
Mercier, L. G.; Piers, W. E.; Parvez, M. Angew. Chem. Int. Ed. 2009, 48, 6108-6111.
Caruso Jr., A.; Siegler, M. A.; Tovar, J. D. Angew. Chem. Int. Ed., 2010, 49(25), 4213-4217.
Mercier, L. G.; Furukawa, S.; Piers, W. G.; Wakamiya, A.; Yamaguchi, S.; Parvez, M.; Harrington, R. W.; Clegg, W. Organometallics 2011, 30, 1719-17-29.
Yoshifuji, M.; Shima, I.; Inamoto, N.; Hirotsu, K.; Higuchi, T. J. Am. Chem. Soc. 1981, 103, 4587-4589.
Dunne, E. C.; Coyne, E. J.; Crowley, P. B.; Gilheany, D. G. Tet. Lett. 2002, 43, 2449-2453.
\check{S}terk, D.; Modec, B.; Mohar, B. J. Org. Chem. 2007, 72, 8010-8018.
Swager, T.; Gil, C. J.; Wrighton, M. S. J. Phys. Chem. 1995, 99, 4886-4893.
Albota, M.; Beljonne, D.; Brédas, J-L.; Ehrlich, J. E.; Fu, J-Y.; Heikal, A. A.; Hess, S. E.; Kogej, T.; Levin, M. D.; Marder, S. R.; McCord-Maughon, D.; Perry, J. W.; Rockel, H.; Rumi, M.; Subramaniam, G.; Webb, W. W.; W. X-L.; Xu, C. Science 1998, 281, 1653.
Amijs, C. H. M.; Van Klink, G. P. M.; Van Koten, G. Green Chem. 2003, 5, 470-474.
Zhou, N.; Wang, L.; Thompson, D. W.; Zhao, Y. Org. Lett. 2008, 10, 3001-3004.

Although the foregoing subject matter has been described in some detail by way of illustration and example for purposes of clarity of understanding, it will be understood by those skilled in the art that certain changes and modifications can be practiced within the scope of the appended claims.

1. A compound selected from the group consisting of: 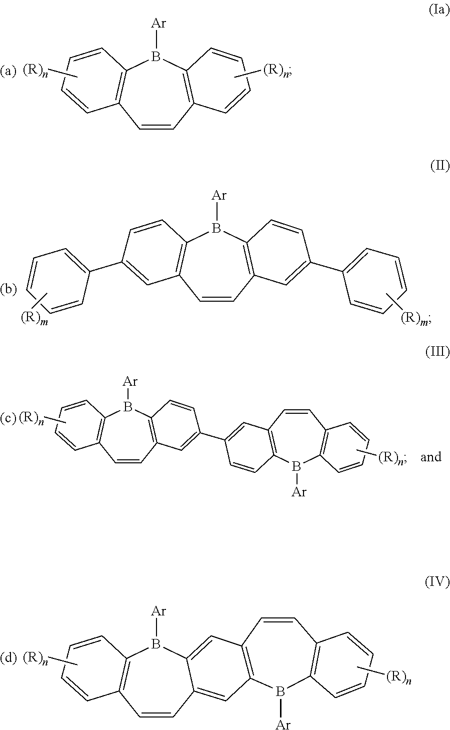
wherein:
m is an integer from 0 to 5;
n is an integer from 0 to 4;
Ar is selected from the group consisting of phenyl and substituted phenyl;
R at each occurrence is independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings;
provided that if Ar is 2,4,6-trimethylbenzene, at least one R is not H; and oligomers and polymers thereof.

2. The compound of claim 1, wherein the substituted phenyl is selected from the group consisting of 2,6-dimethylphenyl, 2,4,6-tri-iso-propylphenyl, 2,4,6-tri-tert-butylphenyl, 2,4,6-trimethyl phenyl, and 4-cyanophenyl.

3. The compound of claim 1, wherein the compound of Formula (Ia) is selected from the group consisting of: 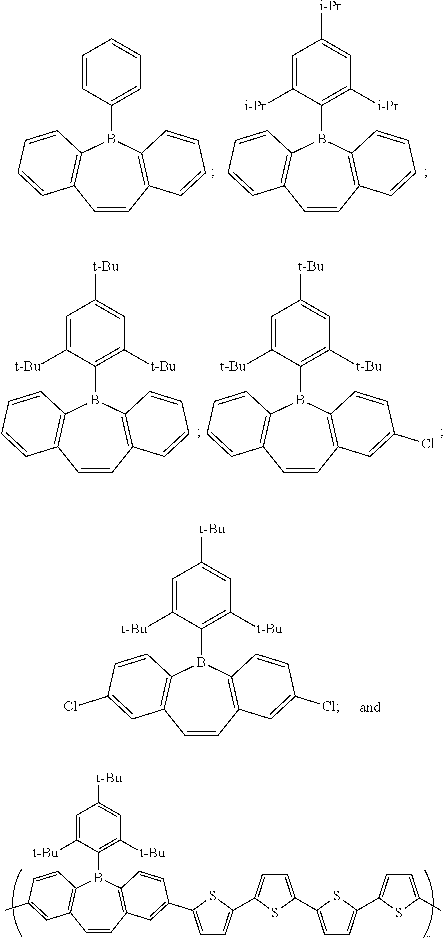
wherein “t-Bu” is a tertiary butyl group and “i-Pr” is an isopropyl group.

4. The compound of claim 1, wherein the compound of Formula (Ia) is selected from the group consisting of: 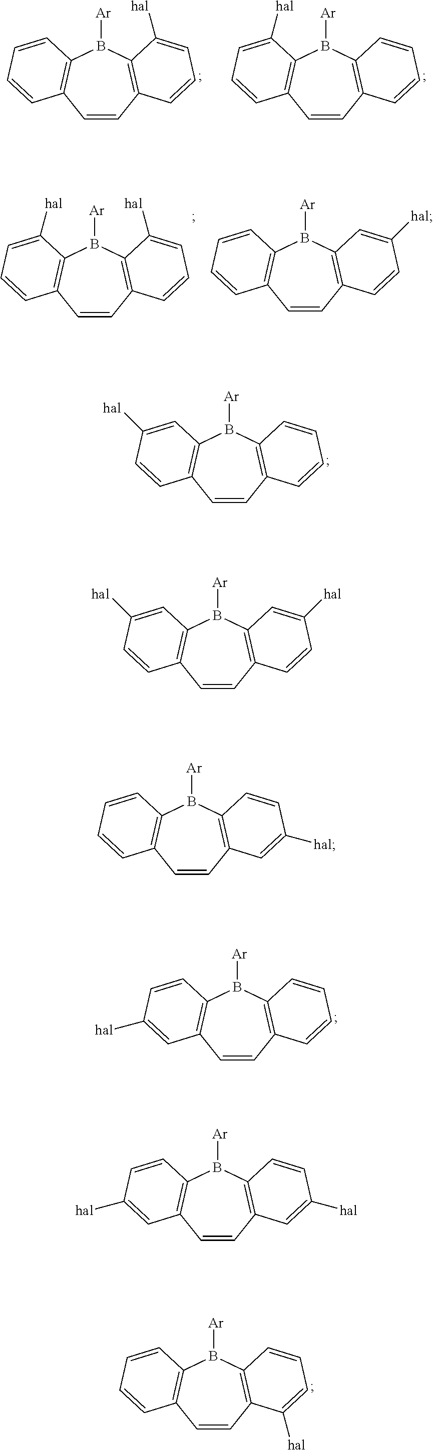 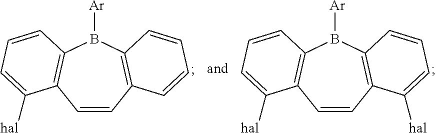
wherein Ar is as defined above and each “hal” substituent group is independently a halogen selected from the group consisting of F, Cl, Br, and I.

5. The compound of claim 1, wherein the compound of Formula (II) is selected from the group consisting of: 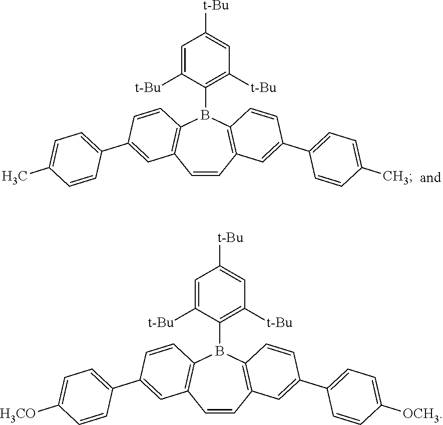 [SMILES: Cc1ccc(-c2ccc3c(c2)C=Cc2cc(-c4ccc(C)cc4)ccc2B3c2c(C(C)(C)C)cc(C(C)(C)C)cc2C(C)(C)C)cc1 ; COc1ccc(-c2ccc3c(c2)C=Cc2cc(-c4ccc(OC)cc4)ccc2B3c2c(C(C)(C)C)cc(C(C)(C)C)cc2C(C)(C)C)cc1]
wherein “t-Bu” is a tertiary butyl group.

6. The compound of claim 1, wherein the compound of Formula (III) has the following structure: 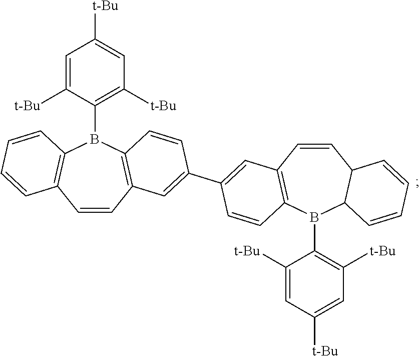 [SMILES: CC(C)(C)c1cc(C(C)(C)C)c(B2c3ccccc3C=Cc3cc(-c4ccc5c(c4)C=CC4C=CC=CC4B5c4c(C(C)(C)C)cc(C(C)(C)C)cc4C(C)(C)C)ccc32)c(C(C)(C)C)c1]
wherein “t-Bu” is a tertiary butyl group.

7. The compound of claim 1, wherein the compound of Formula (1a) is a compound of Formula (1b): 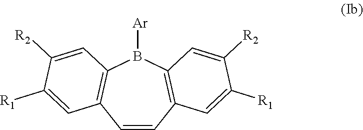
wherein Ar is selected from the group consisting of phenyl and substituted phenyl; R₁ and R₂ at each occurrence are independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings; provided that at least one of R₁ and R₂ is not H; and oligomers and polymers thereof.

8. The compound of claim 7, wherein the compound of Formula (Ib) is selected from the group consisting of: 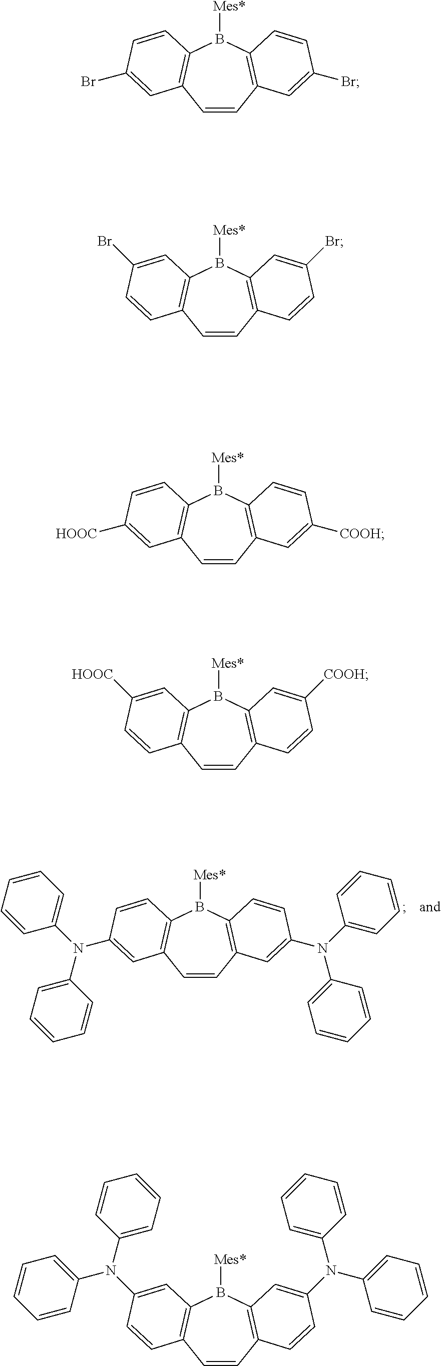
wherein Mes* is 2,4,6-tri-t-butylphenyl.

9. The compound of claim 7, wherein the compound of Formula (Ib) is selected from the group consisting of:

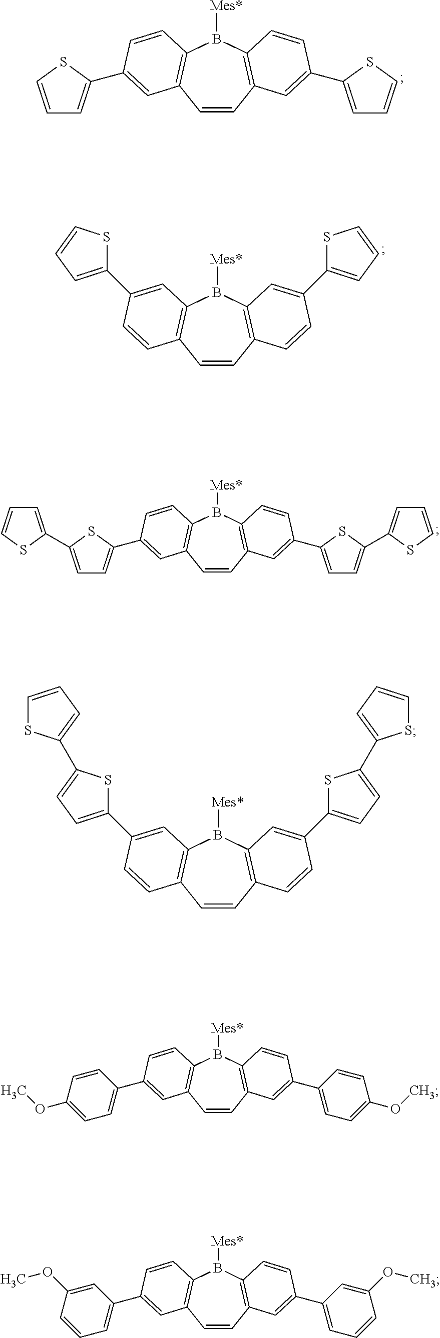

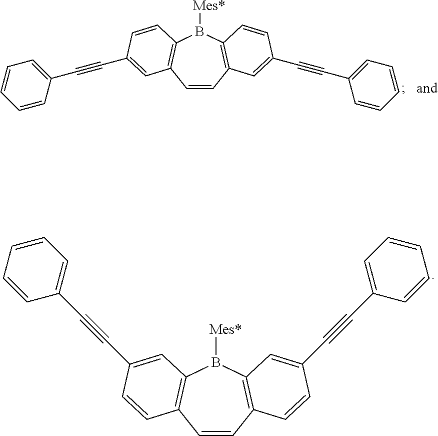

10. The compound of claim 7, wherein the compound of Formula (Ib) is selected from the group consisting of:

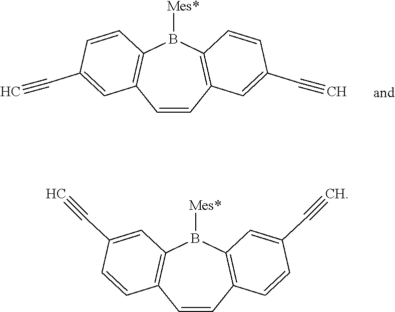

11. The compound of claim 7, wherein the compound of Formula (Ib) is selected from the group consisting of:

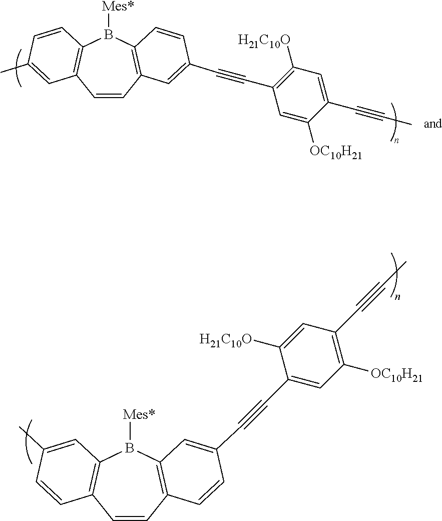

12. The compound of claim 1, wherein the compound of Formula (IV) has a structure selected from the group consisting of: 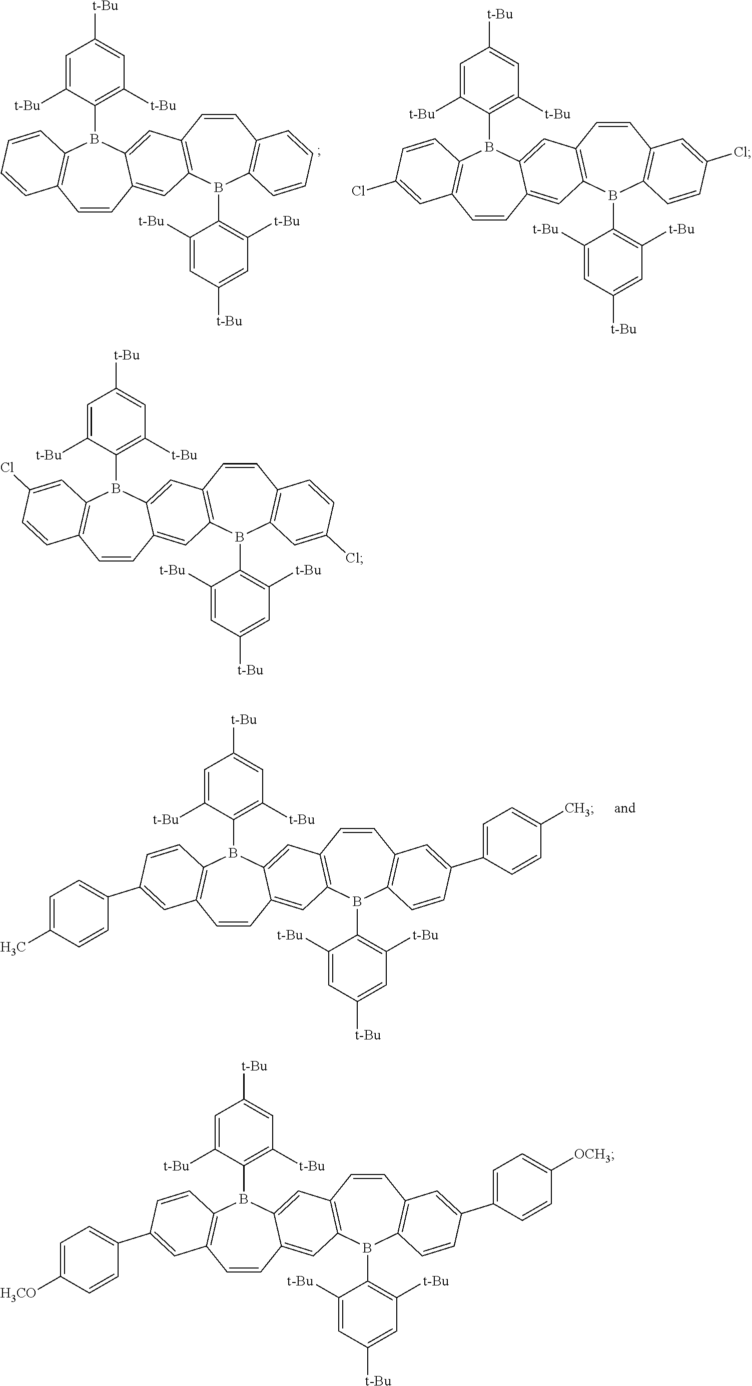
wherein t-Bu is a tertiary butyl group.

13. The compound of claim 1, wherein the compound of Formula (IV) is selected from the group consisting of:

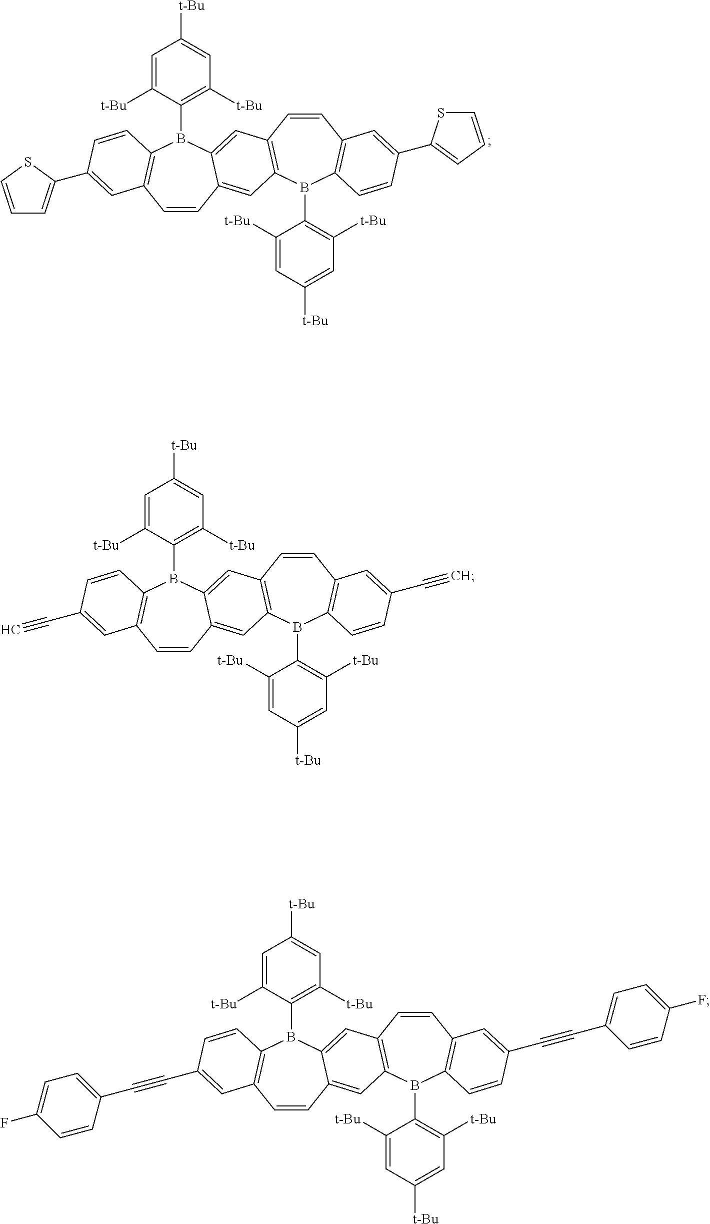 [SMILES: CC(C)(C)c1cc(C(C)(C)C)c(B2c3ccc(-c4cccs4)cc3C=Cc3cc4c(cc32)C=Cc2cc(-c3cccs3)ccc2B4c2c(C(C)(C)C)cc(C(C)(C)C)cc2C(C)(C)C)c(C(C)(C)C)c1 ; C#Cc1ccc2c(c1)C=Cc1cc3c(cc1B2c1c(C(C)(C)C)cc(C(C)(C)C)cc1C(C)(C)C)C=Cc1cc(C#C)ccc1B3c1c(C(C)(C)C)cc(C(C)(C)C)cc1C(C)(C)C ; CC(C)(C)c1cc(C(C)(C)C)c(B2c3ccc(C#Cc4ccc(F)cc4)cc3C=Cc3cc4c(cc32)C=Cc2cc(C#Cc3ccc(F)cc3)ccc2B4c2c(C(C)(C)C)cc(C(C)(C)C)cc2C(C)(C)C)c(C(C)(C)C)c1]

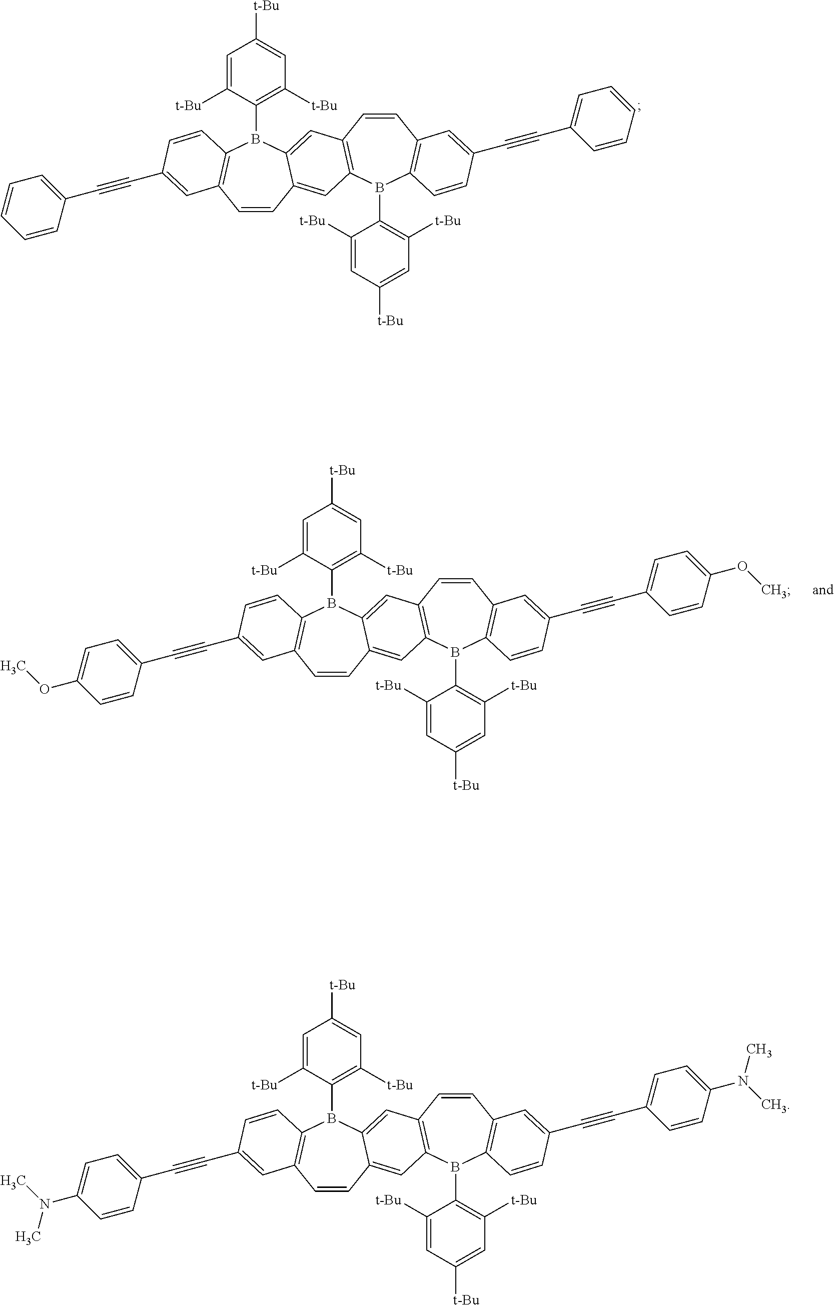 [SMILES: CC(C)(C)c1cc(C(C)(C)C)c(B2c3ccc(C#Cc4ccccc4)cc3C=Cc3cc4c(cc32)C=Cc2cc(C#Cc3ccccc3)ccc2B4c2c(C(C)(C)C)cc(C(C)(C)C)cc2C(C)(C)C)c(C(C)(C)C)c1 ; COc1ccc(C#Cc2ccc3c(c2)C=Cc2cc4c(cc2B3c2c(C(C)(C)C)cc(C(C)(C)C)cc2C(C)(C)C)C=Cc2cc(C#Cc3ccc(OC)cc3)ccc2B4c2c(C(C)(C)C)cc(C(C)(C)C)cc2C(C)(C)C)cc1 ; CN(C)c1ccc(C#Cc2ccc3c(c2)C=Cc2cc4c(cc2B3c2c(C(C)(C)C)cc(C(C)(C)C)cc2C(C)(C)C)C=Cc2cc(C#Cc3ccc(N(C)C)cc3)ccc2B4c2c(C(C)(C)C)cc(C(C)(C)C)cc2C(C)(C)C)cc1]

14. The compound of claim 1, wherein the compound of Formula (IV) has the following structure:

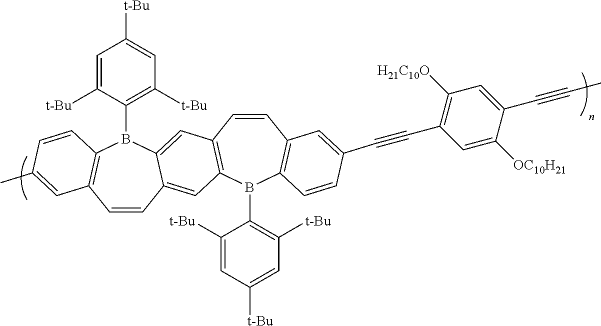

15. An oligomeric material comprising a plurality of monomer units comprising one or more compounds of claim 1.

16. A polymeric material comprising a plurality of monomer units comprising one or more compounds of claim 1.

17. A pi-electron material comprising a compound of claim 1.

18. A pi-electron material comprising an oligomeric material of claim 1.

19. An organic semiconductor material comprising a compound of claim 1.

20. An organic semiconductor material comprising an oligomeric material of claim 1.

21. An electronic device comprising a compound of claim 1.

22. An electronic device comprising an oligomeric material of claim 1.

23. The electronic device of claim 21, wherein the device is a transistor device.

24. The electronic device of claim 23, wherein transistor device comprises a device selected from the group consisting of a photovoltaic and an organic light emitting diode.

25. A compound selected from the group consisting of: 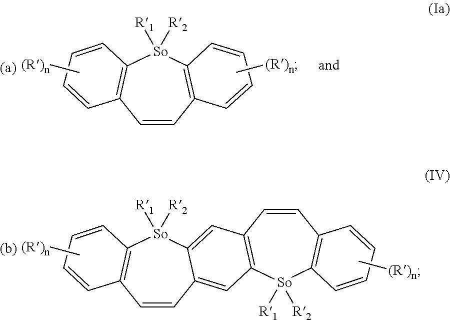
wherein:
n is an integer from 0 to 4;
R′₁, and R′₂ are each independently alkyl or substituted alkyl;
R′ at each occurrence is independently selected from the group consisting of H, substituted and unsubstituted alkyl, halogen, alkoxyl, carboxyl, amino, alkyl amino, dialkyl amino, alkenyl, alkynyl, substituted and unsubstituted aryl, substituted and unsubstituted alkynylaryl, substituted and unsubstituted heteroaryl, and a chain comprising 2 or more substituted and unsubstituted heteroaryl rings.

26. A compound of claim 25, wherein the compound of Formula (Ia′) is selected from the group consisting of: 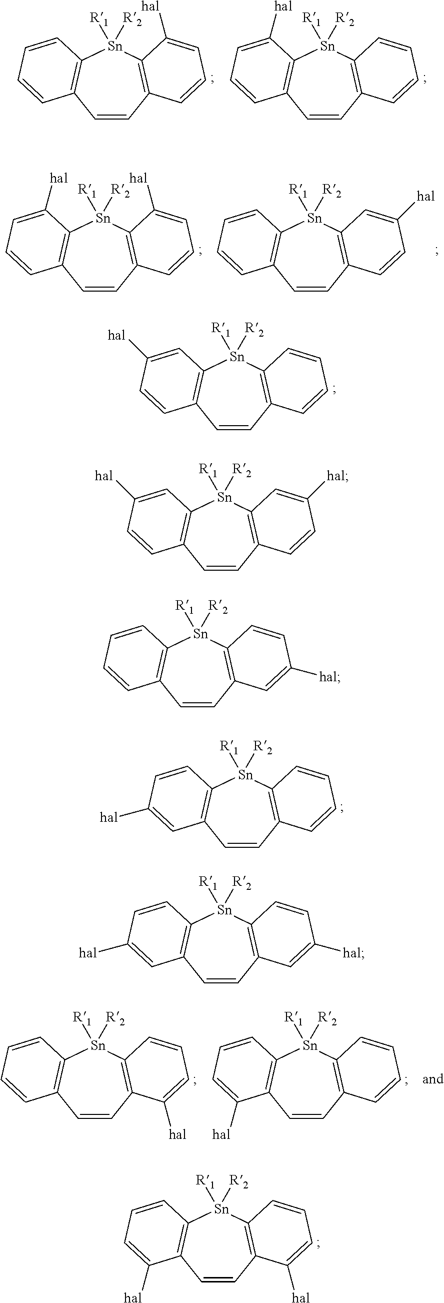
wherein R′₁, and R′₂ each “hal” substituent group is independently a halogen selected from the group consisting of F, Cl, Br, and I.

27. A compound of claim 25, wherein the compound of formula (Ia′) is selected from the group consisting of:

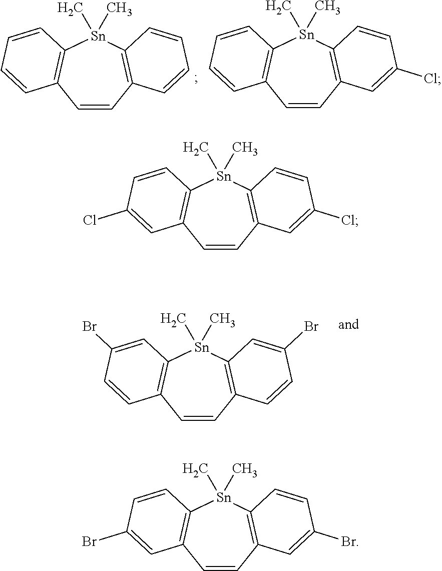

28. A compound of claim 25, wherein the compound of formula (IV′) is selected from the group consisting of: [chemical structure]
